(19) United States
(12) Patent Application Publication
(10) Pub. No.: US 2024/0005467 A1
(43) Pub. Date: Jan. 4, 2024

(54) IMAGE PROCESSING APPARATUS, IMAGING APPARATUS, IMAGE PROCESSING METHOD, AND PROGRAM

(71) Applicant: FUJIFILM Corporation, Tokyo (JP)

(72) Inventors: Taro SAITO, Saitama-shi (JP); Koichi TANAKA, Saitama-shi (JP); Tomoharu SHIMADA, Saitama-shi (JP)

(73) Assignee: FUJIFILM Corporation, Tokyo (JP)

(21) Appl. No.: 18/338,225

(22) Filed: Jun. 20, 2023

(30) Foreign Application Priority Data
Jun. 30, 2022 (JP) 2022-106600

(51) Int. Cl. G06T 5/50; G06T 3/40; G06T 5/00; G06T 7/13; G06V 10/56

(52) U.S. Cl. CPC G06T 5/50; G06T 3/4053; G06T 5/002; G06T 5/006; G06T 7/13; G06V 10/56; G06T 2207/20192; G06T 2207/20221

(57) ABSTRACT

The image processing apparatus includes a processor. The processor is configured to: acquire a first image, which is obtained by performing first AI processing on a processing target image, and a second image, which is obtained without performing the first AI processing on the processing target image; and adjust excess and deficiency of the first AI processing by combining the first image and the second image.

### CROSS-REFERENCE TO RELATED APPLICATIONS

This application claims priority under 35 USC 119 from Japanese Patent Application No. 2022-106600 filed on Jun. 30, 2022, the disclosure of which is incorporated by reference herein.

### BACKGROUND

### 1. Technical Field

The present invention relates to an image processing apparatus, an imaging apparatus, an image processing method, and a program.

### 2. Related Art

JP2018-206382A discloses an image processing system including a processing unit that performs processing on an input image, which is input to an input layer, by using a neural network having the input layer, an output layer, and an interlayer provided between the input layer and the output layer, and an adjustment unit that adjusts internal parameters calculated by learning, which are at least one internal parameter of one or more nodes included in the interlayer, based on data related to the input image in a case where the processing is performed after the learning.

Further, in the image processing system described in JP2018-206382A, the input image is an image that includes noise, and the noise is removed or reduced from the input image by the processing performed by the processing unit.

Further, in the image processing system described in JP2018-206382A, the neural network includes a first neural network, a second neural network, a division unit that divides the input image into a high-frequency component image and a low-frequency component image and inputs the high-frequency component image to the first neural network while inputting the low-frequency component image to the second neural network, and a composition unit that combines a first output image output from the first neural network and a second output image output from the second neural network, and an adjustment unit adjusts the internal parameters of the first neural network based on the data related to the input image while not adjusting the internal parameters of the second neural network.

Further, JP2018-206382A discloses the image processing system including the processing unit that generates an output image in which the noise is reduced from the input image by using a neural network and the adjustment unit that adjusts the internal parameters of the neural network according to an imaging condition of the input image.

JP2020-166814A discloses a medical image processing apparatus including an acquisition unit that acquires a first image, which is a medical image of a predetermined portion of a subject, a high image quality unit that generates a second image, which has higher image quality than that of the first image, from the first image by using a high image quality engine including a machine learning engine, and a display control unit that displays a composite image, which is obtained by combining the first image and the second image based on a ratio obtained by using information related to at least a part of a region of the first image, on a display unit.

JP2020-184300A discloses an electronic apparatus including a memory that stores at least one command and a processor that is electrically connected to the memory, obtains a noise map, which indicates a input image quality, from the input image by executing the command, applies the input image and the noise map to a learning network model including a plurality of layers, and obtains an output image having improved input image quality, in which the processor provides a noise map to at least one interlayer among a plurality of layers, and the learning network model is a trained artificial intelligence model obtained by training a relationship between a plurality of sample images, and the noise map for each sample image and an original image for each sample image, by using an artificial intelligence algorithm.

### SUMMARY

One embodiment according to the present disclosed technology provides an image processing apparatus, an imaging apparatus, an image processing method, and a program capable of obtaining an image that has a less noticeable effect of first AI processing than a first image obtained by performing the first AI processing on a processing target image.

An image processing apparatus according to a first aspect of the present disclosed technology comprises: a processor, in which the processor is configured to: acquire a first image, which is obtained by performing first AI processing on a processing target image, and a second image, which is obtained without performing the first AI processing on the processing target image; and adjust excess and deficiency of the first AI processing by combining the first image and the second image.

A second aspect according to the present disclosed technology is the image processing apparatus according to the first aspect, in which the second image is an image obtained by performing non-AI method processing, which does not use a neural network, on the processing target image.

An image processing apparatus according to a third aspect of the present disclosed technology comprises: a processor, in which the processor is configured to: acquire a first image, which is obtained by performing first AI processing on a processing target image to adjust a non-noise element of the processing target image, and a second image, which is obtained without performing the first AI processing on the processing target image; and adjust the non-noise element by combining the first image and the second image.

A fourth aspect according to the present disclosed technology is the image processing apparatus according to the third aspect, in which the second image is an image in which the non-noise element is adjusted by performing non-AI method processing, which does not use a neural network, on the processing target image.

A fifth aspect according to the present disclosed technology is the image processing apparatus according to the third aspect, in which the second image is an image in which the non-noise element is not adjusted.

A sixth aspect according to the present disclosed technology is the image processing apparatus according to any one of the first to fifth aspects, in which the processor is configured to combine the first image and the second image at a ratio in which the excess and deficiency of the first AI processing is adjusted.

A seventh aspect according to the present disclosed technology is the image processing apparatus according to the sixth aspect, in which the processing target image is an image obtained by performing imaging by an imaging apparatus, the first AI processing includes first correction processing of correcting a phenomenon, which appears in the processing target image due to a characteristic of the imaging apparatus, by using an AI method, the first image includes a first corrected image obtained by performing the first correction processing, and the processor is configured to adjust an element derived from the first correction processing by combining the first corrected image and the second image at the ratio.

An eighth aspect according to the present disclosed technology is the image processing apparatus according to the seventh aspect, in which the processor is configured to perform second correction processing of correcting the phenomenon by using a non-AI method, the second image includes a second corrected image obtained by performing the second correction processing, and the processor is configured to adjust the element derived from the first correction processing by combining the first corrected image and the second corrected image at the ratio.

A ninth aspect according to the present disclosed technology is the image processing apparatus according to the sixth or eighth aspect, in which the characteristic includes an optical characteristic of the imaging apparatus.

A tenth aspect according to the present disclosed technology is the image processing apparatus according to any one of the sixth to ninth aspects, in which the first AI processing includes first change processing of changing a factor that controls a visual impression given from the processing target image by using an AI method, the first image includes a first changed image obtained by performing the first change processing, and the processor is configured to adjust an element derived from the first change processing by combining the first changed image and the second image at the ratio.

An eleventh aspect according to the present disclosed technology is the image processing apparatus according to the tenth aspect, in which the processor is configured to perform second change processing of changing the factor by using a non-AI method, the second image includes a second changed image obtained by performing the second change processing, and the processor is configured to adjust the element derived from the first change processing by combining the first changed image and the second changed image at the ratio.

A twelfth aspect according to the present disclosed technology is the image processing apparatus according to the tenth or eleventh aspect, in which the factor includes a clarity, color, a gradation, a resolution, a blurriness, an emphasizing degree of an edge region, an image style, and/or an image quality related to skin.

A thirteenth aspect according to the present disclosed technology is the image processing apparatus according to any one of the sixth to twelfth aspects, in which the processing target image is a captured image obtained by imaging subject light, which is formed on a light-receiving surface by a lens of an imaging apparatus, by the imaging apparatus, the first image includes a first aberration corrected image obtained by performing aberration region correction processing of correcting a region of the captured image where an aberration of the lens is reflected by using an AI method, as processing included in the first AI processing, the second image includes a second aberration corrected image obtained by performing processing of correcting the region of the captured image where the aberration of the lens is reflected by using a non-AI method, and the processor is configured to adjust an element derived from the aberration region correction processing by combining the first aberration corrected image and the second aberration corrected image at the ratio.

A fourteenth aspect according to the present disclosed technology is the image processing apparatus according to any one of the sixth to thirteenth aspects, in which the first image includes a first colored image obtained by performing color processing of coloring a first region and a second region, which is a region different from the first region, with respect to the processing target image in a distinguishable manner by using an AI method, as processing included in the first AI processing, the second image includes a second colored image obtained by performing processing of changing color of the processing target image by using a non-AI method, and the processor is configured to adjust an element derived from the color processing by combining the first colored image and the second colored image at the ratio.

A fifteenth aspect according to the present disclosed technology is the image processing apparatus according to the fourteenth aspect, in which the second colored image is an image obtained by performing processing of coloring the first region and the second region with respect to the processing target image in a distinguishable manner by using the non-AI method.

A sixteenth aspect according to the present disclosed technology is the image processing apparatus according to the fourteenth or fifteenth aspect, in which the processing target image is an image obtained by imaging a first subject, and the first region is a region where a specific subject, which is included in the first subject in the processing target image, is captured.

A seventeenth aspect according to the present disclosed technology is the image processing apparatus according to any one of the sixth to sixteenth aspects, in which the first image includes a first contrast adjusted image obtained by performing first contrast adjustment processing of adjusting a contrast of the processing target image by using an AI method, as processing included in the first AI processing, the second image includes a second contrast adjusted image obtained by performing second contrast adjustment processing of adjusting the contrast of the processing target image by using a non-AI method, and the processor is configured to adjust an element derived from the first contrast adjustment processing by combining the first contrast adjusted image and the second contrast adjusted image at the ratio.

An eighteenth aspect according to the present disclosed technology is the image processing apparatus according to the seventeenth aspect, in which the processing target image is an image obtained by imaging a second subject, the first contrast adjustment processing includes third contrast adjustment processing of adjusting the contrast of the processing target image according to the second subject by using the AI method, the second contrast adjustment processing includes fourth contrast adjustment processing of adjusting the contrast of the processing target image according to the second subject by using the non-AI method, the first image includes a third contrast image obtained by performing the third contrast adjustment processing, the second image includes a fourth contrast image obtained by performing the fourth contrast adjustment processing, and the processor is configured to adjust an element derived from the third contrast adjustment processing by combining the third contrast image and the fourth contrast image at the ratio.

A nineteenth aspect according to the present disclosed technology is the image processing apparatus according to the seventeenth or eighteenth aspect, in which the first contrast adjustment processing includes fifth contrast adjustment processing of adjusting a contrast between a center pixel included in the processing target image and a plurality of adjacent pixels adjacent to a vicinity of the center pixel by using the AI method, the second contrast adjustment processing includes sixth contrast adjustment processing of adjusting the contrast between the center pixel and the plurality of adjacent pixels by using the non-AI method, the first image includes a fifth contrast image obtained by performing the fifth contrast adjustment processing, the second image includes a sixth contrast image obtained by performing the sixth contrast adjustment processing, and the processor is configured to adjust an element derived from the fifth contrast adjustment processing by combining the fifth contrast image and the sixth contrast image at the ratio.

A twentieth aspect according to the present disclosed technology is the image processing apparatus according to any one of the sixth to nineteenth aspects, in which the first image includes a first resolution adjusted image obtained by performing first resolution adjustment processing of adjusting a resolution of the processing target image by using an AI method, as processing included in the first AI processing, the second image includes a second resolution adjusted image obtained by performing second resolution adjustment processing of adjusting the resolution by using a non-AI method, and the processor is configured to adjust an element derived from the first resolution adjustment processing by combining the first resolution adjusted image and the second resolution adjusted image at the ratio.

A twenty-first aspect according to the present disclosed technology is the image processing apparatus according to the twentieth aspect, in which the first resolution adjustment processing is processing of performing a super-resolution on the processing target image by using the AI method, and the second resolution adjustment processing is processing of performing the super-resolution on the processing target image by using the non-AI method.

A twenty-second aspect according to the present disclosed technology is the image processing apparatus according to any one of the sixth to twenty-first aspects, in which the first image includes a first high dynamic range image obtained by performing expansion processing of expanding a dynamic range of the processing target image by using an AI method, as processing included in the first AI processing, the second image includes a second high dynamic range image obtained by performing processing of expanding the dynamic range of the processing target image by using a non-AI method, and the processor is configured to adjust an element derived from the expansion processing by combining the first high dynamic range image and the second high dynamic range image at the ratio.

A twenty-third aspect according to the present disclosed technology is the image processing apparatus according to any one of the sixth to twenty-second aspects, in which the first image includes a first edge emphasized image obtained by performing emphasis processing of emphasizing an edge region in the processing target image more than a non-edge region, which is a region different from the edge region, by using an AI method, as processing included in the first AI processing, the second image includes a second edge emphasized image obtained by performing processing of emphasizing the edge region more than the non-edge region by using a non-AI method, and the processor is configured to adjust an element derived from the emphasis processing by combining the first edge emphasized image and the second edge emphasized image at the ratio.

A twenty-fourth aspect according to the present disclosed technology is the image processing apparatus according to any one of the sixth to twenty-third aspects, in which the first image includes a first point image adjusted image obtained by performing point image adjustment processing of adjusting a blurriness amount of a point image with respect to the processing target image by using an AI method, as processing included in the first AI processing, the second image includes a second point image adjusted image obtained by performing processing of adjusting the blurriness amount by using a non-AI method, and the processor is configured to adjust an element derived from the point image adjustment processing by combining the first point image adjusted image and the second point image adjusted image at the ratio.

A twenty-fifth aspect according to the present disclosed technology is the image processing apparatus according to any one of the sixth to twenty-fourth aspects, in which the processing target image is an image obtained by imaging a third subject, the first image includes a first blurred image obtained by performing blur processing of applying a blurriness, which is determined in accordance with the third subject, to the processing target image by using an AI method, as processing included in the first AI processing, the second image includes a second blurred image obtained by performing processing of applying the blurriness to the processing target image by using a non-AI method, and the processor is configured to adjust an element derived from the blur processing by combining the first blurred image and the second blurred image at the ratio.

A twenty-sixth aspect according to the present disclosed technology is the image processing apparatus according to any one of the sixth to twenty-fifth aspects, in which the first image includes a first round blurriness image obtained by performing round blurriness processing of applying a first round blurriness to the processing target image by using an AI method, as processing included in the first AI processing, the second image includes a second round blurriness image obtained by performing processing of adjusting the first round blurriness from the processing target image by using a non-AI method or of applying a second round blurriness to the processing target image by using the non-AI method, and the processor is configured to adjust an element derived from the round blurriness processing by combining the first round blurriness image and the second round blurriness image at the ratio.

A twenty-seventh aspect according to the present disclosed technology is the image processing apparatus according to any one of the sixth to twenty-sixth aspects, in which the first image includes a first gradation adjusted image obtained by performing first gradation adjustment processing of adjusting a gradation of the processing target image by using an AI method, as processing included in the first AI processing, the second image includes a second gradation adjusted image obtained by performing second gradation adjustment processing of adjusting the gradation of the processing target image by using a non-AI method, and the processor is configured to adjust an element derived from the first gradation adjustment processing by combining the first gradation adjusted image and the second gradation adjusted image at the ratio.

A twenty-eighth aspect according to the present disclosed technology is the image processing apparatus according to the twenty-seventh aspect, in which the processing target image is an image obtained by imaging a fourth subject, the first gradation adjustment processing is processing of adjusting the gradation of the processing target image according to the fourth subject by using the AI method, and the second gradation adjustment processing is processing of adjusting the gradation of the processing target image according to the fourth subject by using the non-AI method.

A twenty-ninth aspect according to the present disclosed technology is the image processing apparatus according to any one of the sixth to twenty-eighth aspects, in which the first image includes an image style changed image obtained by performing image style change processing of changing an image style of the processing target image by using an AI method, as processing included in the first AI processing, and the processor is configured to adjust an element derived from the image style change processing by combining the image style changed image and the second image at the ratio.

A thirtieth aspect according to the present disclosed technology is the image processing apparatus according to any one of the sixth to twenty-ninth aspects, in which the processing target image is an image obtained by imaging skin, the first image includes a skin image quality adjusted image obtained by performing skin image quality adjustment processing of adjusting an image quality related to the skin captured in the processing target image by using an AI method, as processing included in the first AI processing, and the processor is configured to adjust an element derived from the skin image quality adjustment processing by combining the skin image quality adjusted image and the second image at the ratio.

A thirty-first aspect according to the present disclosed technology is the image processing apparatus according to any one of the sixth to thirtieth aspects, in which the first AI processing includes a plurality of purpose-specific processing performed by using an AI method, the first image includes a multiple processed image obtained by performing the plurality of purpose-specific processing on the processing target image, and the processor is configured to combine the multiple processed image and the second image at the ratio.

A thirty-two aspect according to the present disclosed technology is the image processing apparatus according to the thirty-first aspect, in which the plurality of purpose-specific processing are performed in an order based on a degree of influence applied on the processing target image.

A thirty-third aspect according to the present disclosed technology is the image processing apparatus according to the thirty-second aspect, in which the plurality of purpose-specific processing are performed stepwise from purpose-specific processing in which the degree of the influence is small to purpose-specific processing in which the degree of the influence is large.

A thirty-fourth aspect according to the present disclosed technology is the image processing apparatus according to any one of the fifth to thirty-two aspects, in which the ratio is defined based on a difference between the processing target image and the first image and/or a difference between the first image and the second image.

A thirty-fifth aspect according to the present disclosed technology is the image processing apparatus according to any one of the sixth to thirty-fourth aspects, in which the processor is configured to adjust the ratio according to related information that is related to the processing target image.

An imaging apparatus according to a thirty-sixth aspect of the present disclosed technology comprises: the image processing apparatus according to any one of the first to thirty-fourth aspects; and an image sensor, in which the processing target image is an image obtained by performing imaging by the image sensor.

An image processing method according to a thirty-seventh aspect of the present disclosed technology comprises: acquiring a first image, which is obtained by performing first AI processing on a processing target image, and a second image, which is obtained without performing the first AI processing on the processing target image; and adjusting excess and deficiency of the first AI processing by combining the first image and the second image.

An image processing method according to a thirty-eighth aspect of the present disclosed technology comprises: acquiring a first image, which is obtained by performing first AI processing on a processing target image to adjust a non-noise element of the processing target image, and a second image, which is obtained without performing the first AI processing on the processing target image; and adjusting the non-noise element by combining the first image and the second image.

A program according to a thirty-ninth aspect of the present disclosed technology causing a computer to execute a process comprises: acquiring a first image, which is obtained by performing first AI processing on a processing target image, and a second image, which is obtained without performing the first AI processing on the processing target image; and adjusting excess and deficiency of the first AI processing by combining the first image and the second image.

A program according to a fortieth aspect of the present disclosed technology causing a computer to execute a process comprises: acquiring a first image, which is obtained by performing first AI processing on a processing target image to adjust a non-noise element of the processing target image, and a second image, which is obtained without performing the first AI processing on the processing target image; and adjusting the non-noise element by combining the first image and the second image.

### BRIEF DESCRIPTION OF THE DRAWINGS

Exemplary embodiments of the technology of the disclosure will be described in detail based on the following figures, wherein:

FIG. 1 is a schematic configuration diagram showing an example of a configuration of an entire imaging apparatus;

FIG. 2 is a schematic configuration diagram showing an example of hardware configurations of an optical system and an electrical system of the imaging apparatus;

FIG. 3 is a block diagram showing an example of a function of an image processing engine;

FIG. 4 is a conceptual diagram showing an example of the content of processing of an AI method processing unit and a non-AI method processing unit;

FIG. 5 is a conceptual diagram showing an example of the content of processing of an image adjustment unit and a composition unit;

FIG. 6 is a flowchart showing an example of a flow of image composition processing;

FIG. 7 is a conceptual diagram showing an example of the content of processing of the AI method processing unit and the non-AI method processing unit according to a first modification example;

FIG. 8 is a conceptual diagram showing an example of the content of processing of the image adjustment unit and the composition unit according to the first modification example;

FIG. 9 is a flowchart showing an example of a flow of the image composition processing according to the first modification example;

FIG. 10 is a conceptual diagram showing an example of the content of processing in which the non-AI method processing unit colors a person region and a background region in a distinguishable manner by using a non-AI method;

FIG. 11 is a conceptual diagram showing an example of the content of processing of the AI method processing unit and the non-AI method processing unit according to a second modification example;

FIG. 12 is a conceptual diagram showing an example of the content of processing of the image adjustment unit and the composition unit according to the second modification example;

FIG. 13 is a flowchart showing an example of a flow of the image composition processing according to the second modification example;

FIG. 14 is a conceptual diagram showing an example of the contents of first clarity processing and second clarity processing;

FIG. 15 is a conceptual diagram showing an example of the content of processing in which a processor adjusts a contrast according to a subject;

FIG. 16 is a conceptual diagram showing an example of the content of processing of the AI method processing unit and the non-AI method processing unit according to a third modification example;

FIG. 17 is a conceptual diagram showing an example of the content of processing of the image adjustment unit and the composition unit according to the third modification example;

FIG. 18 is a flowchart showing an example of a flow of the image composition processing according to the third modification example;

FIG. 19 is a conceptual diagram showing an example of the content of processing of the AI method processing unit and the non-AI method processing unit according to a fourth modification example;

FIG. 20 is a conceptual diagram showing an example of the content of processing of the image adjustment unit and the composition unit according to the fourth modification example;

FIG. 21 is a flowchart showing an example of a flow of the image composition processing according to the fourth modification example;

FIG. 22 is a conceptual diagram showing an example of the content of processing of the AI method processing unit and the non-AI method processing unit according to a fifth modification example;

FIG. 23 is a conceptual diagram showing an example of the content of processing of the image adjustment unit and the composition unit according to the fifth modification example;

FIG. 24 is a flowchart showing an example of a flow of the image composition processing according to the fifth modification example;

FIG. 25 is a conceptual diagram showing an example of the content of processing of the AI method processing unit and the non-AI method processing unit according to a sixth modification example;

FIG. 26 is a conceptual diagram showing an example of the content of processing of the image adjustment unit and the composition unit according to the sixth modification example;

FIG. 27 is a flowchart showing an example of a flow of the image composition processing according to the sixth modification example;

FIG. 28 is a conceptual diagram showing an example of the content of processing of the AI method processing unit and the non-AI method processing unit according to a seventh modification example;

FIG. 29 is a conceptual diagram showing an example of the content of processing of the image adjustment unit and the composition unit according to the seventh modification example;

FIG. 30 is a flowchart showing an example of a flow of the image composition processing according to the seventh modification example;

FIG. 31 is a conceptual diagram showing an example of the content of processing of the AI method processing unit and the non-AI method processing unit according to an eighth modification example;

FIG. 32 is a conceptual diagram showing an example of the content of processing of the image adjustment unit and the composition unit according to the eighth modification example;

FIG. 33 is a flowchart showing an example of a flow of the image composition processing according to the eighth modification example;

FIG. 34 is a conceptual diagram showing a first example of the content of processing in which the non-AI method processing unit generates a second round blurriness by filtering a first round blurriness generated by using the AI method;

FIG. 35 is a conceptual diagram showing a second example of the content of processing in which the non-AI method processing unit generates a second round blurriness by filtering a first round blurriness generated by using the AI method;

FIG. 36 is a conceptual diagram showing an example of the content of processing of the AI method processing unit and the non-AI method processing unit according to a ninth modification example;

FIG. 37 is a conceptual diagram showing an example of the content of processing of the image adjustment unit and the composition unit according to the ninth modification example;

FIG. 38 is a flowchart showing an example of a flow of the image composition processing according to the ninth modification example;

FIG. 39 is a conceptual diagram showing an example of the content of processing of the AI method processing unit and the non-AI method processing unit according to a tenth modification example;

FIG. 40 is a conceptual diagram showing an example of the content of processing of the image adjustment unit and the composition unit according to the tenth modification example;

FIG. 41 is a flowchart showing an example of a flow of the image composition processing according to the tenth modification example;

FIG. 42 is a conceptual diagram showing an example of the content of processing of the AI method processing unit and the non-AI method processing unit according to an eleventh modification example;

FIG. 43 is a conceptual diagram showing an example of the content of processing of the image adjustment unit and the composition unit according to the eleventh modification example;

FIG. 44 is a flowchart showing an example of a flow of the image composition processing according to the eleventh modification example;

FIG. 45 is a conceptual diagram showing an example of an aspect in a case where the AI method processing unit performs a plurality of purpose-specific processing by using the AI method;

FIG. 46 is a conceptual diagram showing an example of the content of processing in which the processor derives a ratio according to a difference between a processing target image and a first image;

FIG. 47 is a conceptual diagram showing an example of the content of processing in which the processor derives a ratio according to a difference between the first image and a second image;

FIG. 48 is a conceptual diagram showing an example of the content of processing in which the processor adjusts the ratio based on related information; and

FIG. 49 is a conceptual diagram showing an example of a configuration of the imaging system.

### DETAILED DESCRIPTION

Hereinafter, an example of an embodiment of an image processing apparatus, an imaging apparatus, an image processing method, and a program according to the present disclosed technology will be described with reference to the accompanying drawings.

First, the wording used in the following description will be described.

CPU refers to an abbreviation of a “Central Processing Unit”. GPU refers to an abbreviation of a “Graphics Processing Unit”. TPU refers to an abbreviation of a “Tensor processing unit”. NVM refers to an abbreviation of a “Non-volatile memory”. RAM refers to an abbreviation of a “Random Access Memory”. IC refers to an abbreviation of an “Integrated Circuit”. ASIC refers to an abbreviation of an “Application Specific Integrated Circuit”. PLD refers to an abbreviation of a “Programmable Logic Device”. FPGA refers to an abbreviation of a “Field-Programmable Gate Array”. SoC refers to an abbreviation of a “System-on-a-chip”. SSD refers to an abbreviation of a “Solid State Drive”. USB refers to an abbreviation of a “Universal Serial Bus”. HDD refers to an abbreviation of a “Hard Disk Drive”. EEPROM refers to an abbreviation of an “Electrically Erasable and Programmable Read Only Memory”. EL refers to an abbreviation of “Electro-Luminescence”. I/F refers to an abbreviation of an “Interface”. UI refers to an abbreviation of a “User Interface”. fps refers to an abbreviation of a “frame per second”. MF refers to an abbreviation of “Manual Focus”. AF refers to an abbreviation of “Auto Focus”. CMOS refers to an abbreviation of a “Complementary Metal Oxide Semiconductor”. CCD refers to an abbreviation of a “Charge Coupled Device”. LAN refers to an abbreviation of a “Local Area Network”. WAN refers to an abbreviation of a “Wide Area Network”. AI refers to an abbreviation of “Artificial Intelligence”. A/D refers to an abbreviation of “Analog/Digital”. FIR refers to an abbreviation of a “Finite Impulse Response”. IIR refers to an abbreviation of an “Infinite Impulse Response”. VAE refers to an abbreviation for a “Variational Auto-Encoder”. GAN refers to an abbreviation for a “Generative Adversarial Network”.

In the present embodiment, the noise refers to noise generated due to an imaging performed by the imaging apparatus (for example, electrical noise that appears in an image (that is, an electronic image) obtained by being captured). In other words, the noise refers to inevitably generated electrical noise (for example, noise inevitably generated by an electrical factor). Specific examples of the noise include noise generated with an increase in an analog gain, dark current noise, pixel defects, and/or heat noise. Further, in the following, an element other than noise (that is, an element that represents an image other than noise) that appears in an image obtained by being captured is referred to as a “non-noise element”.

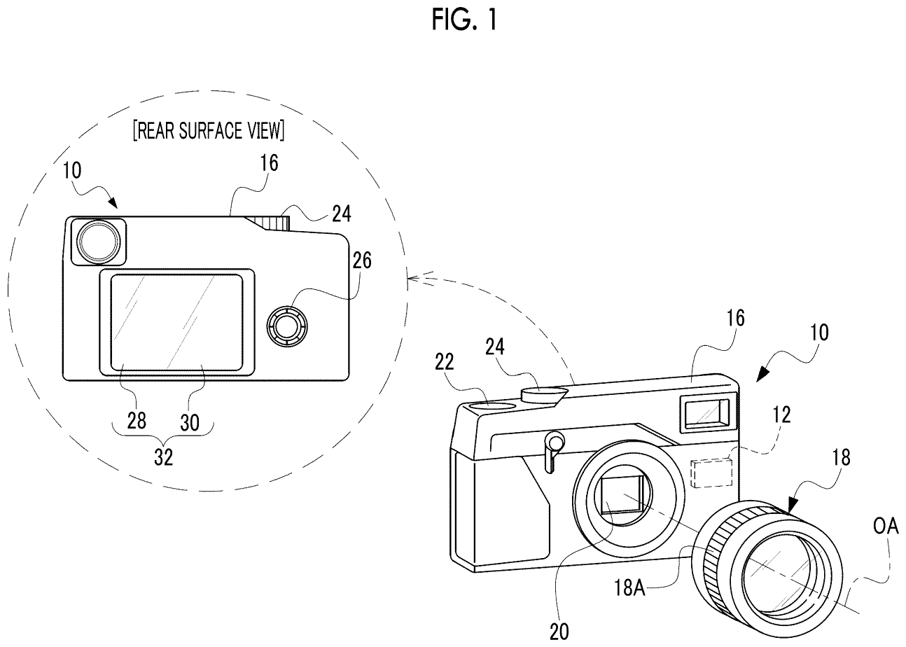

As an example shown in FIG. 1, the imaging apparatus 10 is an apparatus for imaging a subject and includes an image processing engine 12, an imaging apparatus main body 16, and an interchangeable lens 18. The imaging apparatus 10 is an example of an “imaging apparatus” according to the present disclosed technology. The interchangeable lens 18 is an example of a “lens” according to the present disclosed technology. The image processing engine 12 is an example of an “image processing apparatus” and a “computer” according to the present disclosed technology.

The image processing engine 12 is built into the imaging apparatus main body 16 and controls the entire imaging apparatus 10. The interchangeable lens 18 is interchangeably attached to the imaging apparatus main body 16. The interchangeable lens 18 is provided with a focus ring 18A. In a case where a user or the like of the imaging apparatus 10 (hereinafter, simply referred to as the “user”) manually adjusts the focus on the subject by the imaging apparatus 10, the focus ring 18A is operated by the user or the like.

In the example shown in FIG. 1, a lens-interchangeable digital camera is shown as an example of the imaging apparatus 10. However, this is only an example, and a digital camera with a fixed lens may be used or a digital camera, which is built into various types of electronic devices such as a smart device, a wearable terminal, a cell observation device, an ophthalmologic observation device, or a surgical microscope may be used.

An image sensor 20 is provided in the imaging apparatus main body 16. The image sensor 20 is an example of an “image sensor” according to the present disclosed technology. The image sensor 20 is a CMOS image sensor. The image sensor 20 generates and outputs image data indicating an image by imaging the subject. In a case where the interchangeable lens 18 is attached to the imaging apparatus main body 16, subject light indicating the subject is transmitted through the interchangeable lens 18 and imaged on the image sensor 20, and then image data is generated by the image sensor 20.

In the present embodiment, although the CMOS image sensor is exemplified as the image sensor 20, the present disclosed technology is not limited to this, for example, the present disclosed technology is established even in a case where the image sensor 20 is another type of image sensor such as a CCD image sensor.

A release button 22 and a dial 24 are provided on an upper surface of the imaging apparatus main body 16. The dial 24 is operated in a case where an operation mode of the imaging system, an operation mode of a playback system, and the like are set, and by operating the dial 24, an imaging mode, a playback mode, and a setting mode are selectively set as the operation mode in the imaging apparatus 10. The imaging mode is an operation mode in which the imaging is performed with respect to the imaging apparatus 10. The playback mode is an operation mode for playing the image (for example, a still image and/or a moving image) obtained by the performance of the imaging for recording in the imaging mode. The setting mode is an operation mode for setting the imaging apparatus 10 in a case where various types of set values used in the control related to the imaging are set.

The release button 22 functions as an imaging preparation instruction unit and an imaging instruction unit, and is capable of detecting a two-step pressing operation of an imaging preparation instruction state and an imaging instruction state. The imaging preparation instruction state refers to a state in which the release button 22 is pressed, for example, from a standby position to an intermediate position (half pressed position), and the imaging instruction state refers to a state in which the release button 22 is pressed to a final pressed position (fully pressed position) beyond the intermediate position. In the following, the “state of being pressed from the standby position to the half pressed position” is referred to as a “half pressed state”, and the “state of being pressed from the standby position to the fully pressed position” is referred to as a “fully pressed state”. Depending on the configuration of the imaging apparatus 10, the imaging preparation instruction state may be a state in which the user's finger is in contact with the release button 22, and the imaging instruction state may be a state in which the operating user's finger is moved from the state of being in contact with the release button 22 to the state of being away from the release button 22.

An instruction key 26 and a touch panel display 32 are provided on a rear surface of the imaging apparatus main body 16.

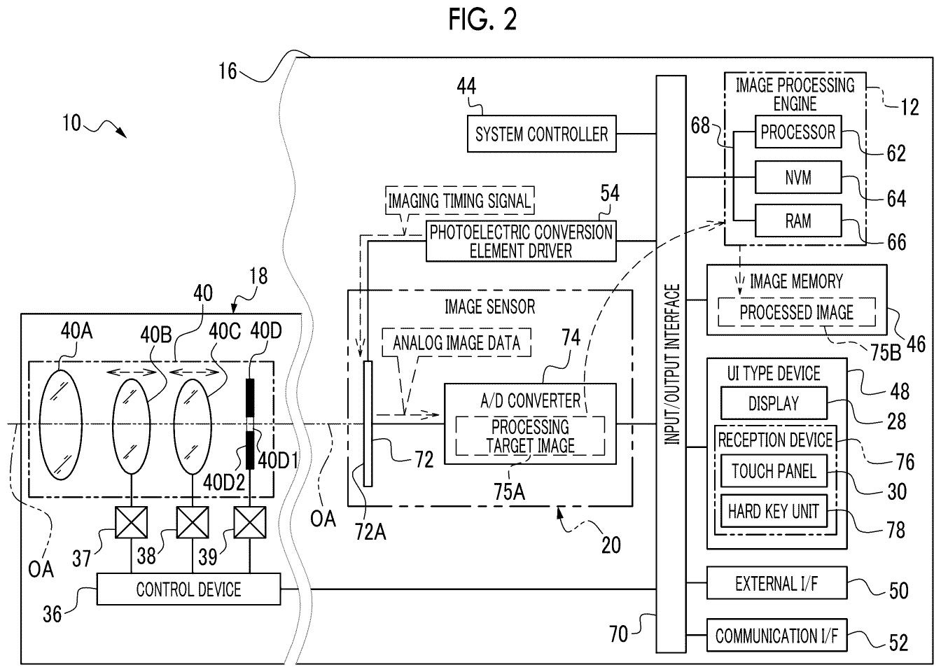

The touch panel display 32 includes a display 28 and a touch panel 30 (see also FIG. 2). Examples of the display 28 include an EL display (for example, an organic EL display or an inorganic EL display). The display 28 may not be an EL display but may be another type of display such as a liquid crystal display.

The display 28 displays image and/or character information and the like. The display 28 is used for imaging for a live view image, that is, for displaying a live view image obtained by performing the continuous imaging in a case where the imaging apparatus 10 is in the imaging mode. Here, the “live view image” refers to a moving image for display based on the image data obtained by being imaged by the image sensor 20. The imaging, which is performed to obtain the live view image (hereinafter, also referred to as “imaging for a live view image”), is performed according to, for example, a frame rate of 60 fps. 60 fps is only an example, and a frame rate of fewer than 60 fps may be used, or a frame rate of more than 60 fps may be used.

The display 28 is also used for displaying a still image obtained by the performance of the imaging for a still image in a case where an instruction for performing the imaging for a still image is provided to the imaging apparatus 10 via the release button 22. The display 28 is also used for displaying a playback image or the like in a case where the imaging apparatus 10 is in the playback mode. Further, the display 28 is also used for displaying a menu screen where various menus can be selected and displaying a setting screen for setting the various set values used in control related to the imaging in a case where the imaging apparatus 10 is in the setting mode.

The touch panel 30 is a transmissive touch panel and is superimposed on a surface of a display region of the display 28. The touch panel 30 receives the instruction from the user by detecting contact with an indicator such as a finger or a stylus pen. In the following, for convenience of explanation, the above-mentioned “fully pressed state” includes a state in which the user turns on a softkey for starting the imaging via the touch panel 30.

In the present embodiment, although an out-cell type touch panel display in which the touch panel 30 is superimposed on the surface of the display region of the display 28 is exemplified as an example of the touch panel display 32, this is only an example. For example, as the touch panel display 32, an on-cell type or in-cell type touch panel display can be applied.

The instruction key 26 receives various instructions. Here, the “various instructions” refer to, for example, various instructions such as an instruction for displaying the menu screen, an instruction for selecting one or a plurality of menus, an instruction for confirming a selected content, an instruction for erasing the selected content, zooming in, zooming out, frame forwarding, and the like. Further, these instructions may be provided by the touch panel 30.

As an example shown in FIG. 2, the image sensor 20 includes photoelectric conversion elements 72. The photoelectric conversion elements 72 have a light-receiving surface 72A, and the subject light is formed on the light-receiving surface 72A via the interchangeable lens 18. The light-receiving surface 72A is an example of a “light-receiving surface” according to the present disclosed technology. The photoelectric conversion elements 72 are disposed in the imaging apparatus main body 16 such that the center of the light-receiving surface 72A and an optical axis OA coincide with each other (see also FIG. 1). The photoelectric conversion elements 72 have a plurality of photosensitive pixels arranged in a matrix shape, and the light-receiving surface 72A is formed by the plurality of photosensitive pixels. Each photosensitive pixel has a micro lens (not shown). The photosensitive pixel is a physical pixel having a photodiode (not shown), which photoelectrically converts the received light and outputs an electric signal according to the light receiving amount.

Further, red (R), green (G), or blue (B) color filters (not shown) are arranged in a matrix shape in a default pattern arrangement (for example, Bayer arrangement, G stripe R/G complete checkered pattern, X-Trans (registered trademark) arrangement, honeycomb arrangement, or the like) on the plurality of photosensitive pixels. In the following, for convenience of explanation, a photosensitive pixel having a micro lens and an R color filter is referred to as an R pixel, a photosensitive pixel having a micro lens and a G color filter is referred to as a G pixel, and a photosensitive pixel having a micro lens and a B color filter is referred to as a B pixel.

The interchangeable lens 18 includes an imaging lens 40. The imaging lens 40 has an objective lens 40A, a focus lens 40B, a zoom lens 40C, and a stop 40D. The objective lens 40A, the focus lens 40B, the zoom lens 40C, and the stop 40D are disposed in the order of the objective lens 40A, the focus lens 40B, the zoom lens 40C, and the stop 40D along the optical axis OA from the subject side (that is, object side) to the imaging apparatus main body 16 side (that is, image side).

Further, the interchangeable lens 18 includes a control device 36, a first actuator 37, a second actuator 38, and a third actuator 39. The control device 36 controls the entire interchangeable lens 18 according to the instruction from the imaging apparatus main body 16. The control device 36 is a device having a computer including, for example, a CPU, an NVM, a RAM, and the like. The NVM of the control device 36 is, for example, an EEPROM. Further, the RAM of the control device 36 temporarily stores various types of information and is used as a work memory. In the control device 36, the CPU reads a necessary program from the NVM and executes the read various programs on the RAM to control the entire imaging lens 40.

Although a device having a computer is exemplified here as an example of the control device 36, this is only an example, and a device including an ASIC, FPGA, and/or PLD may be applied. Further, as the control device 36, for example, a device implemented by a combination of a hardware configuration and a software configuration may be used.

The first actuator 37 includes a slide mechanism for focus (not shown) and a motor for focus (not shown). The focus lens 40B is attached to the slide mechanism for focus so as to be slidable along the optical axis OA. Further, the motor for focus is connected to the slide mechanism for focus, and the slide mechanism for focus operates by receiving the power of the motor for focus to move the focus lens 40B along the optical axis OA.

The second actuator 38 includes a slide mechanism for zoom (not shown) and a motor for zoom (not shown). The zoom lens 40C is attached to the slide mechanism for zoom so as to be slidable along the optical axis OA. Further, the motor for zoom is connected to the slide mechanism for zoom, and the slide mechanism for zoom operates by receiving the power of the motor for zoom to move the zoom lens 40C along the optical axis OA.

The third actuator 39 includes a power transmission mechanism (not shown) and a motor for stop (not shown). The stop 40D has an opening 40D1 and is a stop in which the size of the opening 40D1 is variable. The opening 40D1 is formed by a plurality of stop leaf blades for example. The plurality of stop leaf blades 40D2 are connected to the power transmission mechanism. Further, the motor for stop is connected to the power transmission mechanism, and the power transmission mechanism transmits the power of the motor for stop to the plurality of stop leaf blades 40D2. The plurality of stop leaf blades 40D2 receives the power that is transmitted from the power transmission mechanism and changes the size of the opening 40D1 by being operated. The stop 40D adjusts the exposure by changing the size of the opening 40D1.

The motor for focus, the motor for zoom, and the motor for stop are connected to the control device 36, and the control device 36 controls each drive of the motor for focus, the motor for zoom, and the motor for stop. In the present embodiment, a stepping motor is adopted as an example of the motor for focus, the motor for zoom, and the motor for stop. Therefore, the motor for focus, the motor for zoom, and the motor for stop operate in synchronization with a pulse signal in response to a command from the control device 36. Although an example in which the motor for focus, the motor for zoom, and the motor for stop are provided in the interchangeable lens 18 has been described here, this is only an example, and at least one of the motor for focus, the motor for zoom, or the motor for stop may be provided in the imaging apparatus main body 16. The constituent and/or operation method of the interchangeable lens 18 can be changed as needed.

In the imaging apparatus 10, in the case of the imaging mode, an MF mode and an AF mode are selectively set according to the instructions provided to the imaging apparatus main body 16. The MF mode is an operation mode for manually focusing. In the MF mode, for example, by operating the focus ring 18A or the like by the user, the focus lens 40B is moved along the optical axis OA with the movement amount according to the operation amount of the focus ring 18A or the like, thereby the focus is adjusted.

In the AF mode, the imaging apparatus main body 16 calculates a focusing position according to a subject distance and adjusts the focus by moving the focus lens 40B toward the calculated focusing position. Here, the focusing position refers to a position of the focus lens on the optical axis OA in a state of being in focus.

The imaging apparatus main body 16 includes the image processing engine 12, the image sensor 20, the system controller 44, an image memory 46, a UI type device 48, an external I/F 50, a communication I/F 52, a photoelectric conversion element driver 54, and an input/output interface 70. Further, the image sensor 20 includes the photoelectric conversion elements 72 and an A/D converter 74.

The image processing engine 12, the image memory 46, the UI type device 48, the external I/F 50, the photoelectric conversion element driver 54, and the A/D converter 74 are connected to the input/output interface 70. Further, the control device 36 of the interchangeable lens 18 is also connected to the input/output interface 70.

The system controller 44 includes a CPU (not shown), an NVM (not shown), and a RAM (not shown). In the system controller 44, the NVM is a non-temporary storage medium and stores various parameters and various programs. The NVM of the system controller 44 is, for example, an EEPROM. However, this is only an example, and an HDD and/or SSD or the like may be applied as the NVM of a system controller 44 instead of or together with the EEPROM. Further, the RAM of the system controller 44 temporarily stores various types of information and is used as a work memory. In the system controller 44, the CPU reads a necessary program from the NVM and executes the read various programs on the RAM to control the entire imaging apparatus 10. That is, in the example shown in FIG. 2, the image processing engine 12, the image memory 46, the UI type device 48, the external I/F 50, the communication I/F 52, the photoelectric conversion element driver 54, and the control device 36 are controlled by the system controller 44.

The image processing engine 12 operates under the control of the system controller 44. The image processing engine 12 includes a processor 62, an NVM 64, and a RAM 66. Here, the processor 62 is an example of a “processor” according to the present disclosed technology.

The processor 62, the NVM 64, and the RAM 66 are connected via a bus 68, and the bus 68 is connected to the input/output interface 70. In the example shown in FIG. 2, one bus is shown as the bus 68 for convenience of illustration, but a plurality of buses may be used. The bus 68 may be a serial bus or may be a parallel bus including a data bus, an address bus, a control bus, and the like.

The processor 62 includes a CPU and a GPU, and the GPU is operated under the control of the CPU and is mainly responsible for executing image processing. The processor 62 may be one or more CPUs integrated with a GPU function or may be one or more CPUs not integrated with the GPU function. Further, the processor 62 may include a multi-core CPU or a TPU.

The NVM 64 is a non-temporary storage medium and stores various parameters and various programs, which are different from the various parameters and various programs stored in the NVM of the system controller 44. For example, the NVM 64 is an EEPROM. However, this is only an example, and an HDD and/or SSD or the like may be applied as the NVM 64 instead of or together with the EEPROM. Further, the RAM 66 temporarily stores various types of information and is used as a work memory.

The processor 62 reads a necessary program from the NVM 64 and executes the read program in the RAM 66. The processor 62 performs various types of image processing according to a program executed on the RAM 66.

The photoelectric conversion element driver 54 is connected to the photoelectric conversion elements 72. The photoelectric conversion element driver 54 supplies an imaging timing signal, which defines the timing of the imaging performed by the photoelectric conversion elements 72, to the photoelectric conversion elements 72 according to an instruction from the processor 62. The photoelectric conversion elements 72 perform reset, exposure, and output of an electric signal according to the imaging timing signal supplied from the photoelectric conversion element driver 54. Examples of the imaging timing signal include a vertical synchronization signal, and a horizontal synchronization signal.

In a case where the interchangeable lens 18 is attached to the imaging apparatus main body 16, the subject light incident on the imaging lens 40 is imaged on the light-receiving surface 72A by the imaging lens 40. Under the control of the photoelectric conversion element driver 54, the photoelectric conversion elements 72 photoelectrically convert the subject light, which is received from the light-receiving surface 72A and output the electric signal corresponding to the amount of light of the subject light to the A/D converter 74 as analog image data indicating the subject light. Specifically, the A/D converter 74 reads the analog image data from the photoelectric conversion elements 72 in units of one frame and for each horizontal line by using an exposure sequential reading method.

The A/D converter 74 generates a processing target image 75A by digitizing analog image data. The processing target image 75A is a captured image obtained by performing imaging by the imaging apparatus 10 and is an example of a “processing target image” and a “captured image” according to the present disclosed technology. The processing target image 75A is an image in which the R pixels, the G pixels, and the B pixels are arranged in a mosaic shape.

In the present embodiment, as an example, the processor 62 of the image processing engine 12 acquires the processing target image 75A from the A/D converter 74 and performs various types of the image processing on the acquired processing target image 75A.

A processed image 75B is stored in the image memory 46. The processed image 75B is an image obtained by performing various types of image processing on the processing target image 75A by the processor 62.

The UI type device 48 includes a display 28, and the processor 62 displays various types of information on the display 28. Further, the UI type device 48 includes a reception device 76. The reception device 76 includes a touch panel 30 and a hard key unit 78. The hard key unit 78 is a plurality of hard keys including an instruction key 26 (see FIG. 1). The processor 62 operates according to various instructions received by using the touch panel 30. Here, although the hard key unit 78 is included in the UI type device 48, the present disclosed technology is not limited to this, for example, the hard key unit 78 may be connected to the external I/F 50.

The external I/F 50 controls the exchange of various information between the imaging apparatus 10 and an apparatus existing outside the imaging apparatus 10 (hereinafter, also referred to as an “external apparatus”). Examples of the external I/F 50 include a USB interface. The external apparatus (not shown) such as a smart device, a personal computer, a server, a USB memory, a memory card, and/or a printer is directly or indirectly connected to the USB interface.

The communication I/F 52 is connected to a network (not shown). The communication I/F 52 controls the exchange of information between a communication device (not shown) such as a server on the network and the system controller 44. For example, the communication I/F 52 transmits information in response to a request from the system controller 44 to the communication device via the network. Further, the communication I/F 52 receives the information transmitted from the communication device and outputs the received information to the system controller 44 via the input/output interface 70.

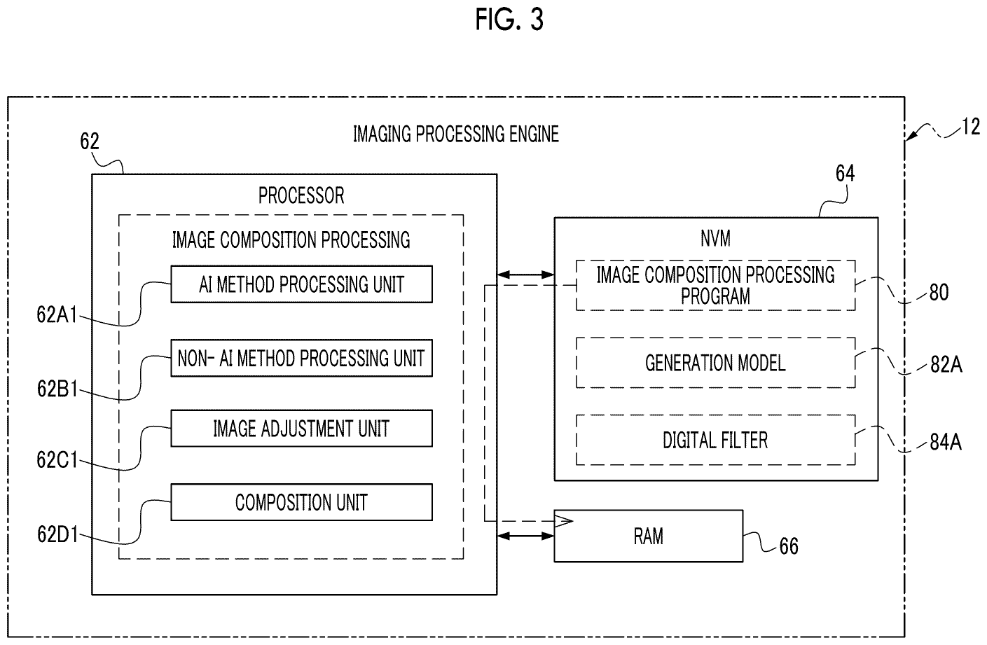

As an example shown in FIG. 3, an image composition processing program 80 is stored in the NVM 64 of the imaging apparatus 10. The image composition processing program 80 is an example of a “program” according to the present disclosed technology.

The generation model 82A is stored in the NVM 64 of the imaging apparatus 10. An example of the generation model 82A is a trained generation network. Examples of the generation network include GAN, VAE, and the like. The processor 62 performs AI method processing on the processing target image 75A (see FIG. 2). An example of the AI method processing includes processing that uses the generation model 82A. Hereinafter, for convenience of explanation, the processing, which uses the generation model 82A, will be described as the processing that is actively performed mainly by the generation model 82A. That is, for convenience of explanation, the generation model 82A will be described assuming that it is a function of performing processing on the input information and outputting the processing result.

A digital filter 84A is stored in the NVM 64 of the imaging apparatus 10. An example of the digital filter 84A includes an FIR filter. The FIR filter is only an example, and may be another digital filter such as an IIR filter. Hereinafter, for convenience of explanation, the processing, which uses the digital filter 84A, will be described as the processing that is actively performed mainly by the digital filter 84A. That is, for convenience of explanation, the digital filter 84A will be described assuming that it is a function of performing processing on the input information and outputting the processing result.

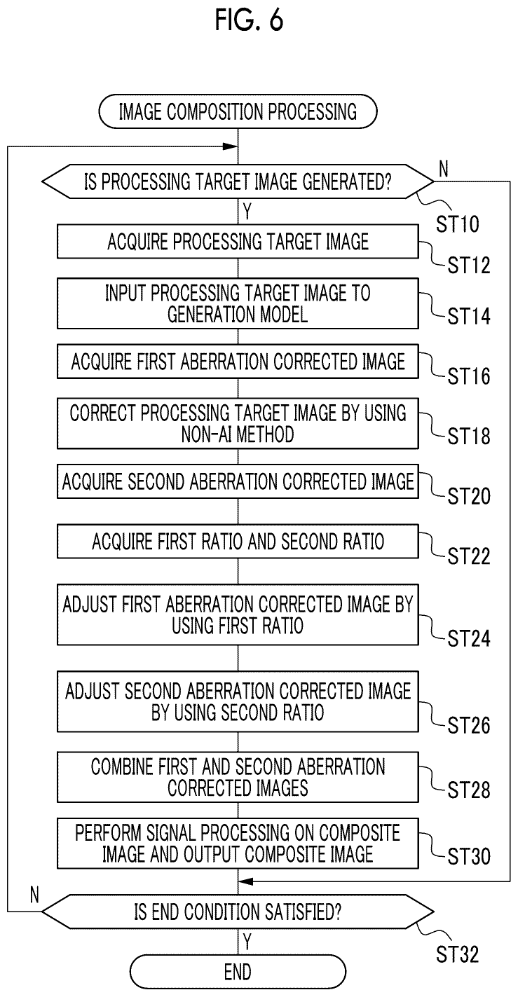

The processor 62 reads the image composition processing program 80 from the NVM 64 and executes the read image composition processing program 80 on the RAM 66. The processor 62 performs the image composition processing (see FIG. 6) according to the image composition processing program 80 executed on the RAM 66. The image composition processing is implemented by operating the processor 62 as an AI method processing unit 62A1, a non-AI method processing unit 62B1, an image adjustment unit 62C1, and a composition unit 62D1 according to the image composition processing program 80. The generation model 82A is used by the AI method processing unit 62A1, and the digital filter 84A is used by the non-AI method processing unit 62B1.

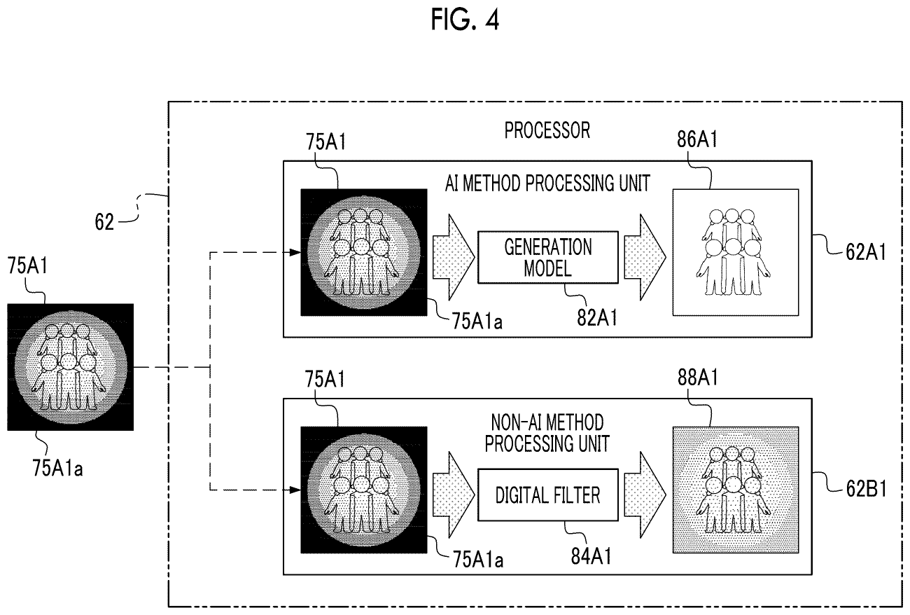

As an example shown in FIG. 4, a processing target image 75A1 is input to the AI method processing unit 62A1 and the non-AI method processing unit 62B1. The processing target image 75A1 is an example of the processing target image 75A shown in FIG. 2. In the example shown in FIG. 4, an image region 75A1a is shown as an image region received an influenced of an aberration (hereinafter, simply referred to as an “aberration”) of the imaging lens 40 (see FIG. 2) in the processing target image 75A1 (that is, an image region where the aberration is reflected).

The processing target image 75A1 is an image having a non-noise element. An example of the non-noise element includes the image region 75A1a. The image region 75A1a is an example of a “non-noise element of the processing target image”, a “phenomenon that appears in the processing target image due to the characteristic of the imaging apparatus”, a “blurriness”, and a “region where an aberration of the lens is reflected in the captured image” according to the present disclosed technology.

In the example shown in FIG. 4, an image region where the field curvature is reflected is shown as an example of the image region 75A1a. Further, in the example shown in FIG. 4, as the image region 75A1a, an aspect (that is, an aspect in which the back blurriness is reflected) in which the processing target image 75A1 is gradually darkened from the center along the outer side in the radial direction due to the field curvature is shown.

Here, although the field curvature is exemplified as an aberration reflected in the processing target image 75A1, this is only an example, and the aberration reflected in the processing target image 75A1 may be other types of aberration such as spherical aberration, coma aberration, astigmatism, distortion, axial chromatic aberration, or lateral chromatic aberration. The aberration is an example of a “characteristic of the imaging apparatus” and an “optical characteristic of the imaging apparatus” according to the present disclosed technology.

The AI method processing unit 62A1 performs AI method processing on the processing target image 75A1. An example of the AI method processing on the processing target image 75A1 includes processing that uses the generation model 82A1. The generation model 82A1 is an example of the generation model 82A shown in FIG. 3. The generation model 82A1 is a generation network that has already been trained to reduce the influence of the aberration (here, for example, the field curvature). The AI method processing unit 62A1 generates a first aberration corrected image 86A1 by performing processing, which uses the generation model 82A1, on the processing target image 75A1. In other words, the AI method processing unit 62A1 generates the first aberration corrected image 86A1 by adjusting the non-noise element (here, as an example, the image region 75A1a) in the processing target image 75A1 by using the AI method. In other words, the AI method processing unit 62A1 generates the first aberration corrected image 86A1 by correcting the image region 75A1a (that is, the region where the aberration is reflected) in the processing target image 75A1 by using the AI method. Here, the processing, which uses the generation model 82A1, is an example of “first AI processing”, “first correction processing”, and “first aberration region correction processing” according to the present disclosed technology. Further, here, “generating the first aberration corrected image 86A1” is an example of “acquiring a first image” according to the present disclosed technology.

The processing target image 75A1 is input to the generation model 82A1. The generation model 82A1 generates and outputs the first aberration corrected image 86A1 based on the input processing target image 75A1. The first aberration corrected image 86A1 is an image obtained by adjusting the non-noise element by using the generation model 82A1 (that is, an image obtained by adjusting the non-noise element by the processing, which uses the generation model 82A1, with respect to the processing target image 75A1). In other words, the first aberration corrected image 86A1 is an image in which the non-noise element in the processing target image 75A1 is corrected by using the generation model 82A1 (that is, an image in which the non-noise element is corrected by performing the processing, which uses the generation model 82A1, with respect to the processing target image 75A1). In other words, the first aberration corrected image 86A1 is an image in which the image region 75A1a is corrected by using the generation model 82A1 (that is, an image in which the image region 75A1a is corrected such that the influence of the aberration is reduced by the processing, which uses the generation model 82A1, with respect to the processing target image 75A1). The first aberration corrected image 86A1 is an example of a “first image”, a “first corrected image”, and a “first aberration corrected image” according to the present disclosed technology.

The non-AI method processing unit 62B1 performs non-AI method processing on the processing target image 75A1. The non-AI method processing refers to processing that does not use a neural network. Here, examples of the processing that does not use the neural network include processing that does not use the generation model 82A1.

An example of the non-AI method processing on the processing target image 75A1 includes processing that uses the digital filter 84A1. The digital filter 84A1 is a digital filter configured to reduce the influence of the aberration (here, for example, the field curvature). The non-AI method processing unit 62B1 generates a second aberration corrected image 88A1 by performing the processing (that is, filtering), which uses the digital filter 84A1, on the processing target image 75A1. In other words, the non-AI method processing unit 62B1 generates the second aberration corrected image 88A1 by adjusting the non-noise element (here, as an example, the image region 75A1a) in the processing target image 75A1 by using the non-AI method. In other words, the non-AI method processing unit 62B1 generates the second aberration corrected image 88A1 by correcting the image region 75A1a (that is, the region where the aberration is reflected) in the processing target image 75A1 by using the non-AI method. Here, the processing, which uses the digital filter 84A1, is an example of “non-AI method processing that does not use a neural network”, “second correction processing”, and “processing of correcting by using the non-AI method” according to the present disclosed technology. Further, here, “generating the second aberration corrected image 88A1” is an example of “acquiring a second image” according to the present disclosed technology.

The processing target image 75A1 is input to the digital filter 84A1. The digital filter 84A1 generates the second aberration corrected image 88A1 based on the input processing target image 75A1. The second aberration corrected image 88A1 is an image obtained by adjusting the non-noise element by using the digital filter 84A1 (that is, an image obtained by adjusting the non-noise element by the processing, which uses the digital filter 84A1, with respect to the processing target image 75A1). In other words, the second aberration corrected image 88A1 is an image in which the non-noise element in the processing target image 75A1 is corrected by using the digital filter 84A1 (that is, an image in which the non-noise element is corrected by the processing, which uses the digital filter 84A1, with respect to the processing target image 75A1). In other words, the second aberration corrected image 88A1 is an image in which the image region 75A1a is corrected by using the digital filter 84A1 (that is, an image in which the image region 75A1a is corrected such that the influence of the aberration is reduced by the processing, which uses the digital filter 84A1, with respect to the processing target image 75A1). The second aberration corrected image 88A1 is an example of a “second image”, a “second corrected image”, and a “second aberration corrected image” according to the present disclosed technology.

By the way, there is a user who does not completely eliminate the influence of the aberration but rather wants to appropriately leave the influence of the aberration in the image. In the example shown in FIG. 4, the influence of the aberration is reduced in the first aberration corrected image 86A1 as compared with the second aberration corrected image 88A1. In other words, the second aberration corrected image 88A1 is more influenced by the aberration than the first aberration corrected image 86A1. However, the user may feel that the influence of the aberration in the first aberration corrected image 86A1 is too small and that the influence of the aberration in the second aberration corrected image 88A1 is too large. Therefore, in a case where only one of the first aberration corrected image 86A1 or the second aberration corrected image 88A1 is finally output, an image that does not suit the user's preference is provided to the user. In a case where the performance of the generation model 82A1 is improved by increasing the amount of training for the generation model 82A1 or increasing the number of interlayers of the generation model 82A1, there is an increased possibility that an image close to the user's preference can be obtained. However, the cost required for creating the generation model 82A1 is high, and as a result, there is a possibility that the cost of the imaging apparatus 10 is increased.

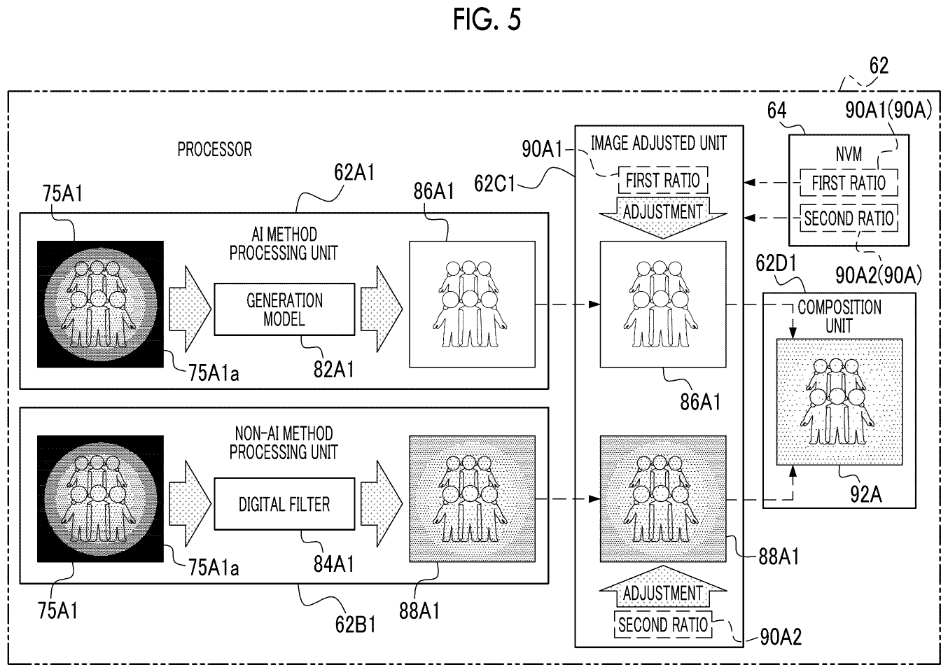

Therefore, in view of such circumstances, in the imaging apparatus 10, as an example shown in FIG. 5, by performing the processing of the image adjustment unit 62C1 and the processing of the composition unit 62D1 on the first aberration corrected image 86A1 and the second aberration corrected image 88A1, the first aberration corrected image 86A1 and the second aberration corrected image 88A1 are combined.

As an example shown in FIG. 5, a ratio 90A is stored in the NVM 64. The ratio 90A is a ratio for combining the first aberration corrected image 86A1 and the second aberration corrected image 88A1 and is defined to adjust excess and deficiency of the AI method processing (that is, the processing that uses the generation model 82A1) performed by the AI method processing unit 62A1.

The ratio 90A is roughly classified into a first ratio 90A1 and a second ratio 90A2. The first ratio 90A1 is a value of 0 or more and 1 or less, and the second ratio 90A2 is a value obtained by subtracting the value of the first ratio 90A1 from “1”. That is, the first ratio 90A1 and the second ratio 90A2 are defined such that the sum of the first ratio 90A1 and the second ratio 90A2 is “1”. The first ratio 90A1 and the second ratio 90A2 are variable values that are changed by an instruction from the user. The instruction from the user is received by the reception device 76 (see FIG. 2).

The image adjustment unit 62C1 adjusts the first aberration corrected image 86A1 generated by the AI method processing unit 62A1 by using the first ratio 90A1. For example, the image adjustment unit 62C1 adjusts a pixel value of each pixel of the first aberration corrected image 86A1 by multiplying a pixel value of each pixel of the first aberration corrected image 86A1 by the first ratio 90A1.

The image adjustment unit 62C1 adjusts the second aberration corrected image 88A1 generated by the non-AI method processing unit 62B1 by using the second ratio 90A2. For example, the image adjustment unit 62C1 adjusts a pixel value of each pixel of the second aberration corrected image 88A1 by multiplying a pixel value of each pixel of the second aberration corrected image 88A1 by the second ratio 90A2.

The composition unit 62D1 generates a composite image 92A by combining the first aberration corrected image 86A1 adjusted at the first ratio 90A1 by the image adjustment unit 62C1 and the second aberration corrected image 88A1 adjusted at the second ratio 90A2 by the image adjustment unit 62C1. That is, the composition unit 62D1 adjusts the excess and deficiency of the AI method processing performed by the AI method processing unit 62A1 by combining the first aberration corrected image 86A1 adjusted at the first ratio 90A1 and the second aberration corrected image 88A1 adjusted at the second ratio 90A2. In other words, the composition unit 62D1 adjusts the non-noise element (here, as an example, the image region 75A1a) by combining the first aberration corrected image 86A1 adjusted at the first ratio 90A1 and the second aberration corrected image 88A1 adjusted at the second ratio 90A2. Further, in other words, the composition unit 62D1 adjusts an element derived from the processing that uses the generation model 82A1 (for example, the pixel value of the pixel for which the influence of the aberration is reduced by using the generation model 82A1) by combining the first aberration corrected image 86A1 adjusted at the first ratio 90A1 and the second aberration corrected image 88A1 adjusted at the second ratio 90A2.

The composition, which is performed by the composition unit 62D1, is an addition of a pixel value of a corresponding pixel position between the first aberration corrected image 86A1 and the second aberration corrected image 88A1. Here, the addition refers to, for example, a simple addition. In the example shown in FIG. 5, as an example of the composite image 92A, an image, which is obtained by combining the first aberration corrected image 86A1 and the second aberration corrected image 88A1 in a case where both a value of the first ratio 90A1 and a value of the second ratio 90A2 are “0.5”, is shown. In this case, half of the influence of the first aberration corrected image 86A1 (that is, the influence of the processing that uses the generation model 82A1) and the influence of the second aberration corrected image 88A1 (that is, the influence of the processing that uses the digital filter 84A1) are reflected in the composite image 92A.

In a case where the first ratio 90A1 is made larger than the second ratio 90A2, the influence of the first aberration corrected image 86A1 is reflected in the composite image 92A more than the influence of the second aberration corrected image 88A1. On the contrary, in a case where the second ratio 90A2 is made larger than the first ratio 90A1, the influence of the second aberration corrected image 88A1 is reflected in the composite image 92A more than the influence of the first aberration corrected image 86A1.

The composition unit 62D1 performs various types of image processing on the composite image 92A (for example, known image processing such as an offset correction, a white balance correction, demosaic processing, a color correction, a gamma correction, a color space conversion, brightness processing, color difference processing, and resizing processing). The composition unit 62D1 outputs an image obtained by performing various types of image processing on the composite image 92A to a default output destination (for example, an image memory 46 shown in FIG. 2) as the processed image 75B (see FIG. 2).

Next, the operation of the imaging apparatus 10 will be described with reference to FIG. 6. FIG. 6 shows an example of a flow of the image composition processing executed by the processor 62. The flow of the image composition processing shown in FIG. 6 is an example of an “image processing method” according to the present disclosed technology.

In the image composition processing shown in FIG. 6, first, in step ST10, the AI method processing unit 62A1 determines whether or not the processing target image 75A1 is generated by the image sensor 20 (see FIG. 2). In a case where the processing target image 75A1 is not generated by the image sensor 20 in step ST10, the determination is set as negative, and the image composition processing shifts to step ST32. In a case where the processing target image 75A1 is generated by the image sensor 20 in step ST10, the determination is set as positive, and the image composition processing shifts to step ST12.

In step ST12, the AI method processing unit 62A1 and the non-AI method processing unit 62B1 acquire the processing target image 75A1 from the image sensor 20. After the processing in step ST12 is executed, the image composition processing shifts to step ST14.

In step ST14, the AI method processing unit 62A1 inputs the processing target image 75A1 acquired in step ST12 to the generation model 82A1. After the processing in step ST14 is executed, the image composition processing shifts to step ST16.

In step ST16, the AI method processing unit 62A1 acquires the first aberration corrected image 86A1 output from the generation model 82A1 by inputting the processing target image 75A1 to the generation model 82A1 in step ST14. After the processing in step ST16 is executed, the image composition processing shifts to step ST18.

In step ST18, the non-AI method processing unit 62B1 corrects the influence of the aberration (that is, the image region 75A1a) by performing the processing, which uses the digital filter 84A1, on the processing target image 75A1 acquired in step ST12. After the processing in step ST18 is executed, the image composition processing shifts to step ST20.

In step ST20, the non-AI method processing unit 62B1 acquires the second aberration corrected image 88A1 obtained by performing the processing, which uses the digital filter 84A1, on the processing target image 75A1 in step ST18. After the processing in step ST20 is executed, the image composition processing shifts to step ST22.

In step ST22, the image adjustment unit 62C1 acquires the first ratio 90A1 and the second ratio 90A2 from the NVM64. After the processing in step ST22 is executed, the image composition processing shifts to step ST24.

In step ST24, the image adjustment unit 62C1 adjusts the first aberration corrected image 86A1 by using the first ratio 90A1 acquired in step ST22. After the processing in step ST24 is executed, the image composition processing shifts to step ST26.

In step ST26, the image adjustment unit 62C1 adjusts the second aberration corrected image 88A1 by using the second ratio 90A2 acquired in step ST22. After the processing in step ST26 is executed, the image composition processing shifts to step ST28.

In step ST28, the composition unit 62D1 adjusts the excess and deficiency of the AI method processing performed by the AI method processing unit 62A1 by combining the first aberration corrected image 86A1 adjusted in step ST24 and the second aberration corrected image 88A1 adjusted in step ST26. The composite image 92A is generated by combining the first aberration corrected image 86A1 adjusted in step ST24 and the second aberration corrected image 88A1 adjusted in step ST26. After the processing in step ST28 is executed, the image composition processing shifts to step ST30.

In step ST30, the composition unit 62D1 performs various types of image processing on the composite image 92A. The composition unit 62D1 outputs an image obtained by performing various types of image processing on the composite image 92A to a default output destination as the processed image 75B. After the processing in step ST30 is executed, the image composition processing shifts to step ST32.

In step ST32, the composition unit 62D1 determines whether or not the condition for ending the image composition processing (hereinafter, referred to as an “end condition”) is satisfied. Examples of the end condition include a condition that the reception device 76 receives an instruction of ending the image composition processing. In step ST32, in a case where the end condition is not satisfied, the determination is set as negative, and the image composition processing shifts to step ST10. In step ST32, in a case where the end condition is satisfied, the determination is set as positive, and the image composition processing is ended.

As described above, in the imaging apparatus 10, the processing target image 75A1 is acquired by the AI method processing unit 62A1 and the non-AI method processing unit 62B1 as an image having the image region 75A1a in which the influence of the aberration is reflected. The AI method processing unit 62A1 performs the AI method processing (that is, the processing that uses the generation model 82A1) on the processing target image 75A1. As a result, the first aberration corrected image 86A1 is generated. Further, the non-AI method processing unit 62B1 performs the non-AI method processing (that is, the processing that uses the digital filter 84A1) on the processing target image 75A1. As a result, the second aberration corrected image 88A1 is generated.

By the way, in a case where the first aberration corrected image 86A1 is used as it is as the image finally provided to the user, the influence of the processing that uses the generation model 82A1 is noticeable, and there is a possibility that the image does not suit the user's preference. Therefore, in the imaging apparatus 10, the first aberration corrected image 86A1 and the second aberration corrected image 88A1 are adjusted at the ratio of 90A. That is, the adjustment that uses the first ratio 90A1 is performed with respect to the first aberration corrected image 86A1, and the adjustment that uses the second ratio 90A2 is performed with respect to the second aberration corrected image 88A1. Thereafter, the first aberration corrected image 86A1, in which the adjustment that uses the first ratio 90A1 is performed, and the second aberration corrected image 88A1, in which the adjustment that uses the second ratio 90A2 is performed, are combined. As a result, it is possible to obtain an image (that is, the composite image 92A) in which the influence (that is, the influence of adjusting the non-noise element by the processing that uses the generation model 82A1) of the processing, which uses the generation model 82A1, is less noticeable than the first aberration corrected image 86A1.

In the present embodiment, the second aberration corrected image 88A1 is an image obtained by performing the processing, which uses the digital filter 84A1, on the processing target image 75A1, and the composite image 92A is generated by combining the first aberration corrected image 86A1 and the second aberration corrected image 88A1. As a result, the composite image 92A can include the influence of the processing that uses the digital filter 84A1.

In the present embodiment, the second aberration corrected image 88A1 is an image in which the non-noise element of the processing target image 75A1 is adjusted by the non-AI method processing, and the composite image 92A is generated by combining the first aberration corrected image 86A1 and the second aberration corrected image 88A1. As a result, the composite image 92A1 can include the result obtained by adjusting the non-noise element of the processing target image 75A1 by the non-AI method processing.

In the present embodiment, the ratio 90A is defined to adjust the excess and deficiency of the processing that uses the generation model 82A1. The first aberration corrected image 86A1 and the second aberration corrected image 88A1 are combined at the ratio 90A. As a result, it is possible to suppress that the image (that is, the composite image 92A) does not suit the user's preference due to the influence by the processing that uses the generation model 82A1 appears excessively in the image. Further, since the ratio 90A is changed according to the instruction from the user, a degree to which the influence of the processing that uses the generation model 82A1 remains in the composite image 92A and a degree to which the influence of the aberration remains in the composite image 92A can be adjusted to the user's preference.

In the present embodiment, the first aberration corrected image 86A1 is an image obtained by correcting a phenomenon (here, as an example, the influence of the aberration) that appears in the processing target image 75A1 due to the characteristic (here, as an example, the optical characteristic of an imaging lens 40) of the imaging apparatus 10 by using the AI method. Further, the first aberration corrected image 86A1 is an image obtained by correcting the phenomenon that appears in the processing target image 75A1 due to the characteristic of the imaging apparatus 10 by using the non-AI method. The composite image 92A is generated by combining the first aberration corrected image 86A1 and the second aberration corrected image 88A1. Therefore, it is possible to suppress the excess and deficiency of the correction amount obtained by correcting the phenomenon (here, as an example, the influence of the aberration) that appears in the processing target image 75A1 due to the characteristic of the imaging apparatus 10 with respect to the composite image 92A by using the AI method. Further, since the influence of the aberration is not completely eliminated, the unnatural appearance (that is, the unnaturalness caused by the influence of the aberration being reduced by using the generation model 82A1) of the composite image 92A can be alleviated. Further, the influence of the processing, which uses the generation model 82A1, is not excessively reflected in the composite image 92A, and the influence of the aberration can be appropriately left in the composite image 92A.

In the above embodiment, although an example of the embodiment in which the first aberration corrected image 86A1 and the second aberration corrected image 88A1 are combined has been described, the present disclosed technology is not limited to this. For example, the element derived from the AI method processing may be adjusted by combining the processing target image 75A1 (that is, an image in which the non-noise element is not adjusted) with the first aberration corrected image 86A1 instead of the second aberration corrected image 88A1. That is, an image region (for example, here, as an example, a pixel value of a pixel of which the influence of the aberration is reduced by using the generation model 82A1), where the influence of the aberration is reduced by using the AI method, may be adjusted by combining the first aberration corrected image 86A1 and the processing target image 75A1. In this case, the influence of the element derived from the AI method processing on the composite image 92A is alleviated by the element derived from the processing target image 75A1 (for example, the image region 75A1a). Therefore, it is possible to suppress the excess and deficiency of the correction amount obtained by correcting the phenomenon (here, as an example, the influence of the aberration) that appears in the processing target image 75A1 due to the characteristic of the imaging apparatus 10 with respect to the composite image 92A by using the AI method. The processing target image 75A1 that is combined with the first aberration corrected image 86A1 is an example of a “second image” according to the present disclosed technology.

In the above-described embodiment, although the influence of the aberration (the image region 75A1a in the example shown in FIG. 4) has been exemplified as an example of the phenomenon that appears in the processing target image 75A1 due to the characteristic of the imaging apparatus 10, the present disclosed technology is not limited to this. For example, the phenomenon that appears in the processing target image 75A1 due to the characteristic of the imaging apparatus 10 may be flare and/or ghost or the like caused by the imaging lens 40, and also in this case, flare and/or ghost may be reduced by using the AI method processing and the non-AI method processing. Further, the brightness, which is defined according to the opening diameter of the imaging lens 40, may be adjusted by using the AI method processing and the non-AI method processing.

In the above-described embodiment, although the second aberration corrected image 88A1 is exemplified as an image obtained by performing the non-AI method processing on the processing target image 75A1, the present disclosed technology is not limited to this. For example, an image that is obtained without performing the processing, which uses the generation model 82A1, on an image (for example, an image other than the processing target image 75A1 among a plurality of images including the processing target image 75A1 obtained by continuous shooting) different from the processing target image 75A1 may be applied instead of the second aberration corrected image 88A1. It should be noted that the same applies to the following first modification example and subsequent examples.

### First Modification Example

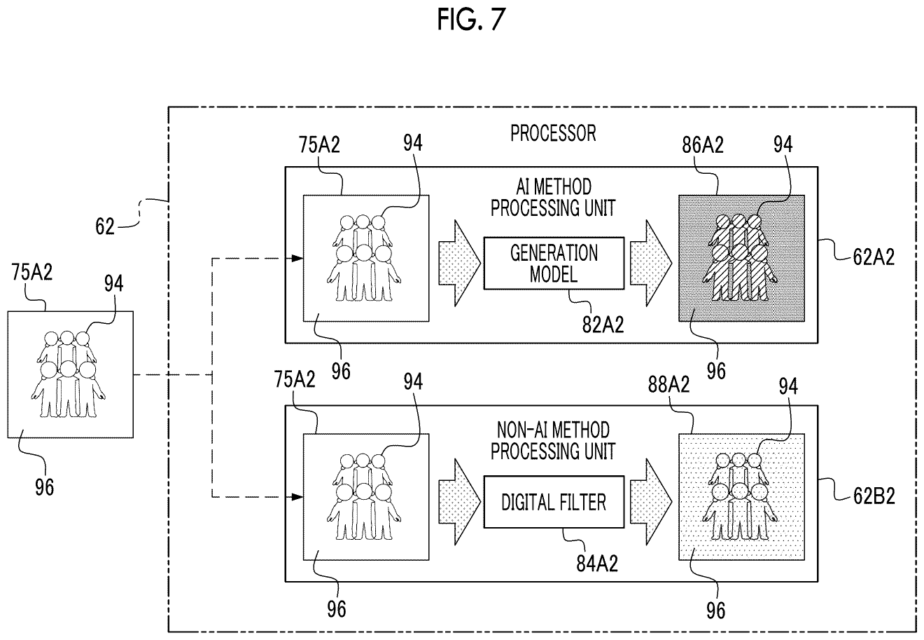

As an example shown in FIG. 7, the processor 62 according to the present first modification example differs from the processor 62 shown in FIG. 4 in that an AI method processing unit 62A2 is provided instead of the AI method processing unit 62A1, and in that a non-AI method processing unit 62B2 is provided instead of the non-AI method processing unit 62B1. In the present first modification example, the description of the same matters as those described before the first modification example will be omitted, and the matters different from the matters described before the first modification example will be described.

The processing target image 75A2 is input to the AI method processing unit 62A2 and the non-AI method processing unit 62B2. The processing target image 75A2 is an example of the processing target image 75A shown in FIG. 2. The processing target image 75A2 is a chromatic image and has a person region 94 and a background region 96. The person region 94 is an image region where a person is captured. The background region 96 is an image region where a background is captured.

Here, the person and the background captured in the processing target image 75A2 are examples of a “first subject” according to the present disclosed technology. The person region 94 is an example of a “first region” and a “region where a specific subject is captured” according to the present disclosed technology. The background region 96 is an example of a “second region that is a region different from the first region” according to the present disclosed technology. Color of the person region 94 and color of the background region 96 are examples of a “non-noise element of the processing target image”, a “factor that controls a visual impression given from the processing target image”, and “color” according to the present disclosed technology.

The AI method processing unit 62A2 performs AI method processing on the processing target image 75A2. An example of the AI method processing on the processing target image includes processing that uses the generation model 82A2. The generation model 82A2 is an example of the generation model 82A shown in FIG. 3. The generation model 82A2 is a generation network that has already been trained to change the color of the person region 94 and the color of the background region 96 such that the person region 94 and the background region 96 can be distinguished from each other.

The AI method processing unit 62A2 changes the factor that controls a visual impression given from the processing target image 75A2 by using the AI method. That is, the AI method processing unit 62A2 changes the factor that controls the visual impression given from the processing target image 75A2 as the non-noise element of the processing target image by performing the processing, which uses the generation model 82A2, on the processing target image 75A2. The factors that control the visual impression given from the processing target image 75A2 is the color of the person region 94 and the color of the background region 96. In the example shown in FIG. 7, the AI method processing unit 62A2 generates a first colored image 86A2 by performing processing, which uses the generation model 82A2, on the processing target image 75A2. The first colored image 86A2 is an image in which the person region 94 and the background region 96 are colored in a distinguishable manner. For example, the person region 94 has chromatic color and the background region 96 has achromatic color.

Here, the processing, which uses the generation model 82A2, is an example of “first AI processing”, “first change processing”, and “color processing” according to the present disclosed technology. The first colored image 86A2 is an example of a “first changed image” and a “first colored image” according to the present disclosed technology. “Generating the first colored image 86A2” is an example of “acquiring the first image” according to the present disclosed technology.

The processing target image 75A2 is input to the generation model 82A2. The generation model 82A2 generates and outputs the first colored image 86A2 based on the input processing target image 75A2.

The non-AI method processing unit 62B2 performs non-AI method processing on the processing target image 75A2. The non-AI method processing refers to processing that does not use a neural network. In the present first modification example, examples of the processing that does not use the neural network include processing that does not use the generation model 82A2.

An example of the non-AI method processing on the processing target image 75A2 includes processing that uses the digital filter 84A2. The digital filter 84A2 is a digital filter configured to change the chromatic color in the processing target image 75A2 to the achromatic color. The non-AI method processing unit 62B2 generates a second colored image 88A2 by performing the processing (that is, filtering), which uses the digital filter 84A2, on the processing target image 75A2. In other words, the non-AI method processing unit 62B2 generates the second colored image 88A2 by adjusting the non-noise element (here, as an example, the color) in the processing target image 75A2 by using the non-AI method. Further, in other words, the non-AI method processing unit 62B2 generates the second colored image 88A2 by changing the chromatic color in the processing target image 75A2 to the achromatic color by using the non-AI method.

Here, the processing, which uses the digital filter 84A2, is an example of “non-AI method processing that does not use a neural network” and “second change processing of changing the factor by using the non-AI method” according to the present disclosed technology. “Generating the second colored image 88A2” is an example of “acquiring the second image” according to the present disclosed technology.

The processing target image 75A2 is input to the digital filter 84A2. The digital filter 84A2 generates the second colored image 88A2 based on the input processing target image 75A2. The second colored image 88A2 is an image obtained by changing the non-noise element by using the digital filter 84A2 (that is, an image obtained by changing the non-noise element by the processing, which uses the digital filter 84A2, with respect to the processing target image 75A2). In other words, the second colored image 88A2 is an image in which the color in the processing target image 75A2 is changed by using the digital filter 84A2 (that is, an image in which the chromatic color is changed to the achromatic color by the processing, which uses the digital filter 84A2, with respect to the processing target image 75A2). The second colored image 88A2 is an example of a “second image”, a “second changed image”, and a “second colored image” according to the present disclosed technology.

By the way, the first colored image 86A2, which is obtained by performing the AI method processing on the processing target image 75A2, may include color different from the user's preference due to the characteristic of the generation model 82A2 (for example, the number of interlayers and/or the amount of training, or the like). In a case where the influence of the AI method processing is excessively reflected on the processing target image 75A2, it is conceivable that the color that is different from the user's preference is noticeable.

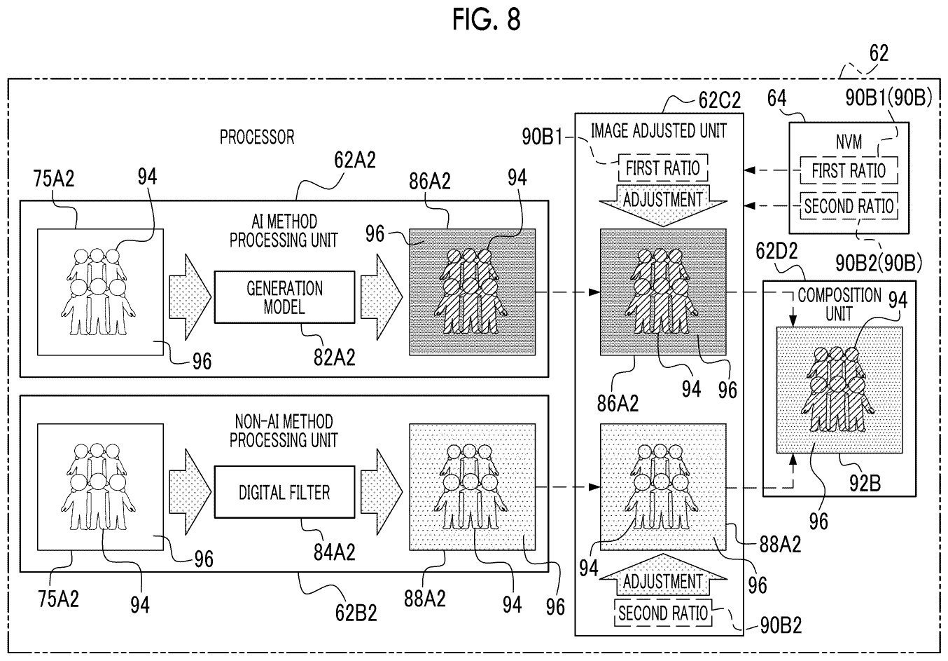

Therefore, in view of such circumstances, in the imaging apparatus 10, as an example shown in FIG. 8, by performing the processing of the image adjustment unit 62C2 and the processing of the composition unit 62D2 on the first colored image 86A2 and the second colored image 88A2, the first colored image 86A2 and the second colored image 88A2 are combined.

As an example shown in FIG. 8, a ratio 90B is stored in the NVM 64. The ratio 90B is a ratio for combining the first colored image 86A2 and the second colored image 88A2 and is defined to adjust excess and deficiency of the AI method processing (that is, the processing that uses the generation model 82A2) performed by the AI method processing unit 62A2.

The ratio 90B is roughly classified into a first ratio 90B1 and a second ratio 90B2. The first ratio 90B1 is a value of 0 or more and 1 or less, and the second ratio 90B2 is a value obtained by subtracting the value of the first ratio 90B1 from “1”. That is, the first ratio 90B1 and the second ratio 90B2 are defined such that the sum of the first ratio 90B1 and the second ratio 90B2 is “1”. The first ratio 90B1 and the second ratio 90B2 are variable values that are changed by an instruction from the user.

The image adjustment unit 62C2 adjusts the first colored image 86A2 generated by the AI method processing unit 62A2 by using the first ratio 90B1. For example, the image adjustment unit 62C2 adjusts a pixel value of each pixel of the first colored image 86A2 by multiplying a pixel value of each pixel of the first colored image 86A2 by the first ratio 90B1.

The image adjustment unit 62C2 adjusts the second colored image 88A2 generated by using the non-AI method processing unit 62B2 by using the second ratio 90B2. For example, the image adjustment unit 62C2 adjusts a pixel value of each pixel of the second colored image 88A2 by multiplying a pixel value of each pixel of the second colored image 88A2 by the second ratio 90B2.

The composition unit 62D2 generates a composite image 92B by combining the first colored image 86A2 adjusted at the first ratio 90B1 by the image adjustment unit 62C2 and the second colored image 88A2 adjusted at the second ratio 90B2 by the image adjustment unit 62C2. That is, the composition unit 62D2 adjusts the excess and deficiency of the AI method processing performed by the AI method processing unit 62A2 by combining the first colored image 86A2 adjusted at the first ratio 90B1 and the second colored image 88A2 adjusted at the second ratio 90B2. In other words, the composition unit 62D2 adjusts the non-noise element (here, as an example, the color) by combining the first colored image 86A2 adjusted at the first ratio 90B1 and the second colored image 88A2 adjusted at the second ratio 90B2. Further, in other words, the composition unit 62D2 adjusts an element derived from the processing that uses the generation model 82A2 (for example, the pixel value of the pixel of which the color is changed by using the generation model 82A2) by combining the first colored image 86A2 adjusted at the first ratio 90B1 and the second colored image 88A2 adjusted at the second ratio 90B2.

The composition, which is performed by the composition unit 62D2, is an addition of a pixel value of a corresponding pixel position between the first colored image 86A2 and the second colored image 88A2. The composition, which is performed by the composition unit 62D2, is performed in the same manner as the composition, which is performed by the composition unit 62D1 shown in FIG. 5. Further, various types of image processing are also performed on the composite image 92B by the composition unit 62D2 in the same manner as on the composite image 92A shown in FIG. 5. The composite image 92B, in which various types of image processing are performed, is output to a default output destination by the composition unit 62D2.

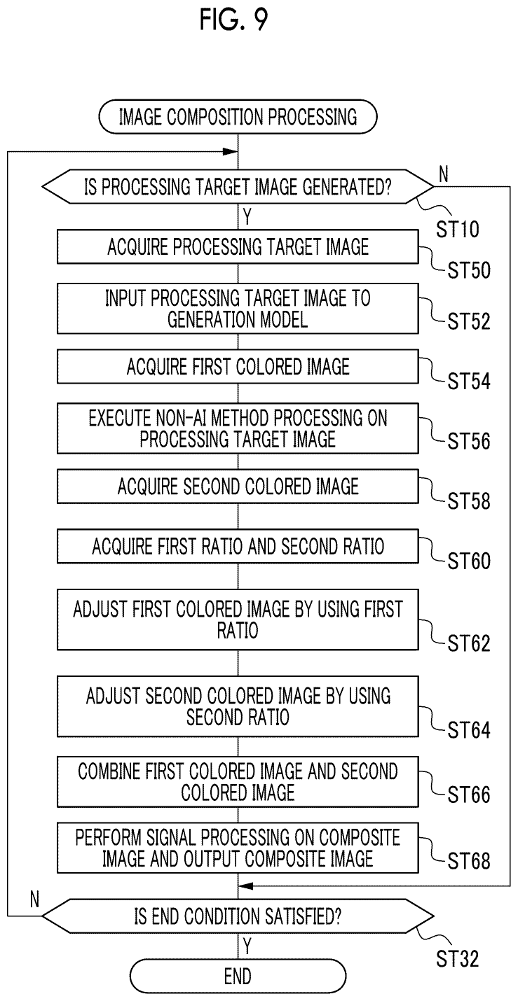

FIG. 9 shows an example of a flow of the image composition processing according to the present first modification example. The flowchart shown in FIG. 9 is different from the flowchart shown in FIG. 6 in that it includes step ST50 to step ST68 instead of step ST12 to step ST30.

In the image composition processing shown in FIG. 9, in step ST50, the AI method processing unit 62A2 and the non-AI method processing unit 62B2 acquire the processing target image 75A2 from the image sensor 20. After the processing in step ST50 is executed, the image composition processing shifts to step ST52.

In step ST52, the AI method processing unit 62A2 inputs the processing target image acquired in step ST50 to the generation model 82A2. After the processing in step ST52 is executed, the image composition processing shifts to step ST54.

In step ST54, the AI method processing unit 62A2 acquires the first colored image 86A2 output from the generation model 82A2 by inputting the processing target image 75A2 to the generation model 82A2 in step ST52. After the processing in step ST54 is executed, the image composition processing shifts to step ST56.

In step ST56, the non-AI method processing unit 62B2 adjusts the color in the processing target image 75A2 by performing the processing, which uses the digital filter 84A2, on the processing target image 75A2 acquired in step ST50. After the processing in step ST56 is executed, the image composition processing shifts to step ST58.

In step ST58, the non-AI method processing unit 62B2 acquires the second colored image 88A2 obtained by performing the processing, which uses the digital filter 84A2, on the processing target image 75A2 in step ST56. After the processing in step ST58 is executed, the image composition processing shifts to step ST60.

In step ST60, the image adjustment unit 62C2 acquires the first ratio 90B1 and the second ratio 90B2 from the NVM64. After the processing in step ST60 is executed, the image composition processing shifts to step ST62.

In step ST62, the image adjustment unit 62C2 adjusts the first colored image 86A2 by using the first ratio 90B1 acquired in step ST60. After the processing in step ST62 is executed, the image composition processing shifts to step ST64.

In step ST64, the image adjustment unit 62C2 adjusts the second colored image 88A2 by using the second ratio 90B2 acquired in step ST60. After the processing in step ST64 is executed, the image composition processing shifts to step ST66.

In step ST66, the composition unit 62D2 adjusts the excess and deficiency of the AI method processing performed by the AI method processing unit 62A2 by combining the first colored image 86A2 adjusted in step ST62 and the second colored image 88A2 adjusted in step ST64. The composite image 92B is generated by combining the first colored image 86A2 adjusted in step ST62 and the second colored image 88A2 adjusted in step ST64. After the processing in step ST66 is executed, the image composition processing shifts to step ST68.

In step ST68, the composition unit 62D2 performs various types of image processing on the composite image 92B. The composition unit 62D2 outputs an image obtained by performing various types of image processing on the composite image 92B to a default output destination as the processed image 75B. After the processing in step ST68 is executed, the image composition processing shifts to step ST32.

As described above, in the imaging apparatus 10 according to the present first modification example, the first colored image 86A2 is generated by changing the factor (here, as an example, the color) that controls the visual impression given from the processing target image 75A2 by using the AI method processing. Further, the second colored image 88A2 is generated by changing the factor that controls the visual impression given from the processing target image 75A2 by using the non-AI method processing. Further, the first colored image 86A2 is adjusted according to the first ratio 90B1, and the second colored image 88A2 is adjusted according to the second ratio 90B2. The composite image 92B is generated by combining the first colored image 86A2 adjusted according to the first ratio 90B1 and the second colored image 88A2 adjusted according to the second ratio 90B2. As a result, the element (for example, the color in the first colored image 86A2) derived from the AI method processing is adjusted. That is, the influence of the element derived from the AI method processing on the composite image 92B is alleviated by the element derived from the non-AI method processing (for example, the color in the second colored image 88A2). Therefore, it is possible to suppress the excess and deficiency of a change amount in which the factor that controls the visual impression given from the processing target image 75A2 is changed with respect to the composite image 92B by using the AI method. As a result, the composite image 92B becomes an image in which the influence of the AI method processing is less noticeable than that of the first colored image 86A2, and it is possible to provide a suitable image to a user who does not prefer the influence of the AI method processing to be excessively noticeable.

In the present first modification example, the first colored image 86A2 is generated by coloring the person region 94 and the background region 96 in the processing target image 75A2 in a distinguishable manner by using the AI method. Thereafter, the first colored image 86A2 and the second colored image 88A2 are combined. As a result, it is possible to suppress the excess and deficiency of the coloring in a case of performing the AI method processing with respect to the composite image 92B. As a result, the composite image 92B becomes an image in which the coloring in a case of performing the AI method processing is less noticeable than that of the first colored image 86A2, and it is possible to provide a suitable image to a user who does not prefer the coloring in a case of performing the AI method processing to be excessively noticeable.

In the present first modification example, since the first colored image 86A2 and the second colored image 88A2 are combined after the person region 94 and the background region 96 in the processing target image 75A2 are colored in a distinguishable manner by using the AI method, it is possible to suppress the excess and deficiency of coloring in a case of performing the AI method processing with respect to the person region 94. As a result, the composite image 92B becomes an image in which the coloring in a case of performing the AI method processing on the person region 94 is less noticeable than that of the first colored image 86A2, and it is possible to provide a suitable image to a user who does not prefer the coloring in a case of performing the AI method processing on the person region 94 to be excessively noticeable.

In the example shown in FIG. 7 to FIG. 9, although an example of the embodiment in which the non-AI method processing unit 62B2 changes the color in the processing target image 75A2 from the chromatic color to the achromatic color regardless of the subject captured in the processing target image 75A2 has been described, the present disclosed technology is not limited to this. For example, the non-AI method processing unit 62B2 may color the person region 94 and the background region 96 in a distinguishable manner by using the non-AI method.

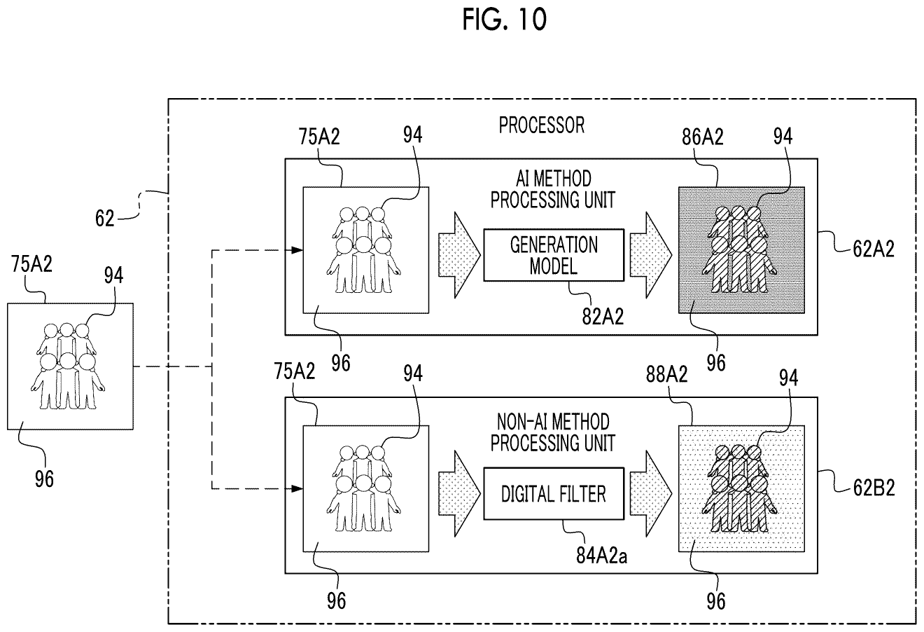

In this case, for example, as shown in FIG. 10, the non-AI method processing unit 62B2 performs the processing, which uses the digital filter 84A2a, on the processing target image 75A2. The digital filter 84A2a is a digital filter configured to color the person region 94 and the background region 96 in the processing target image 75A2 in a distinguishable manner. The digital filter 84A2a may be a digital filter configured such that one of the person region 94 and the background region 96 is colored in the chromatic color and the other is colored in the achromatic color. Further, the digital filter 84A2a is a digital filter configured such that both the person region 94 and the background region 96 are colored in the chromatic color or the achromatic color, and configured to change the gradation between the person region 94 and the background region 96.

The non-AI method processing unit 62B2 generates an image, in which the person region 94 and the background region 96 are colored in a distinguishable manner, as the second colored image 88A2 by performing the processing, which uses the digital filter 84A2a, on the processing target image 75A2. By combining the second colored image 88A2 and the first colored image 86A2 generated in this manner, the user can easily visually recognize the difference between the person region 94 and the background region 86 in the composite image 92B.

In the present first modification example, although the person region 94 is exemplified as an example of the “first region” and the “region in which the specific subject is captured” according to the present disclosed technology, this is only an example, and the present disclosed technology is also applicable to regions (for example, a region where a specific vehicle is captured, a region where a specific animal is captured, a region where a specific plant is captured, a region where a specific building is captured, and/or a region where a specific aircraft is captured, or the like) other than the person region 94.

In the first modification example, although an example of the embodiment in which the first colored image 86A2 and the second colored image 88A2 are combined has been described, this is only an example. For example, the element (for example, the color in the first colored image 86A2) derived from the AI method processing may be adjusted by combining the processing target image 75A2 (that is, an image in which the non-noise element is not adjusted) with the first colored image 86A2 instead of the second colored image 88A2. In this case, the influence of the element derived from the AI method processing on the composite image 92B is alleviated by the element derived from the processing target image 75A2 (for example, the color in the processing target image 75A2). Therefore, it is possible to suppress the excess and deficiency of a change amount in which the factor that controls the visual impression given from the processing target image 75A2 is changed with respect to the composite image 92B by using the AI method. The processing target image 75A2 that is combined with the first colored image 86A2 is an example of a “second image” according to the present disclosed technology.

### Second Modification Example

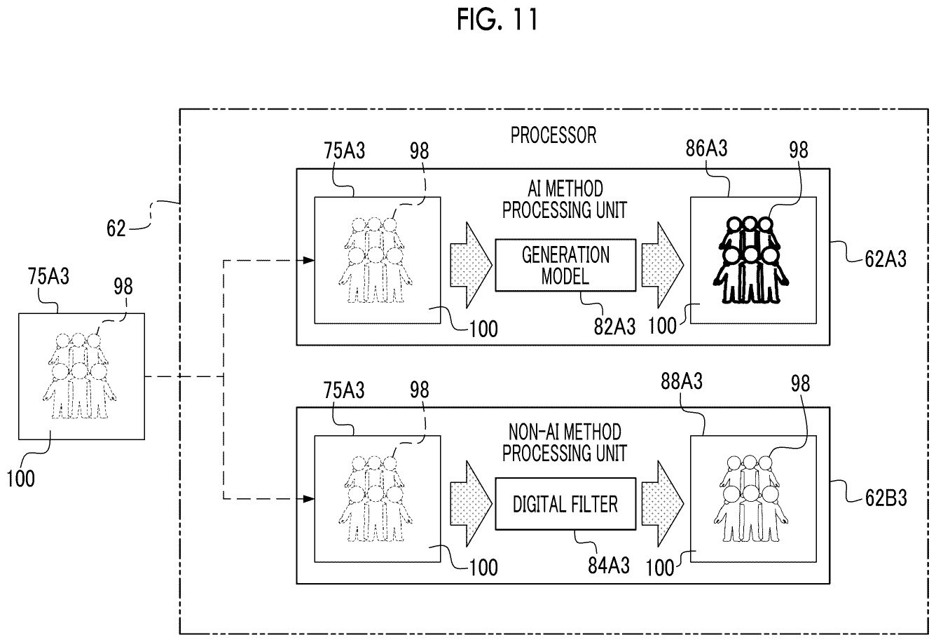

As an example shown in FIG. 11, the processor 62 according to the present second modification example differs from the processor 62 shown in FIG. 4 in that an AI method processing unit 62A3 is provided instead of the AI method processing unit 62A1, and in that a non-AI method processing unit 62B3 is provided instead of the non-AI method processing unit 62B1. In the present second modification example, the description of the same matters as those described before the second modification example will be omitted, and the matters different from the matters described before the second modification example will be described.

The processing target image 75A3 is input to the AI method processing unit 62A3 and the non-AI method processing unit 62B3. The processing target image 75A3 is an example of the processing target image 75A shown in FIG. 2. The processing target image 75A3 is a chromatic image and has a person region 98 and a background region 100. The person region 98 is an image region where a person is captured. The background region 100 is an image region where a background is captured. Although a chromatic image is exemplified here as the processing target image 75A3, the processing target image 75A3 may be an achromatic image.

The AI method processing unit 62A3 and the non-AI method processing unit 62B3 perform the processing of adjusting a contrast of the input processing target image 75A3. In the present second modification example, the processing of adjusting the contrast refers to processing of increasing or decreasing the contrast. The contrast of the processing target image is an example of a “non-noise element of the processing target image”, a “factor that controls a visual impression given from the processing target image”, and a “contrast of the processing target image” according to the present disclosed technology.

The AI method processing unit 62A3 performs AI method processing on the processing target image 75A3. An example of the AI method processing on the processing target image includes processing that uses the generation model 82A3. The generation model 82A3 is an example of the generation model 82A shown in FIG. 3. The generation model 82A3 is a generation network that has already been trained to adjust the contrast of the processing target image 75A3.

The AI method processing unit 62A3 changes the factor that controls the visual impression given from the processing target image 75A3 by using the AI method. That is, the AI method processing unit 62A3 changes the factor that controls the visual impression given from the processing target image 75A3 as the non-noise element of the processing target image by performing the processing, which uses the generation model 82A3, on the processing target image 75A3. The factor that controls the visual impression given from the processing target image 75A3 is the contrast of the processing target image 75A3. In the example shown in FIG. 11, the AI method processing unit 62A3 generates a first contrast adjusted image 86A3 by performing the processing, which uses the generation model 82A3, on the processing target image 75A3. The first contrast adjusted image 86A3 is an image in which the contrast of the processing target image 75A3 is adjusted by using the AI method.

Here, the processing, which uses the generation model 82A3, is an example of “first AI processing”, “first change processing”, and “first contrast adjustment processing” according to the present disclosed technology. The first contrast adjusted image 86A3 is an example of a “first changed image” and a “first contrast adjusted image” according to the present disclosed technology. “Generating the first contrast adjusted image 86A3” is an example of “acquiring the first image” according to the present disclosed technology.

The processing target image 75A3 is input to the generation model 82A3. The generation model 82A3 generates and outputs the first contrast adjusted image 86A3 based on the input processing target image 75A3. In the example shown in FIG. 11, as an example of the first contrast adjusted image 86A3, an image having a higher contrast than the processing target image 75A3 is shown.

The non-AI method processing unit 62B3 performs non-AI method processing on the processing target image 75A3. The non-AI method processing refers to processing that does not use a neural network. In the present second modification example, examples of the processing that does not use the neural network include processing that does not use the generation model 82A3.

An example of the non-AI method processing on the processing target image 75A3 includes processing that uses the digital filter 84A3. The digital filter 84A3 is a digital filter configured to adjust the contrast of the processing target image 75A3. The non-AI method processing unit 62B3 generates a second contrast adjusted image 88A3 by performing the processing (that is, filtering), which uses the digital filter 84A3, on the processing target image 75A3. In other words, the non-AI method processing unit 62B3 generates the second contrast adjusted image 88A3 by adjusting the non-noise element (here, as an example, the contrast) in the processing target image 75A3 by using the non-AI method. Further, in other words, the non-AI method processing unit 62B3 generates the second contrast adjusted image 88A3 by changing the contrast of the processing target image 75A3 by using the non-AI method.

Here, the processing, which uses the digital filter 84A3, is an example of “non-AI method processing that does not use a neural network” and “second change processing of changing the factor by using the non-AI method” according to the present disclosed technology. “Generating the second contrast adjusted image 88A3” is an example of “acquiring the second image” according to the present disclosed technology.

The processing target image 75A3 is input to the digital filter 84A3. The digital filter 84A3 generates the second contrast adjusted image 88A3 based on the input processing target image 75A3. The second contrast adjusted image 88A3 is an image obtained by changing the non-noise element by using the digital filter 84A3 (that is, an image obtained by changing the non-noise element by the processing, which uses the digital filter 84A3, with respect to the processing target image 75A3). In other words, the second contrast adjusted image 88A3 is an image in which the contrast in the processing target image 75A3 is changed by using the digital filter 84A3 (that is, an image in which the contrast is changed by the processing, which uses the digital filter 84A3, with respect to the processing target image 75A3). In the example shown in FIG. 11, as an example of the second contrast adjusted image 88A3, an image having a higher contrast than the processing target image 75A3 and a lower contrast than the first contrast adjusted image 86A3 is shown. The second contrast adjusted image 88A3 is an example of a “second image”, a “second changed image”, and a “second contrast adjusted image” according to the present disclosed technology.

By the way, the first contrast adjusted image 86A3, which is obtained by performing the AI method processing on the processing target image 75A3, may include a contrast different from the user's preference due to the characteristic of the generation model 82A3 (for example, the number of interlayers and/or the amount of training, or the like). In a case where the influence of the AI method processing is excessively reflected on the processing target image 75A3, it is conceivable that the contrast that is different from the user's preference is noticeable.

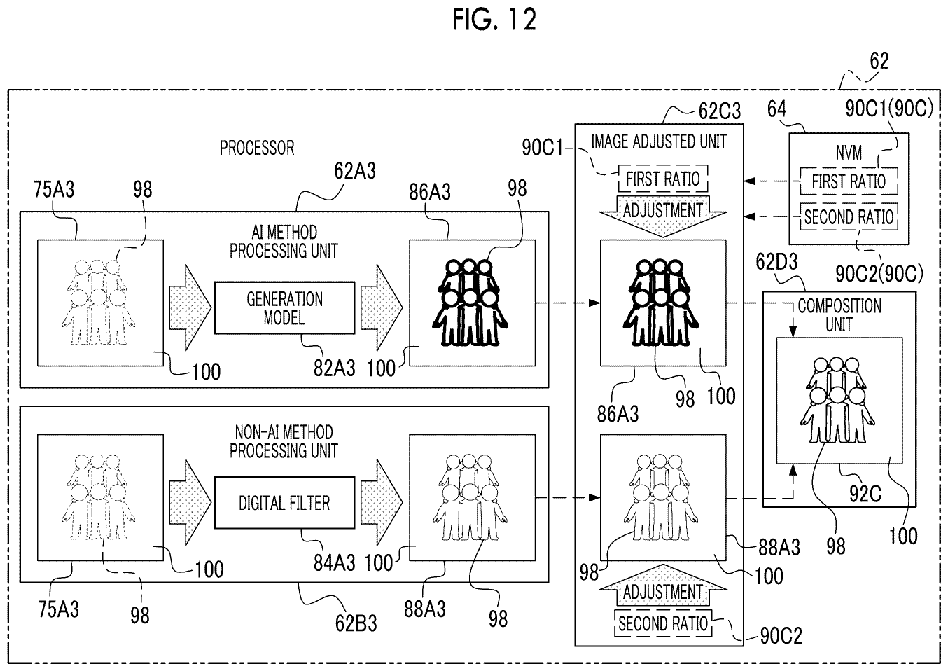

Therefore, in view of such circumstances, in the imaging apparatus 10, as an example shown in FIG. 12, by performing the processing of the image adjustment unit 62C3 and the processing of the composition unit 62D3 on the first contrast adjusted image 86A3 and the second contrast adjusted image 88A3, the first contrast adjusted image 86A3 and the second contrast adjusted image 88A3 are combined.

As an example shown in FIG. 12, a ratio 90C is stored in the NVM 64. The ratio 90C is a ratio for combining the first contrast adjusted image 86A3 and the second contrast adjusted image 88A3 and is defined to adjust the excess and deficiency of the AI method processing (that is, the processing that uses the generation model 82A3) performed by the AI method processing unit 62A3.

The ratio 90C is roughly classified into a first ratio 90C1 and a second ratio 90C2. The first ratio 90C1 is a value of 0 or more and 1 or less, and the second ratio 90C2 is a value obtained by subtracting the value of the first ratio 90C1 from “1”. That is, the first ratio 90C1 and the second ratio 90C2 are defined such that the sum of the first ratio 90C1 and the second ratio 90C2 is “1”. The first ratio 90C1 and the second ratio 90C2 are variable values that are changed by an instruction from the user.

The image adjustment unit 62C3 adjusts the first contrast adjusted image 86A3, which is generated by the AI method processing unit 62A3, by using the first ratio 90C1. For example, the image adjustment unit 62C3 adjusts a pixel value of each pixel of the first contrast adjusted image 86A3 by multiplying a pixel value of each pixel of the first contrast adjusted image 86A3 by the first ratio 90C1.

The image adjustment unit 62C3 adjusts the second contrast adjusted image 88A3, which is generated by the non-AI method processing unit 62B3, by using the second ratio 90C2. For example, the image adjustment unit 62C3 adjusts a pixel value of each pixel of the second contrast adjusted image 88A3 by multiplying a pixel value of each pixel of the second contrast adjusted image 88A3 by the second ratio 90C2.

The composition unit 62D3 generates a composite image 92C by combining the first contrast adjusted image 86A3 adjusted at the first ratio 90C1 by the image adjustment unit 62C3 and the second contrast adjusted image 88A3 adjusted at the second ratio 90C2 by the image adjustment unit 62C3. That is, the composition unit 62D3 adjusts the excess and deficiency of the AI method processing performed by the AI method processing unit 62A3 by combining the first contrast adjusted image 86A3 adjusted at the first ratio 90C1 and the second contrast adjusted image 88A3 adjusted at the second ratio 90C2. In other words, the composition unit 62D3 adjusts the non-noise element (here, as an example, the contrast) by combining the first contrast adjusted image 86A3 adjusted at the first ratio 90C1 and the second contrast adjusted image 88A3 adjusted at the second ratio 90C2. Further, in other words, the composition unit 62D3 adjusts an element derived from the processing that uses the generation model 82A3 (for example, the pixel value of the pixel of which the contrast is changed by using the generation model 82A3) by combining the first contrast adjusted image 86A3 adjusted at the first ratio 90C1 and the second contrast adjusted image 88A3 adjusted at the second ratio 90C2.

The composition, which is performed by the composition unit 62D3, is an addition of a pixel value of a corresponding pixel position between the first contrast adjusted image 86A3 and the second contrast adjusted image 88A3. The composition, which is performed by the composition unit 62D3, is performed in the same manner as the composition, which is performed by the composition unit 62D1 shown in FIG. 5. Further, various types of image processing are also performed on the composite image 92C by the composition unit 62D3 in the same manner as on the composite image 92A shown in FIG. 5. The composite image 92C, in which various types of image processing are performed, is output to a default output destination by the composition unit 62D3.

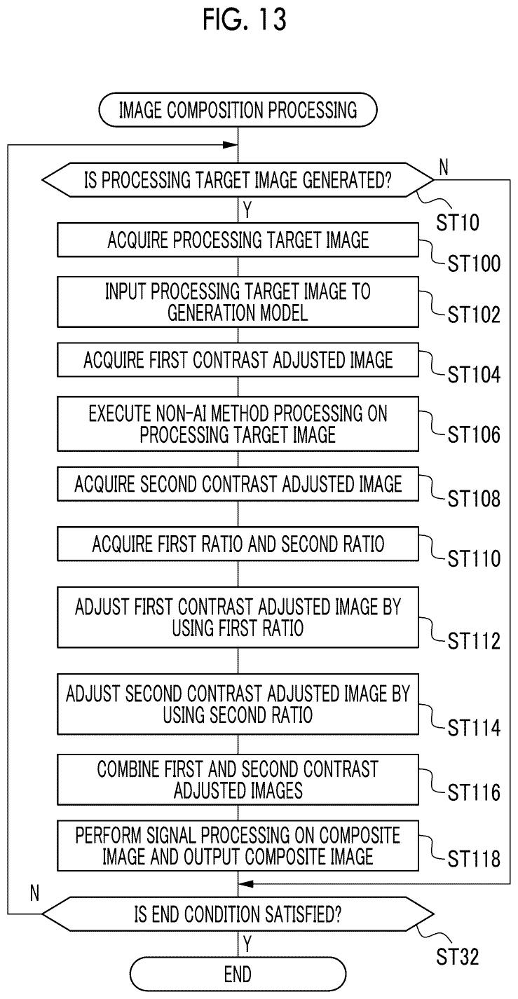

FIG. 13 shows an example of a flow of the image composition processing according to the present second modification example. The flowchart shown in FIG. 13 is different from the flowchart shown in FIG. 6 in that it includes step ST100 to step ST118 instead of step ST12 to step ST30.

In the image composition processing shown in FIG. 13, in step ST100, the AI method processing unit 62A3 and the non-AI method processing unit 62B3 acquire the processing target image 75A3 from the image sensor 20. After the processing in step ST100 is executed, the image composition processing shifts to step ST102.

In step ST102, the AI method processing unit 62A3 inputs the processing target image 75A3 acquired in step ST100 to the generation model 82A3. After the processing in step ST102 is executed, the image composition processing shifts to step ST104.

In step ST104, the AI method processing unit 62A3 acquires the first contrast adjusted image 86A3 output from the generation model 82A3 by inputting the processing target image 75A3 to the generation model 82A3 in step ST102. After the processing of step ST104 is executed, the image composition processing shifts to step ST106.

In step ST106, the non-AI method processing unit 62B3 adjusts the contrast in the processing target image 75A3 by performing the processing, which uses the digital filter 84A3, on the processing target image 75A3 acquired in step ST100. After the processing of step ST106 is executed, the image composition processing shifts to step ST108.

In step ST108, the non-AI method processing unit 62B3 acquires the second contrast adjusted image 88A3 obtained by performing the processing, which uses the digital filter 84A3, on the processing target image 75A3 in step ST106. After the processing of step ST108 is executed, the image composition processing shifts to step ST110.

In step ST110, the image adjustment unit 62C3 acquires the first ratio 90C1 and the second ratio 90C2 from the NVM64. After the processing of step ST110 is executed, the image composition processing shifts to step ST112.

In step ST112, the image adjustment unit 62C3 adjusts the first contrast adjusted image 86A3 by using the first ratio 90C1 acquired in step ST110. After the processing of step ST112 is executed, the image composition processing shifts to step ST114.

In step ST114, the image adjustment unit 62C3 adjusts the second contrast adjusted image 88A3 by using the second ratio 90C2 acquired in step ST110. After the processing of step ST114 is executed, the image composition processing shifts to step ST116.

In step ST116, the composition unit 62D3 adjusts the excess and deficiency of the AI method processing performed by the AI method processing unit 62A3 by combining the first contrast adjusted image 86A3 adjusted in step ST112 and the second contrast adjusted image 88A3 adjusted in step ST114. The composite image 92C is generated by combining the first contrast adjusted image 86A3 adjusted in step S112 and the second contrast adjusted image 88A3 adjusted in step ST114. After the processing of step ST116 is executed, the image composition processing shifts to step ST118.

In step ST118, the composition unit 62D3 performs various types of image processing on the composite image 92C. The composition unit 62D3 outputs an image obtained by performing various types of image processing on the composite image 92C to a default output destination as the processed image 75B. After the processing of step ST118 is executed, the image composition processing shifts to step ST32.

As described above, in the imaging apparatus 10 according to the present second modification example, the first contrast adjusted image 86A3 is generated by adjusting the contrast of the processing target image 75A3 by using the AI method. Further, the second contrast adjusted image 88A3 is generated by adjusting the contrast of the processing target image 75A3 by using the non-AI method. Thereafter, the first contrast adjusted image 86A3 and the second contrast adjusted image 88A3 are combined. As a result, it is possible to suppress the excess and deficiency of the contrast in a case of performing the AI method processing with respect to the composite image 92C. As a result, the composite image 92C becomes an image in which the contrast in a case of performing the AI method processing is less noticeable than that of the first contrast adjusted image 86A3, and it is possible to provide a suitable image to a user who does not prefer the contrast in a case of performing the AI method processing to be excessively noticeable.

In the examples shown in FIG. 11 to FIG. 13, although an example of the embodiment in which the processor 62 adjusts the contrast for the entire processing target image 75A3 has been described, the present disclosed technology is not limited to this, and the processor 62 may perform processing of adjusting the clarity of the processing target image 75A3. The clarity refers to a contrast between a center pixel in a pixel block consist of a plurality of pixels and pixels adjacent to the vicinity of the center pixel. The processing of adjusting the clarity includes processing of adjusting the clarity by using the AI method and processing of adjusting the clarity by using the non-AI method.

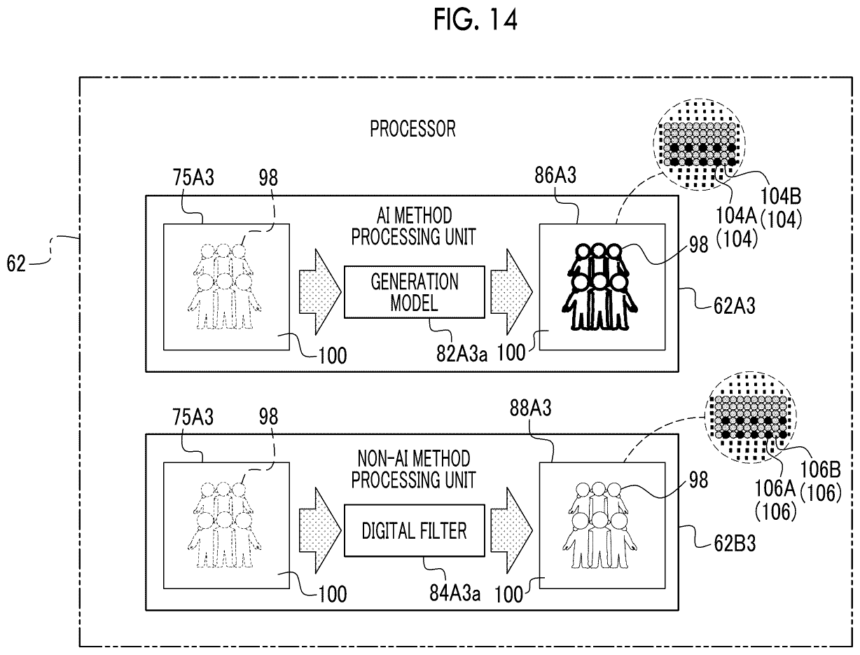

The processing of adjusting the clarity by using the AI method is, for example, processing of using the generation model 82A3a. In this case, the generation model 82A3a is a generation network that has already been trained to adjust the contrast and perform first clarity processing in the above described manner. The first clarity processing refers to processing of adjusting the clarity by using the AI method, that is, processing of locally adjusting the contrast by using the AI method. For example, as shown in FIG. 14, the local adjustment of the contrast by using the AI method is realized by increasing or decreasing a difference between a pixel value of a center pixel 104A among a plurality of pixels 104 forming an edge region of the person region 98, and pixel values of a plurality of adjacent pixels 104B adjacent to the vicinity of the center pixel 104A.

The processing of adjusting the clarity by using the non-AI method is, for example, processing of using the generation model 82A3a. In this case, the digital filter 84A3a is a digital filter configured to adjust the contrast and perform second clarity processing in the above described manner. The second clarity processing refers to processing of adjusting the clarity by using the non-AI method, that is, processing of locally adjusting the contrast by using the non-AI method. For example, as shown in FIG. 14, the local adjustment of the contrast by using the non-AI method is realized by increasing or decreasing a difference between a pixel value of a center pixel 106A among a plurality of pixels 106 forming an edge region of the person region 98, and pixel values of a plurality of adjacent pixels 106B adjacent to the vicinity of the center pixel 106A.

Here, in a case where the first clarity processing is performed, there is a possibility that an unnatural border may appear in the person region 98 by enhancing the clarity of the first contrast adjusted image 86A3 too much, or conversely a fine portion of the person region 98 may become unclear by weakening the clarity of the first contrast adjusted image 86A3 too much. Therefore, the first contrast adjusted image 86A3 in which the first clarity processing is performed and the second contrast adjusted image 88A3 in which the second clarity processing is performed are combined at the ratio 90C. As a result, the element derived from the first clarity processing (for example, the pixel value of the pixel of which the contrast is changed by using the generation model 82A3a) is adjusted. As a result, as the composite image 92C, it is possible to obtain an image in which the influence of the first clarity processing is alleviated.

Here, although an example of the embodiment in which the first contrast adjusted image 86A3 in which the first clarity processing is performed and the second contrast adjusted image 88A3 in which the second clarity processing is performed are combined has been described, the first contrast adjusted image 86A3 in which the first clarity processing is performed, and the second contrast adjusted image 88A3 in which the second clarity processing is not performed or the processing target image 75A3, may be combined. In this case, the same effect can be expected.

The first clarity processing is an example of “fifth contrast adjustment processing” according to the present disclosed technology. The second clarity processing is an example of “sixth contrast adjustment processing” according to the present disclosed technology. The first contrast adjusted image 86A3 obtained by performing the first clarity processing is an example of a “fifth contrast image” according to the present disclosed technology. The second contrast adjusted image 88A3 obtained by performing the second clarity processing is an example of a “sixth image” according to the present disclosed technology.

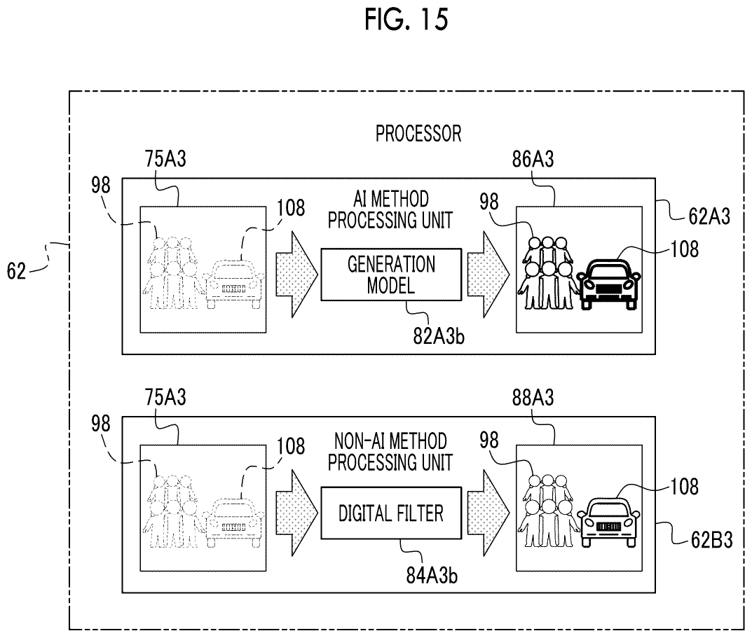

In the examples shown in FIG. 11 to FIG. 13, although a case where a person is captured in the processing target image 74A3 has been described, the present disclosed technology is not limited to this. For example, as shown in FIG. 15, a person and a vehicle (here, an automobile as an example) may be captured in the processing target image 74A3. In this case, the processing target image 74A3 has a person region 98 and a vehicle region 108. The vehicle region 108 is an image region where the vehicle is captured.

The AI method processing unit 62A adjusts the contrast of the processing target image according to the subject by using the AI method. In order to realize this, in the example shown in FIG. 15, processing using the generation model 82A3b is performed by using the AI method processing unit 62A. The generation model 82A3b is a generation network that has already been trained to adjust the contrast according to the subject. The AI method processing unit 62A adjusts the contrast according to the person region 98 and the vehicle region 108 in the processing target image 75A3 by using the generation model 82A3b. That is, the person region 98 is provided with the contrast corresponding to the person indicated by the person region 98, and the vehicle region 108 is provided with the contrast corresponding to the vehicle indicated by the vehicle region 108. In the example shown in FIG. 15, the contrast of the vehicle region 108 is higher than the contrast of the person region 98.

The non-AI method processing unit 62B adjusts the contrast of the processing target image 75A3 according to the subject by using the non-AI method. In order to realize this, in the example shown in FIG. 15, processing that uses the digital filter 84A3b is performed by the non-AI method processing unit 62B. The digital filter 84A3b is a digital filter configured to adjust the contrast according to the subject. The non-AI method processing unit 62B adjusts the contrast according to the person region 98 and the vehicle region 108 in the processing target image 75A3 by using the digital filter 84A3b. In the example shown in FIG. 15, the contrast of the vehicle region 108 is higher than the contrast of the person region 98. Further, the contrast of the vehicle region 108 in the second contrast adjusted image 88A3 is lower than the contrast of the vehicle region 108 in the first contrast adjusted image 86A3. Further, the contrast of the person region 98 in the second contrast adjusted image 88A3 is lower than the contrast of the person region 98 in the first contrast adjusted image 86A3.

Here, in a case where the first contrast adjusted image 86A3 excessively receives the influence of the processing that uses the generation model 82A3b, there is a possibility that the contrast of the person region 98 and the vehicle region 108 in the first contrast adjusted image 86A3 does not suit the user's preference. For example, the user may feel that the contrast of the person region 98 and the vehicle region 108 in the first contrast adjusted image 86A3 is too high. Therefore, the first contrast adjusted image 86A3 obtained by performing the processing, which uses the generation model 82A3b, on the processing target image 75A3 and the second contrast adjusted image 88A3 obtained by performing the processing, which uses the digital filter 84A3b, on the processing target image 75A3 are combined at ratio 90C. As a result, the element derived from the processing that uses the generation model 82A3b (for example, the pixel value of the pixel of which the contrast is changed by using the generation model 82A3b) is adjusted. As a result, as the composite image 92C, it is possible to obtain an image in which the influence of the processing that uses the generation model 82A3b is alleviated.

Here, although an example of the embodiment in which the first contrast adjusted image 86A3 obtained by performing the processing, which uses the generation model 82A3b, on the processing target image 75A3 and the second contrast adjusted image 88A3 obtained by performing the processing, which uses the digital filter 84A3b, on the processing target image 75A3 are combined has been described, the present disclosed technology is not limited to this. For example, the first contrast adjusted image 86A3 obtained by performing the processing, which uses the generation model 82A3b, on the processing target image 75A3, and the second contrast adjusted image 88A3 obtained by not performing the processing that uses the digital filter 84A3b or the processing target image 75A3, may be combined. In this case, the same effect can be expected.

The processing that uses the generation model 82A3b is an example of “third contrast adjustment processing” according to the present disclosed technology. The processing using the digital filter 84A3b is an example of “fourth contrast adjustment processing” according to the present disclosed technology. The first contrast adjusted image 86A3 obtained by performing the processing, which uses the generation model 82A3b, on the processing target image 75A3 is an example of a “third contrast adjusted image” according to the present disclosed technology. The second contrast adjusted image 88A3 obtained by performing the processing, which uses the digital filter 84A3b, on the processing target image 75A3 is an example of a “fourth contrast adjusted image” according to the present disclosed technology.

### Third Modification Example

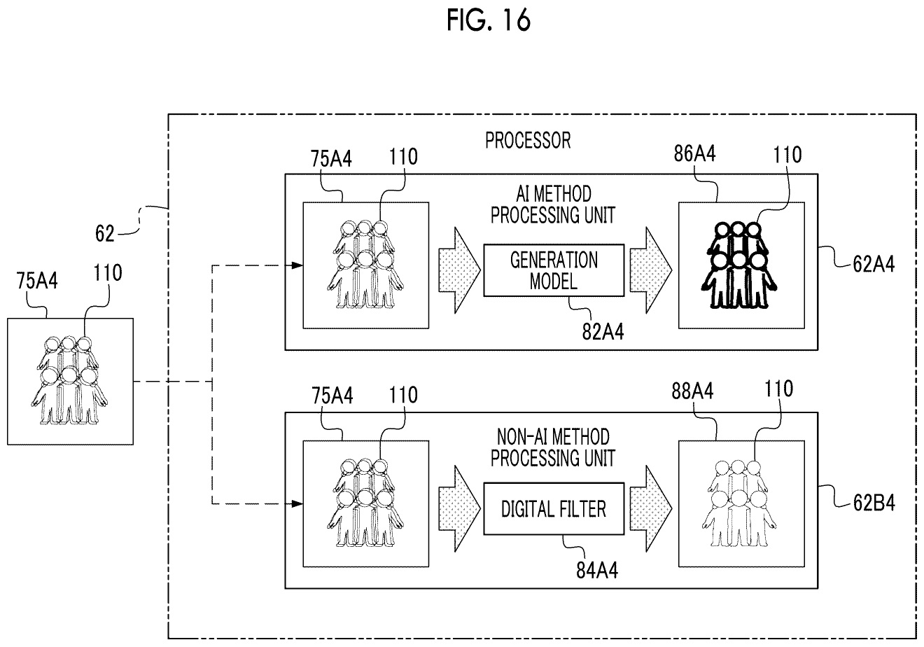

As an example shown in FIG. 16, the processor 62 according to the present third modification example differs from the processor 62 shown in FIG. 4 in that an AI method processing unit 62A4 is provided instead of the AI method processing unit 62A1, and in that a non-AI method processing unit 62B4 is provided instead of the non-AI method processing unit 62B1. In the present third modification example, the description of the same matters as those described before the third modification example will be omitted, and the matters different from the matters described before the third modification example will be described.

The processing target image 75A4 is input to the AI method processing unit 62A4 and the non-AI method processing unit 62B4. The processing target image 75A4 is an example of the processing target image 75A shown in FIG. 2. The processing target image 75A4 is a chromatic image and has a person region 110. The person region 110 is an image region where a person is captured. Although a chromatic image is exemplified here as the processing target image 75A4, the processing target image 75A4 may be an achromatic image.

The AI method processing unit 62A4 and the non-AI method processing unit 62B4 perform the processing of adjusting a resolution of the input processing target image 75A4. In the present third modification example, the processing of adjusting the resolution refers to processing of increasing or decreasing the resolution. The resolution of the processing target image 75A4 is an example of a “non-noise element of the processing target image”, a “factor that controls a visual impression given from the processing target image”, and a “resolution of the processing target image” according to the present disclosed technology.

The AI method processing unit 62A4 performs AI method processing on the processing target image 75A4. An example of the AI method processing on the processing target image includes processing that uses the generation model 82A4. The generation model 82A4 is an example of the generation model 82A shown in FIG. 3. The generation model 82A4 is a generation network that has already been trained to adjust the resolution of the processing target image 75A4. In the present third modification example, the training of adjusting the resolution of the processing target image 75A4 refers to a training of performing a super-resolution on the processing target image 75A4.

The AI method processing unit 62A4 changes the factor that controls the visual impression given from the processing target image 75A4 by using the AI method. That is, the AI method processing unit 62A4 changes the factor that controls the visual impression given from the processing target image 75A4 as the non-noise element of the processing target image by performing the processing, which uses the generation model 82A4, on the processing target image 75A4. The factor that controls the visual impression given from the processing target image 75A4 is the resolution of the processing target image 75A4. In the example shown in FIG. 16, the AI method processing unit 62A4 generates a first resolution adjusted image 86A4 by performing processing, which uses the generation model 82A4, on the processing target image 75A4. The first resolution adjusted image 86A4 is an image in which the resolution of the processing target image 75A4 is adjusted by using the AI method. Here, the image in which the resolution of the processing target image 75A4 is adjusted by using the AI method refers to an image in which the super-resolution is performed on the processing target image 75A4 by using the AI method.

Here, the processing, which uses the generation model 82A4, is an example of “first AI processing”, “first change processing”, and “first resolution adjustment processing” according to the present disclosed technology. The first resolution adjusted image 86A4 is an example of a “first changed image” and a “first resolution adjusted image” according to the present disclosed technology.

“Generating the first resolution adjusted image 86A4” is an example of “acquiring the first image” according to the present disclosed technology.

The processing target image 75A4 is input to the generation model 82A4. The generation model 82A4 generates and outputs the first resolution adjusted image 86A4 based on the input processing target image 75A4. In the example shown in FIG. 16, an image in which the super-resolution is performed on the processing target image 75A4 is shown as an example of the first resolution adjusted image 86A4.

The non-AI method processing unit 62B4 performs non-AI method processing on the processing target image 75A4. The non-AI method processing refers to processing that does not use a neural network. In the present third modification example, examples of the processing that does not use the neural network include processing that does not use the generation model 82A4.

An example of the non-AI method processing on the processing target image 75A4 includes processing that uses the digital filter 84A4. The digital filter 84A4 is a digital filter configured to adjust the resolution of the processing target image 75A4. Hereinafter, a digital filter that is configured as the digital filter 84A4 so as to perform the super-resolution on the processing target image 75A4 will be described as an example.

The non-AI method processing unit 62B4 generates a second resolution adjusted image 88A4 by performing the processing (that is, filtering), which uses the digital filter 84A4, on the processing target image 75A4. In other words, the non-AI method processing unit 62B4 generates the second resolution adjusted image 88A4 by adjusting the non-noise element (here, as an example, the resolution) in the processing target image 75A4 by using the non-AI method. Further, in other words, the non-AI method processing unit 62B4 generates the second resolution adjusted image 88A4 by adjusting the resolution of the processing target image 75A4 by using the non-AI method. The image in which the resolution of the processing target image is adjusted by using the non-AI method refers to an image in which the super-resolution is performed on the processing target image 75A4 by using the non-AI method.

Here, the processing, which uses the digital filter 84A4, is an example of “non-AI method processing that does not use a neural network” and “second change processing of changing the factor by using the non-AI method” according to the present disclosed technology. “Generating the second resolution adjusted image 88A4” is an example of “acquiring the second image” according to the present disclosed technology.

The processing target image 75A4 is input to the digital filter 84A4. The digital filter 84A4 generates the second resolution adjusted image 88A4 based on the input processing target image 75A4. The second resolution adjusted image 88A4 is an image obtained by changing the non-noise element by using the digital filter 84A4 (that is, an image obtained by changing the non-noise element by the processing, which uses the digital filter 84A4, with respect to the processing target image 75A4). In other words, the second resolution adjusted image 88A4 is an image in which the resolution of the processing target image 75A4 is adjusted by using the digital filter 84A4 (that is, an image in which the resolution is adjusted by the processing, which uses the digital filter 84A4, with respect to the processing target image 75A4). In the example shown in FIG. 16, as an example of the second resolution adjusted image 88A4, an image in which the super-resolution is performed on the processing target image 75A4 and the resolution is lower than that of the first resolution adjusted image 86A4 is shown. The second resolution adjusted image 88A4 is an example of a “second image”, a “second changed image”, and a “second resolution adjusted image” according to the present disclosed technology.

By the way, the resolution of the first resolution adjusted image 86A4, which is obtained by performing the AI method processing on the processing target image 75A4, may be a resolution different from the user's preference due to the characteristic of the generation model 82A4 (for example, the number of interlayers and/or the amount of training, or the like). In a case where the influence of the AI method processing is excessively reflected on the processing target image 75A4, it is conceivable that the resolution is too high or too low than the user's preference.

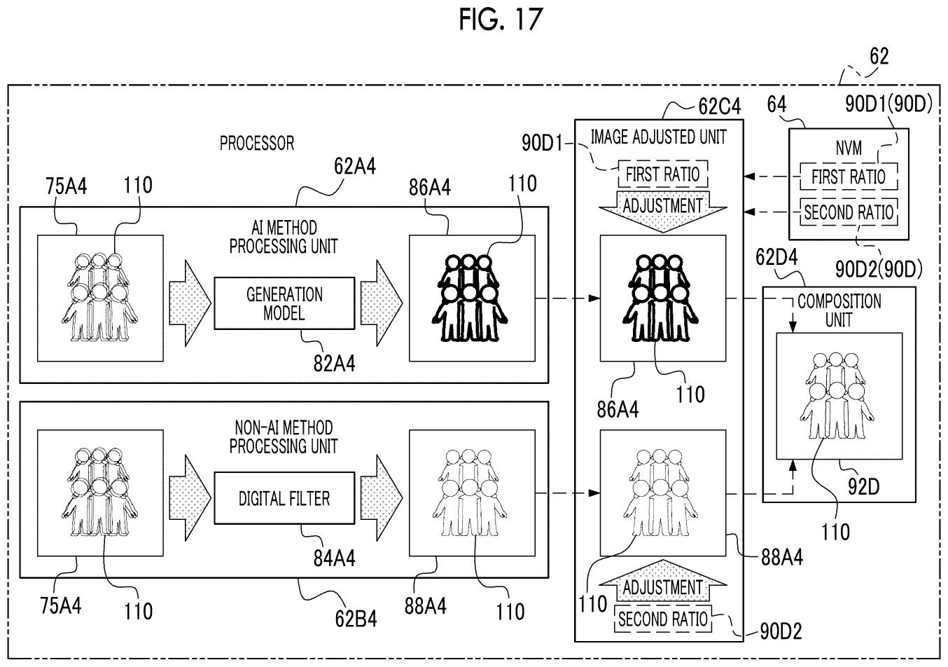

Therefore, in view of such circumstances, in the imaging apparatus 10, as an example shown in FIG. 17, by performing the processing of the image adjustment unit 62C4 and the processing of the composition unit 62D4 on the first resolution adjusted image 86A4 and the second resolution adjusted image 88A4, the first resolution adjusted image 86A4 and the second resolution adjusted image 88A4 are combined.

As an example shown in FIG. 17, a ratio 90D is stored in the NVM 64. The ratio 90D is a ratio for combining the first resolution adjusted image 86A4 and the second resolution adjusted image 88A4 and is defined to adjust excess and deficiency of the AI method processing (that is, the processing that uses the generation model 82A4) performed by the AI method processing unit 62A4.

The ratio 90D is roughly classified into a first ratio 90D1 and a second ratio 90D2. The first ratio 90D1 is a value of 0 or more and 1 or less, and the second ratio 90D2 is a value obtained by subtracting the value of the first ratio 90D1 from “1”. That is, the first ratio 90D1 and the second ratio 90D2 are defined such that the sum of the first ratio 90D1 and the second ratio 90D2 is “1”. The first ratio 90D1 and the second ratio 90D2 are variable values that are changed by an instruction from the user.

The image adjustment unit 62C4 adjusts the first resolution adjusted image 86A4 generated by the AI method processing unit 62A4 by using the first ratio 90D1. For example, the image adjustment unit 62C4 adjusts a pixel value of each pixel of the first resolution adjusted image 86A4 by multiplying a pixel value of each pixel of the first resolution adjusted image 86A4 by the first ratio 90D1.

The image adjustment unit 62C4 adjusts the second resolution adjusted image 88A4 generated by the non-AI method processing unit 62B4 by using the second ratio 90D2. For example, the image adjustment unit 62C4 adjusts a pixel value of each pixel of the second resolution adjusted image 88A4 by multiplying a pixel value of each pixel of the second resolution adjusted image 88A4 by the second ratio 90D2.

The composition unit 62D4 generates a composite image 92D by combining the first resolution adjusted image 86A4 adjusted at the first ratio 90D1 by the image adjustment unit 62C4 and the second resolution adjusted image 88A4 adjusted at the second ratio 90D2 by the image adjustment unit 62C4. That is, the composition unit 62D4 adjusts the excess and deficiency of the AI method processing performed by the AI method processing unit 62A4 by combining the first resolution adjusted image 86A4 adjusted at the first ratio 90D1 and the second resolution adjusted image 88A4 adjusted at the second ratio 90D2. In other words, the composition unit 62D4 adjusts the non-noise element (here, as an example, the resolution) by combining the first resolution adjusted image 86A4 adjusted at the first ratio 90D1 and the second resolution adjusted image 88A4 adjusted at the second ratio 90D2. Further, in other words, the composition unit 62D4 adjusts an element derived from the processing that uses the generation model 82A4 (for example, the pixel value of the pixel of which the resolution is adjusted by using the generation model 82A4) by combining the first resolution adjusted image 86A4 adjusted at the first ratio 90D1 and the second resolution adjusted image 88A4 adjusted at the second ratio 90D2.

The composition, which is performed by the composition unit 62D4, is an addition of a pixel value of a corresponding pixel position between the first resolution adjusted image 86A4 and the second resolution adjusted image 88A4. The composition, which is performed by the composition unit 62D4, is performed in the same manner as the composition, which is performed by the composition unit 62D1 shown in FIG. 5. Further, various types of image processing are also performed on the composite image 92D by the composition unit 62D4 in the same manner as on the composite image 92A shown in FIG. 5. The composite image 92D, in which various types of image processing are performed, is output to a default output destination by the composition unit 62D4.

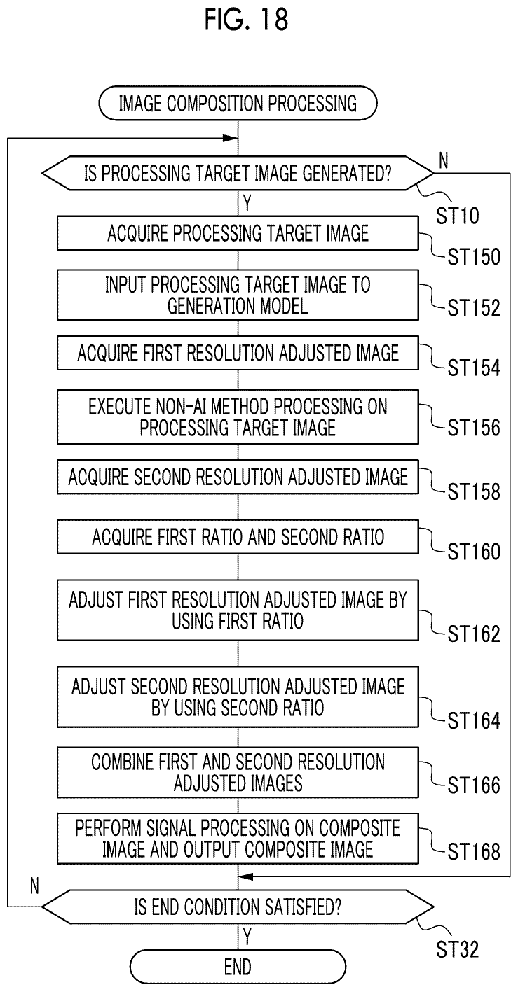

FIG. 18 shows an example of a flow of the image composition processing according to the present third modification example. The flowchart shown in FIG. 18 is different from the flowchart shown in FIG. 6 in that it includes step ST150 to step ST168 instead of step ST12 to step ST30.

In the image composition processing shown in FIG. 18, in step ST150, the AI method processing unit 62A4 and the non-AI method processing unit 62B4 acquire the processing target image 75A4 from the image sensor 20. After the processing of step ST150 is executed, the image composition processing shifts to step ST152.

In step ST152, the AI method processing unit 62A4 inputs the processing target image acquired in step ST150 to the generation model 82A4. As a result, the super-resolution is performed on the processing target image 75A4 by using the AI method. After the processing of step ST152 is executed, the image composition processing shifts to step ST154.

In step ST154, the AI method processing unit 62A4 acquires the first resolution adjusted image 86A4 output from the generation model 82A4 by inputting the processing target image to the generation model 82A4 in step ST152. After the processing of step ST154 is executed, the image composition processing shifts to step ST156.

In step ST156, the non-AI method processing unit 62B4 adjusts the resolution of the processing target image 75A4 by performing the processing, which uses the digital filter 84A4, on the processing target image 75A4 acquired in step ST150. As a result, the super-resolution is performed on the processing target image 75A4 by using the non-AI method. After the processing of step ST156 is executed, the image composition processing shifts to step ST158.

In step ST158, the non-AI method processing unit 62B4 acquires the second resolution adjusted image 88A4 obtained by performing the processing, which uses the digital filter 84A4, on the processing target image 75A4 in step ST156. After the processing of step ST158 is executed, the image composition processing shifts to step ST160.

In step ST160, the image adjustment unit 62C4 acquires the first ratio 90D1 and the second ratio 90D2 from the NVM64. After the processing of step ST160 is executed, the image composition processing shifts to step ST162.

In step ST162, the image adjustment unit 62C4 adjusts the first resolution adjusted image 86A4 by using the first ratio 90D1 acquired in step ST160. After the processing of step ST162 is executed, the image composition processing shifts to step ST164.

In step ST164, the image adjustment unit 62C4 adjusts the second resolution adjusted image 88A4 by using the second ratio 90D2 acquired in step ST160. After the processing of step ST164 is executed, the image composition processing shifts to step ST166.

In step ST166, the composition unit 62D4 adjusts the excess and deficiency of the AI method processing performed by the AI method processing unit 62A4 by combining the first resolution adjusted image 86A4 adjusted in step ST162 and the second resolution adjusted image 88A4 adjusted in step ST164. The composite image 92D is generated by combining the first resolution adjusted image 86A4 adjusted in step ST162 and the second resolution adjusted image 88A4 adjusted in step ST164. After the processing of step ST166 is executed, the image composition processing shifts to step ST168.

In step ST168, the composition unit 62D4 performs various types of image processing on the composite image 92D. The composition unit 62D4 outputs an image obtained by performing various types of image processing on the composite image 92D to a default output destination as the processed image 75B. After the processing of step ST168 is executed, the image composition processing shifts to step ST32.

As described above, in the imaging apparatus 10 according to the present third modification example, the first resolution adjusted image 86A4 is generated by adjusting the resolution of the processing target image 75A4 by using the AI method. Thereafter, the first resolution adjusted image 86A4 and the second resolution adjusted image 88A4 are combined. As a result, it is possible to suppress the excess and deficiency of the resolution in a case of performing the AI method processing with respect to the composite image 92D. As a result, the composite image 92D becomes an image in which the resolution in a case of performing the AI method processing is less noticeable than that of the first resolution adjusted image 86A4, and it is possible to provide a suitable image to a user who does not prefer the resolution in a case of performing the AI method processing to be excessively noticeable.

In the present third modification example, the first resolution adjusted image 86A4 is an image in which the super-resolution is performed on the processing target image 75A4 by using the AI method, and the second resolution adjusted image 88A4 is an image in which the super-resolution is performed on the processing target image 75A4 by using the non-AI method. Thereafter, the composite image 92D is generated by combining the image in which the super-resolution is performed on the processing target image 75A4 by using the AI method and the image in which the super-resolution is performed on the processing target image 75A4 by the non-AI method. Therefore, it is possible to suppress the excess and deficiency of the resolution obtained by performing the super-resolution by using the AI method, with respect to the composite image 92D.

Here, although an example of the embodiment in which the first resolution adjusted image 86A4 obtained by performing the processing, which uses the generation model 82A4, on the processing target image 75A4 and the second resolution adjusted image 88A4 obtained by performing the processing, which uses the digital filter 84A4, on the processing target image are combined has been described, the present disclosed technology is not limited to this. For example, the first resolution adjusted image 86A4 obtained by performing the processing, which uses the generation model 82A4, on the processing target image 75A4 and the processing target image 75A4 (that is, an image in which the non-noise element is not adjusted) may be combined. In this case, the same effect can be expected.

### Fourth Modification Example

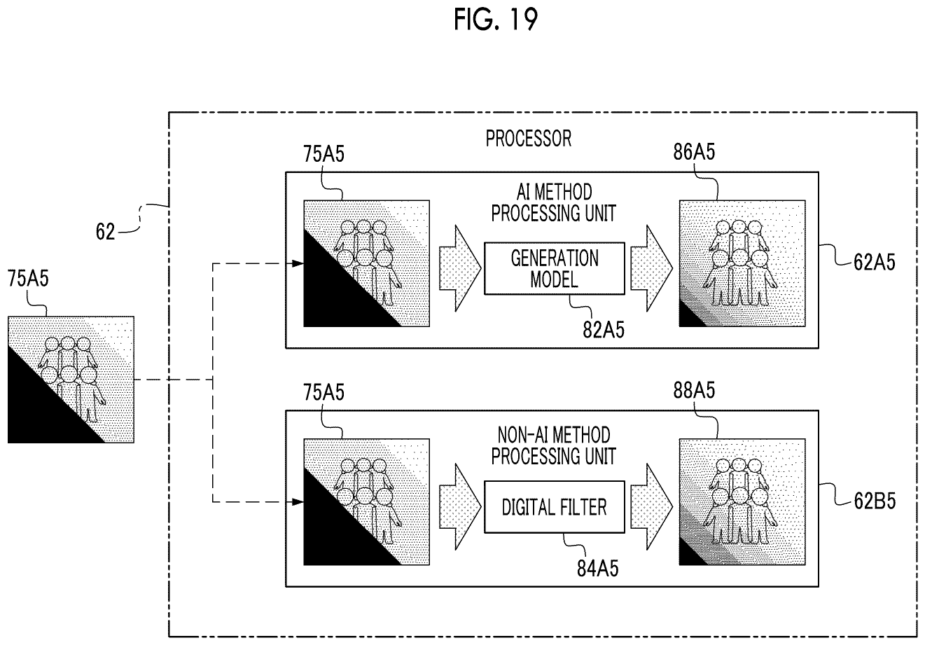

As an example shown in FIG. 19, the processor 62 according to the present fourth modification example differs from the processor 62 shown in FIG. 4 in that an AI method processing unit 62A5 is provided instead of the AI method processing unit 62A1, and in that a non-AI method processing unit 62B5 is provided instead of the non-AI method processing unit 62B1. In the present fourth modification example, the description of the same matters as those described before the fourth modification example will be omitted, and the matters different from the matters described before the fourth modification example will be described.

The processing target image 75A5 is input to the AI method processing unit 62A5 and the non-AI method processing unit 62B5. The processing target image 75A5 is an example of the processing target image 75A shown in FIG. 2. The processing target image 75A5 is a chromatic image. Although a chromatic image is exemplified here as the processing target image 75A5, the processing target image 75A5 may be an achromatic image.

The AI method processing unit 62A5 and the non-AI method processing unit 62B5 perform processing of expanding a dynamic range of the input processing target image 75A5. The dynamic range of the processing target image 75A5 is an example of a “non-noise element of the processing target image”, a “factor that controls a visual impression given from the processing target image”, and a “dynamic range of the processing target image” according to the present disclosed technology.

The AI method processing unit 62A5 performs AI method processing on the processing target image 75A5. An example of the AI method processing on the processing target image 75A5 includes processing that uses the generation model 82A5. The generation model 82A5 is an example of the generation model 82A shown in FIG. 3. The generation model 82A5 is a generation network that has already been trained to expand the dynamic range of the processing target image 75A5. In the present fourth modification example, the training of adjusting the dynamic range of the processing target image 75A5 refers to a training of performing a high-dynamic range on the processing target image 75A5. Hereinafter, the “high dynamic range” will be referred to as “HDR”.

The AI method processing unit 62A5 changes the factor that controls the visual impression given from the processing target image 75A5 by using the AI method. That is, the AI method processing unit 62A5 changes the factor that controls the visual impression given from the processing target image 75A5 as the non-noise element of the processing target image 75A5 by performing the processing, which uses the generation model 82A5, on the processing target image 75A5. The factor that controls the visual impression given from the processing target image 75A5 is the dynamic range of the processing target image 75A5. In the example shown in FIG. 19, the AI method processing unit 62A5 generates a first HDR image 86A5 by performing processing, which uses the generation model 82A5, on the processing target image 75A5. The first HDR image 86A5 is an image in which the dynamic range of the processing target image 75A5 is expanded by using the AI method.

Here, the processing, which uses the generation model 82A5, is an example of “first AI processing”, “first change processing”, and “expansion processing” according to the present disclosed technology. The first HDR image 86A5 is an example of a “first changed image” and a “first HDR image” according to the present disclosed technology. “Generating the first HDR image 86A5” is an example of “acquiring the first image” according to the present disclosed technology.

The processing target image 75A5 is input to the generation model 82A5. The generation model 82A5 generates and outputs the first HDR image 86A5 based on the input processing target image 75A5.

The non-AI method processing unit 62B5 performs non-AI method processing on the processing target image 75A5. The non-AI method processing refers to processing that does not use a neural network. In the present fourth modification example, examples of the processing that does not use the neural network include processing that does not use the generation model 82A5.

An example of the non-AI method processing on the processing target image 75A5 includes processing that uses the digital filter 84A5. The digital filter 84A5 is a digital filter configured to expand the dynamic range of the processing target image 75A5. Hereinafter, a digital filter that is configured as the digital filter 84A5 so as to perform the HDR on the processing target image 75A5 will be described as an example.

The non-AI method processing unit 62B5 generates a second HDR image 88A5 by performing the processing (that is, filtering), which uses the digital filter 84A5, on the processing target image 75A5. In other words, the non-AI method processing unit 62B5 generates the second HDR image 88A5 by changing the non-noise element of the processing target image 75A5 by using the non-AI method. In other words, the non-AI method processing unit 62B5 generates the second HDR image 88A5 by expanding the dynamic range of the processing target image 75A5 by using the non-AI method.

Here, the processing, which uses the digital filter 84A5, is an example of “non-AI method processing that does not use a neural network” and “second change processing of changing the factor by using the non-AI method” according to the present disclosed technology. “Generating the second HDR image 88A5” is an example of “acquiring the second image” according to the present disclosed technology.

The processing target image 75A5 is input to the digital filter 84A5. The digital filter 84A5 generates the second HDR image 88A5 based on the input processing target image 75A5. The second HDR image 88A5 is an image obtained by changing the non-noise element by using the digital filter 84A5 (that is, an image obtained by changing the non-noise element by the processing, which uses the digital filter 84A5, with respect to the processing target image 75A5). In other words, the second HDR image 88A5 is an image in which the dynamic range of the processing target image 75A5 is changed by using the digital filter 84A5 (that is, an image in which the dynamic range is expanded by the processing, which uses the digital filter 84A5, with respect to the processing target image 75A5). The second HDR image 88A5 is an example of a “second image”, a “second changed image”, and a “second HDR image” according to the present disclosed technology.

By the way, the dynamic range of the first HDR image 86A5, which is obtained by performing the AI method processing on the processing target image 75A5, may be a dynamic range different from the user's preference due to the characteristic of the generation model 82A5 (for example, the number of interlayers and/or the amount of training, or the like). In a case where the influence of the AI method processing is excessively reflected on the processing target image 75A5, it is considered that the dynamic range is too wide or narrower than the user's preference.

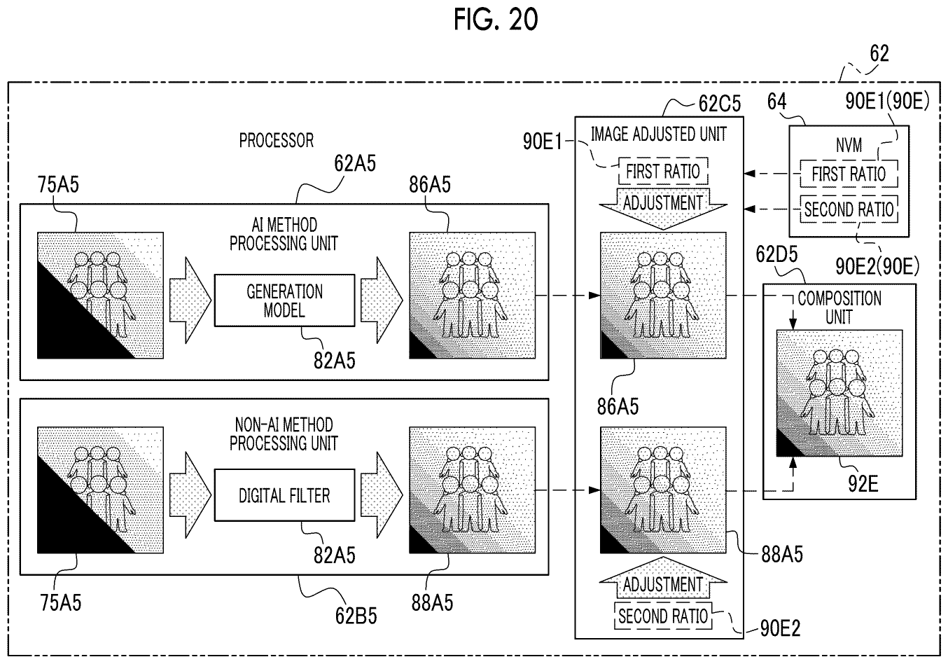

Therefore, in view of such circumstances, in the imaging apparatus 10, as an example shown in FIG. 20, by performing the processing of the image adjustment unit 62C5 and the processing of the composition unit 62D5 on the first HDR image 86A5 and the second HDR image 88A5, the first HDR image 86A5 and the second HDR image 88A5 are combined.

As an example shown in FIG. 20, a ratio 90E is stored in the NVM 64. The ratio 90E is a ratio for combining the first HDR image 86A5 and the second HDR image 88A5 and is defined to adjust excess and deficiency of the AI method processing (that is, the processing that uses the generation model 82A5) performed by the AI method processing unit 62A5.

The ratio 90E is roughly classified into a first ratio 90E1 and a second ratio 90E2. The first ratio 90E1 is a value of 0 or more and 1 or less, and the second ratio 90E2 is a value obtained by subtracting the value of the first ratio 90E1 from “1”. That is, the first ratio 90E1 and the second ratio 90E2 are defined such that the sum of the first ratio 90E1 and the second ratio 90E2 is “1”. The first ratio 90E1 and the second ratio 90E2 are variable values that are changed by an instruction from the user.

The image adjustment unit 62C5 adjusts the first HDR image 86A5 generated by the AI method processing unit 62A5 by using the first ratio 90E1. For example, the image adjustment unit 62C5 adjusts a pixel value of each pixel of the first HDR image 86A5 by multiplying a pixel value of each pixel of the first HDR image 86A5 by using the first ratio 90E1.

The image adjustment unit 62C5 adjusts the second HDR image 88A5 generated by the non-AI method processing unit 62B5 by using the second ratio 90E2. For example, the image adjustment unit 62C5 adjusts a pixel value of each pixel of the second HDR image 88A5 by multiplying a pixel value of each pixel of the second HDR image 88A5 by the second ratio 90E2.

The composition unit 62D5 generates a composite image 92E by combining the first HDR image 86A5 adjusted at the first ratio 90E1 by the image adjustment unit 62C5 and the second HDR image 88A5 adjusted at the second ratio 90E2 by the image adjustment unit 62C5. That is, the composition unit 62D5 adjusts the excess and deficiency of the AI method processing performed by the AI method processing unit 62A5 by combining the first HDR image 86A5 adjusted at the first ratio 90E1 and the second HDR image 88A5 adjusted at the second ratio 90E2. In other words, the composition unit 62D5 adjusts the non-noise element (here, as an example, the dynamic range) by combining the first HDR image 86A5 adjusted at the first ratio 90E1 and the second HDR image 88A5 adjusted at the second ratio 90E2. Further, in other words, the composition unit 62D5 adjusts an element derived from the processing that uses the generation model 82A5 (for example, the pixel value of the pixel of which the dynamic range is expanded by using the generation model 82A5) by combining the first HDR image 86A5 adjusted at the first ratio 90E1 and the second HDR image 88A5 adjusted at the second ratio 90E2.

The composition, which is performed by the composition unit 62D5, is an addition of a pixel value of a corresponding pixel position between the first HDR image 86A5 and the second HDR image 88A5. The composition, which is performed by the composition unit 62D5, is performed in the same manner as the composition, which is performed by the composition unit 62D1 shown in FIG. 5. Further, various types of image processing are also performed on the composite image 92E by the composition unit 62D5 in the same manner as on the composite image 92A shown in FIG. 5. The composite image 92E, in which various types of image processing are performed, is output to a default output destination by the composition unit 62D5.

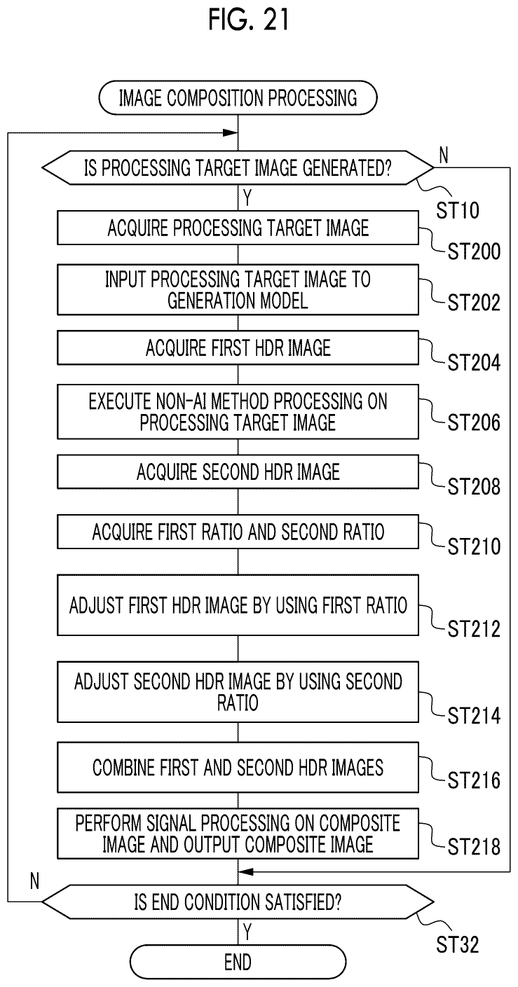

FIG. 21 shows an example of a flow of the image composition processing according to the present fourth modification example. The flowchart shown in FIG. 21 is different from the flowchart shown in FIG. 6 in that it includes step ST200 to step ST218 instead of step ST12 to step ST30.

In the image composition processing shown in FIG. 21, in step ST200, the AI method processing unit 62A5 and the non-AI method processing unit 62B5 acquire the processing target image 75A5 from the image sensor 20. After the processing of step ST200 is executed, the image composition processing shifts to step ST202.

In step ST202, the AI method processing unit 62A5 inputs the processing target image 75A5 acquired in step ST200 to the generation model 82A5. As a result, the HDR is performed on the processing target image 75A5 by using the AI method. After the processing of step ST202 is executed, the image composition processing shifts to step ST204.

In step ST204, the AI method processing unit 62A5 acquires the first HDR image 86A5 output from the generation model 82A5 by inputting the processing target image 75A5 to the generation model 82A5 in step ST202. After the processing of step ST204 is executed, the image composition processing shifts to step ST206.

In step ST206, the non-AI method processing unit 62B5 expands the dynamic range of the processing target image 75A5 by performing the processing, which uses the digital filter 84A5, on the processing target image 75A5 acquired in step ST200. As a result, the HDR is performed on the processing target image 75A5 by using the non-AI method. After the processing of step ST206 is executed, the image composition processing shifts to step ST208.

In step ST208, the non-AI method processing unit 62B5 acquires the second HDR image 88A5 obtained by performing the processing, which uses the digital filter 84A5, on the processing target image 75A5 in step ST206. After the processing of step ST208 is executed, the image composition processing shifts to step ST210.

In step ST210, the image adjustment unit 62C5 acquires the first ratio 90E1 and the second ratio 90E2 from the NVM64. After the processing of step ST210 is executed, the image composition processing shifts to step ST212.

In step ST212, the image adjustment unit 62C5 adjusts the first HDR image 86A5 by using the first ratio 90E1 acquired in step ST210. After the processing of step ST212 is executed, the image composition processing shifts to step ST214.

In step ST214, the image adjustment unit 62C5 adjusts the second HDR image 88A5 by using the second ratio 90E2 acquired in step ST210. After the processing of step ST214 is executed, the image composition processing shifts to step ST216.

In step ST216, the composition unit 62D5 adjusts the excess and deficiency of the AI method processing performed by the AI method processing unit 62A5 by combining the first HDR image 86A5 adjusted in step ST212 and the second HDR image 88A5 adjusted in step ST214. The composite image 92E is generated by combining the first HDR image 86A5 adjusted in step ST212 and the second HDR image 88A5 adjusted in step ST214. After the processing of step ST216 is executed, the image composition processing shifts to step ST218.

In step ST218, the composition unit 62D5 performs various types of image processing on the composite image 92E. The composition unit 62D5 outputs an image obtained by performing various types of image processing on the composite image 92E to a default output destination as the processed image 75B. After the processing of step ST218 is executed, the image composition processing shifts to step ST32.

As described above, in the imaging apparatus 10 according to the present fourth modification example, the first HDR image 86A5 is generated by performing the HDR on the dynamic range of the processing target image 75A5 by using the AI method. Thereafter, the first HDR image 86A5 and the second HDR image 88A5 are combined. As a result, it is possible to suppress the excess and deficiency of the dynamic range in a case of performing the AI method processing with respect to the composite image 92E. As a result, the composite image 92E becomes an image in which the dynamic range in a case of performing the AI method processing is less noticeable than that of the first HDR image 86A5, and it is possible to provide a suitable image to a user who does not prefer the dynamic range in a case of performing the AI method processing to be excessively noticeable.

Here, although an example of the embodiment in which the first HDR image 86A5 obtained by performing the processing, which uses the generation model 82A5, on the processing target image 75A5 and the second HDR image 88A5 obtained by performing the processing, which uses the digital filter 84A5, on the processing target image 75A5 are combined has been described, the present disclosed technology is not limited to this. For example, the first HDR image 86A5 obtained by performing the processing, which uses the generation model 82A5, on the processing target image 75A5 and the processing target image 75A5 (that is, an image in which the non-noise element is not adjusted) may be combined. In this case, the same effect can be expected.

### Fifth Modification Example

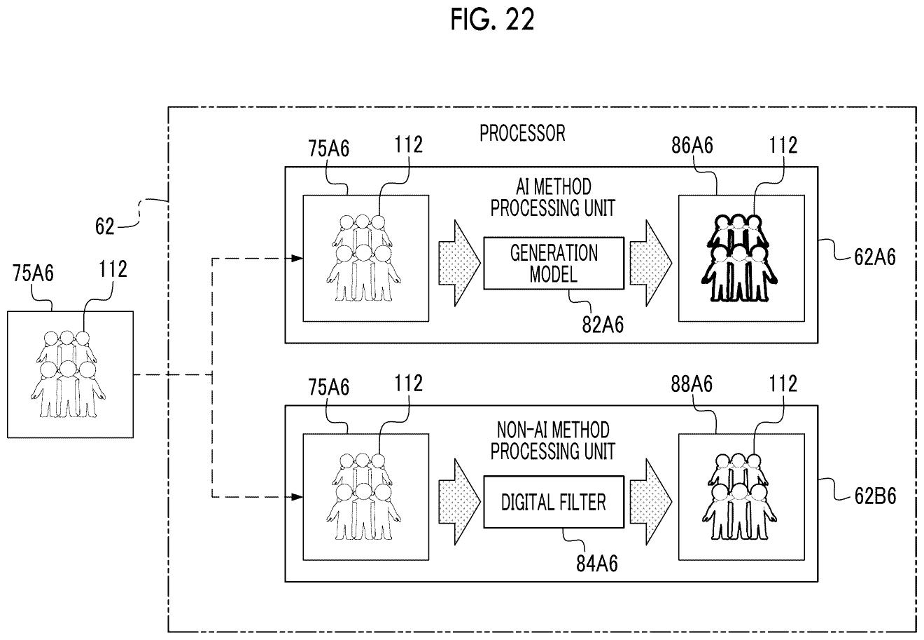

As an example shown in FIG. 22, the processor 62 according to the present fifth modification example differs from the processor 62 shown in FIG. 4 in that an AI method processing unit 62A6 is provided instead of the AI method processing unit 62A1, and in that a non-AI method processing unit 62B6 is provided instead of the non-AI method processing unit 62B1. In the present fifth modification example, the description of the same matters as those described before the fifth modification example will be omitted, and the matters different from the matters described before the fifth modification example will be described.

The processing target image 75A6 is input to the AI method processing unit 62A6 and the non-AI method processing unit 62B6. The processing target image 75A6 is an example of the processing target image 75A shown in FIG. 2. The processing target image 75A6 is a chromatic image and has an edge region 112. The edge region 112 is an image region (for example, a high-frequency component having a certain value or higher) in which an edge of the subject is captured. Although a chromatic image is exemplified here as the processing target image 75A6, the processing target image 75A6 may be an achromatic image.

The AI method processing unit 62A6 and the non-AI method processing unit 62B6 perform processing of emphasizing the edge region 112 in the input processing target image 75A6 more than a non-edge region (hereinafter, simply referred to as a “non-edge region”), which is a region different from the edge region 112. The edge region 112 is an example of an “edge region in the processing target image” according to the present disclosed technology. An emphasizing degree of the edge region 112 is an example of a “non-noise element of the processing target image”, a “factor that controls a visual impression given from the processing target image”, and an “emphasizing degree of the edge region” according to the present disclosed technology.

The AI method processing unit 62A6 performs AI method processing on the processing target image 75A6. An example of the AI method processing on the processing target image 75A6 includes processing that uses the generation model 82A6. The generation model 82A6 is an example of the generation model 82A shown in FIG. 3. The generation model 82A6 is a generation network that has already been trained to emphasize the edge region 112 in the processing target image 75A6 as compared to the non-edge region.

The AI method processing unit 62A6 changes the factor that controls the visual impression given from the processing target image 75A6 by using the AI method. That is, the AI method processing unit 62A6 changes the factor that controls the visual impression given from the processing target image 75A6 as the non-noise element of the processing target image 75A6 by performing the processing, which uses the generation model 82A6, on the processing target image 75A6. The factor that controls the visual impression given from the processing target image 75A6 is the edge region 112 in the processing target image 75A6. In the example shown in FIG. 22, the AI method processing unit 62A6 generates a first edge emphasized image 86A6 by performing the processing, which uses the generation model 82A6, on the processing target image 75A6. The first edge emphasized image 86A6 is an image in which the edge region 112 in the processing target image 75A6 is emphasized more than the non-edge region by using the AI method.

Here, the processing, which uses the generation model 82A6, is an example of “first AI processing”, “first change processing”, and “emphasis processing” according to the present disclosed technology. The first edge emphasized image 86A6 is an example of a “first changed image” and a “first edge emphasized image” according to the present disclosed technology. “Generating the first edge emphasized image 86A6” is an example of “acquiring the first image” according to the present disclosed technology.

The processing target image 75A6 is input to the generation model 82A6. The generation model 82A6 generates and outputs the first edge emphasized image 86A6 based on the input processing target image 75A6.

The non-AI method processing unit 62B6 performs non-AI method processing on the processing target image 75A6. The non-AI method processing refers to processing that does not use a neural network. In the present fifth modification example, examples of the processing that does not use the neural network include processing that does not use the generation model 82A6.

An example of the non-AI method processing on the processing target image 75A6 includes processing that uses the digital filter 84A6. The digital filter 84A6 is a digital filter configured to emphasize the edge region 112 in the processing target image 75A6 more than the non-edge region.

The non-AI method processing unit 62B6 generates a second edge emphasized image 88A6 by performing the processing (that is, filtering), which uses the digital filter 84A6, on the processing target image 75A6. In other words, the non-AI method processing unit 62B6 generates the second edge emphasized image 88A6 by emphasizing the non-noise element (here, as an example, the edge region 112) in the processing target image 75A6 more than the non-edge region by using the non-AI method. Further, in other words, the non-AI method processing unit 62B6 generates the second edge emphasized image 88A6 by emphasizing the edge region 112 in the processing target image 75A6 more than the non-edge region by using the non-AI method.

Here, the processing, which uses the digital filter 84A6, is an example of “non-AI method processing that does not use a neural network” and “second change processing of changing the factor by using the non-AI method” according to the present disclosed technology. “Generating the second edge emphasized image 88A6” is an example of “acquiring the second image” according to the present disclosed technology.

The processing target image 75A6 is input to the digital filter 84A6. The digital filter 84A6 generates the second edge emphasized image 88A6 based on the input processing target image 75A6. The second edge emphasized image 88A6 is an image obtained by changing the non-noise element by using the digital filter 84A6 (that is, an image obtained by changing the non-noise element by the processing, which uses the digital filter 84A6, with respect to the processing target image 75A6). In other words, the second edge emphasized image 88A6 is an image in which the edge region 112 in the processing target image 75A6 is adjusted by using the digital filter 84A6 (that is, an image in which the edge region 112 is emphasized more than the non-edge region by the processing, which uses the digital filter 84A6, with respect to the processing target image 75A6). The intensity of the edge region 112 in the second edge emphasized image 88A6 is lower than the intensity of the edge region 112 in the first edge emphasized image 86A6. The lower intensity of the edge region 112 in the second edge emphasized image 88A6 with respect to the edge region 112 in the first edge emphasized image 86A6 is, for example, at least to the extent that a difference between the edge region 112 in the second edge emphasized image 88A6 and the edge region 112 in the first edge emphasized image 86A6 can be visually recognized. The second edge emphasized image 88A6 is an example of a “second image”, a “second changed image”, and a “second edge emphasized image” according to the present disclosed technology.

By the way, the intensity (for example, the brightness) of the first edge emphasized image 86A6, which is obtained by performing the AI method processing on the processing target image 75A6, may be an intensity different from the user's preference due to the characteristic of the generation model 82A6 (for example, the number of interlayers and/or the amount of training, or the like). In a case where the influence of the AI method processing is excessively reflected on the processing target image 75A6, it is conceivable that the intensity is too high or too low than the user's preference.

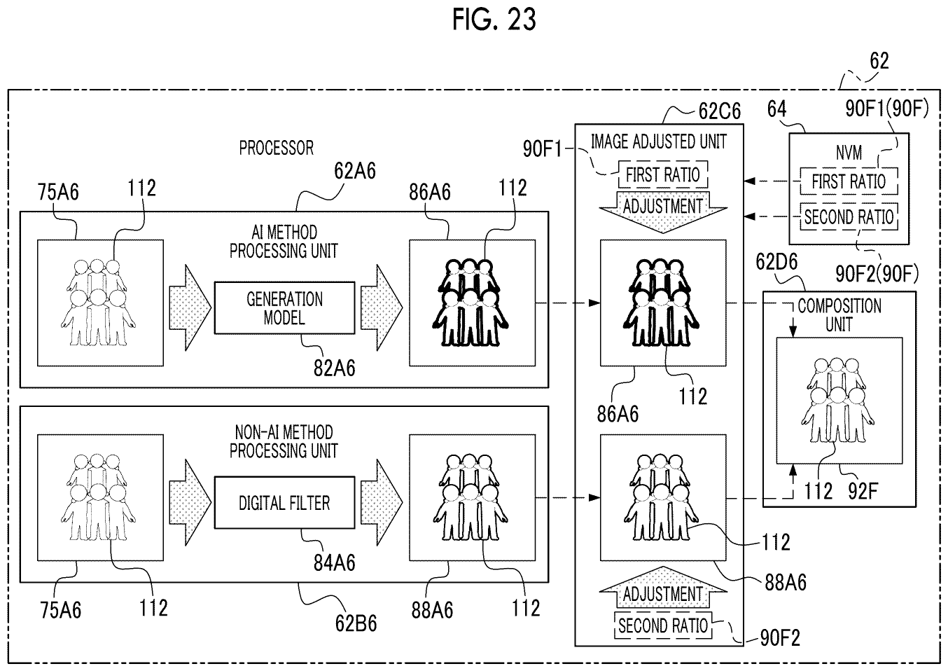

Therefore, in view of such circumstances, in the imaging apparatus 10, as an example shown in FIG. 23, by performing the processing of the image adjustment unit 62C6 and the processing of the composition unit 62D6 on the first edge emphasized image 86A6 and the second edge emphasized image 88A6, the first edge emphasized image 86A6 and the second edge emphasized image 88A6 are combined.

As an example shown in FIG. 23, a ratio 90F is stored in the NVM 64. The ratio 90F is a ratio for combining the first edge emphasized image 86A6 and the second edge emphasized image 88A6 and is defined to adjust excess and deficiency of the AI method processing (that is, the processing that uses the generation model 82A6) performed by the AI method processing unit 62A6.

The ratio 90F is roughly classified into a first ratio 90F1 and a second ratio 90F2. The first ratio 90F1 is a value of 0 or more and 1 or less, and the second ratio 90F2 is a value obtained by subtracting the value of the first ratio 90F1 from “1”. That is, the first ratio 90F1 and the second ratio 90F2 are defined such that the sum of the first ratio 90F1 and the second ratio 90F2 is “1”. The first ratio 90F1 and the second ratio 90F2 are variable values that are changed by an instruction from the user.

The image adjustment unit 62C6 adjusts the first edge emphasized image 86A6 generated by the AI method processing unit 62A6 by using the first ratio 90F1. For example, the image adjustment unit 62C6 adjusts a pixel value of each pixel of the first edge emphasized image 86A6 by multiplying a pixel value of each pixel of the first edge emphasized image 86A6 by the first ratio 90F1.

The image adjustment unit 62C6 adjusts the second edge emphasized image 88A6 generated by the non-AI method processing unit 62B6 by using the second ratio 90F2. For example, the image adjustment unit 62C6 adjusts a pixel value of each pixel of the second edge emphasized image 88A6 by multiplying a pixel value of each pixel of the second edge emphasized image 88A6 by the second ratio 90F2.

The composition unit 62D6 generates a composite image 92F by combining the first edge emphasized image 86A6 adjusted at the first ratio 90F1 by the image adjustment unit 62C6 and the second edge emphasized image 88A6 adjusted at the second ratio 90F2 by the image adjustment unit 62C6. That is, the composition unit 62D6 adjusts the excess and deficiency of the AI method processing performed by the AI method processing unit 62A6 by combining the first edge emphasized image 86A6 adjusted at the first ratio 90F1 and the second edge emphasized image 88A6 adjusted at the second ratio 90F2. In other words, the composition unit 62D6 adjusts the non-noise element (here, for example, the edge region 112) by combining the first edge emphasized image 86A6 adjusted at the first ratio 90F1 and the second edge emphasized image 88A6 adjusted at the second ratio 90F2. Further, in other words, the composition unit 62D6 adjusts an element derived from the processing that uses the generation model 82A6 (for example, the pixel value of the pixel of which the edge region 112 is emphasized more than the non-edge region by using the generation model 82A6) by combining the first edge emphasized image 86A6 adjusted at the first ratio 90F1 and the second edge emphasized image 88A6 adjusted at the second ratio 90F2.

The composition, which is performed by the composition unit 62D6, is an addition of a pixel value of a corresponding pixel position between the first edge emphasized image 86A6 and the second edge emphasized image 88A6. The composition, which is performed by the composition unit 62D6, is performed in the same manner as the composition, which is performed by the composition unit 62D1 shown in FIG. 5. Further, various types of image processing are also performed on the composite image 92F by the composition unit 62D6 in the same manner as on the composite image 92A shown in FIG. 5. The composite image 92F, in which various types of image processing are performed, is output to a default output destination by the composition unit 62D6.

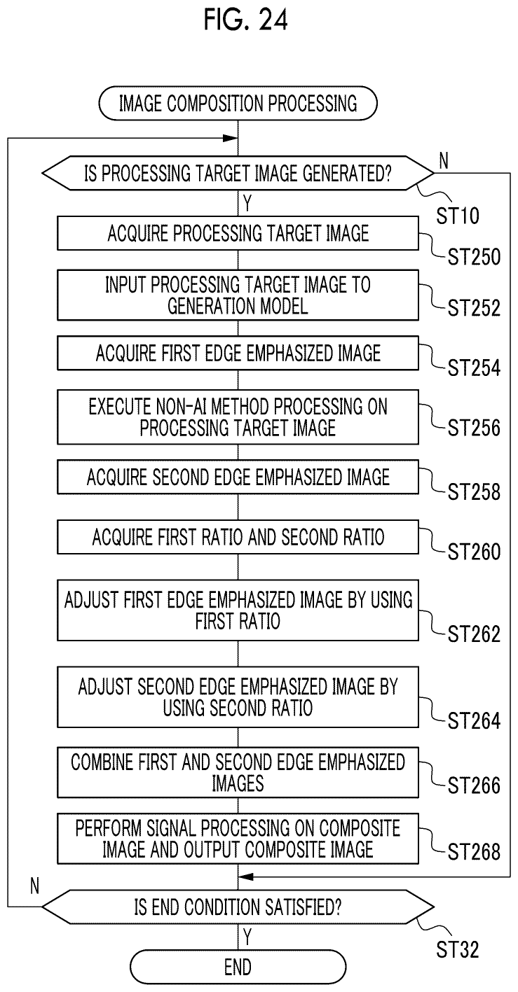

FIG. 24 shows an example of a flow of the image composition processing according to the present fifth modification example. The flowchart shown in FIG. 24 is different from the flowchart shown in FIG. 6 in that it includes step ST250 to step ST268 instead of step ST12 to step ST30.

In the image composition processing shown in FIG. 24, in step ST250, the AI method processing unit 62A6 and the non-AI method processing unit 62B6 acquire the processing target image 75A6 from the image sensor 20. After the processing of step ST250 is executed, the image composition processing shifts to step ST252.

In step ST252, the AI method processing unit 62A6 inputs the processing target image 75A6 acquired in step ST250 to the generation model 82A6. After the processing of step ST252 is executed, the image composition processing shifts to step ST254.

In step ST254, the AI method processing unit 62A6 acquires the first edge emphasized image 86A6 output from the generation model 82A6 by inputting the processing target image 75A6 to the generation model 82A6 in step ST252. After the processing of step ST254 is executed, the image composition processing shifts to step ST256.

In step ST256, the non-AI method processing unit 62B6 emphasizes the edge region 112 in the processing target image 75A6 more than the non-edge region by performing the processing, which uses the digital filter 84A6, on the processing target image 75A6 acquired in step ST250. After the processing of step ST256 is executed, the image composition processing shifts to step ST258.

In step ST258, the non-AI method processing unit 62B6 acquires the second edge emphasized image 88A6 obtained by performing the processing, which uses the digital filter 84A6, on the processing target image 75A6 in step ST256. After the processing of step ST258 is executed, the image composition processing shifts to step ST260.

In step ST260, the image adjustment unit 62C6 acquires the first ratio 90F1 and the second ratio 90F2 from the NVM64. After the processing of step ST260 is executed, the image composition processing shifts to step ST262.

In step ST262, the image adjustment unit 62C6 adjusts the first edge emphasized image 86A6 by using the first ratio 90F1 acquired in step ST260. After the processing of step ST262 is executed, the image composition processing shifts to step ST264.

In step ST264, the image adjustment unit 62C6 adjusts the second edge emphasized image 88A6 by using the second ratio 90F2 acquired in step ST260. After the processing of step ST264 is executed, the image composition processing shifts to step ST266.

In step ST266, the composition unit 62D6 adjusts the excess and deficiency of the AI method processing performed by the AI method processing unit 62A6 by combining the first edge emphasized image 86A6 adjusted in step ST262 and the second edge emphasized image 88A6 adjusted in step ST264. The composite image 92F is generated by combining the first edge emphasized image 86A6 adjusted in step ST262 and the second edge emphasized image 88A6 adjusted in step ST264. After the processing of step ST266 is executed, the image composition processing shifts to step ST268.

In step ST268, the composition unit 62D6 performs various types of image processing on the composite image 92F. The composition unit 62D6 outputs an image obtained by performing various types of image processing on the composite image 92F to a default output destination as the processed image 75B. After the processing of step ST268 is executed, the image composition processing shifts to step ST32.

As described above, in the imaging apparatus 10 according to the present fifth modification example, the first edge emphasized image 86A6 is generated by emphasizing the edge region 112 in the processing target image 75A6 more than the non-edge region by using the AI method. Further, the second edge emphasized image 88A6 is generated by emphasizing the edge region 112 in the processing target image 75A6 more than the non-edge region by using the non-AI method. Thereafter, the first edge emphasized image 86A6 and the second edge emphasized image 88A6 are combined. As a result, it is possible to suppress the excess and deficiency of the intensity of the edge region 112 in a case of performing the AI method processing with respect to the composite image 92F. As a result, the composite image 92F becomes an image in which the intensity of the edge region 112 in a case of performing the AI method processing is less noticeable than that of the first edge emphasized image 86A6, and it is possible to provide a suitable image to a user who does not prefer the intensity of the edge region 112 in a case of performing the AI method processing to be excessively noticeable.

Here, although an example of the embodiment in which the first edge emphasized image 86A6 obtained by performing the processing, which uses the generation model 82A6, on the processing target image 75A6 and the second edge emphasized image 88A6 obtained by performing the processing, which uses the digital filter 84A6, on the processing target image 75A6 are combined has been described, the present disclosed technology is not limited to this. For example, the first edge emphasized image 86A6 obtained by performing the processing, which uses the generation model 82A6, on the processing target image 75A6 and the processing target image 75A6 (that is, an image in which the non-noise element is not adjusted) may be combined. In this case, the same effect can be expected.

### Sixth Modification Example

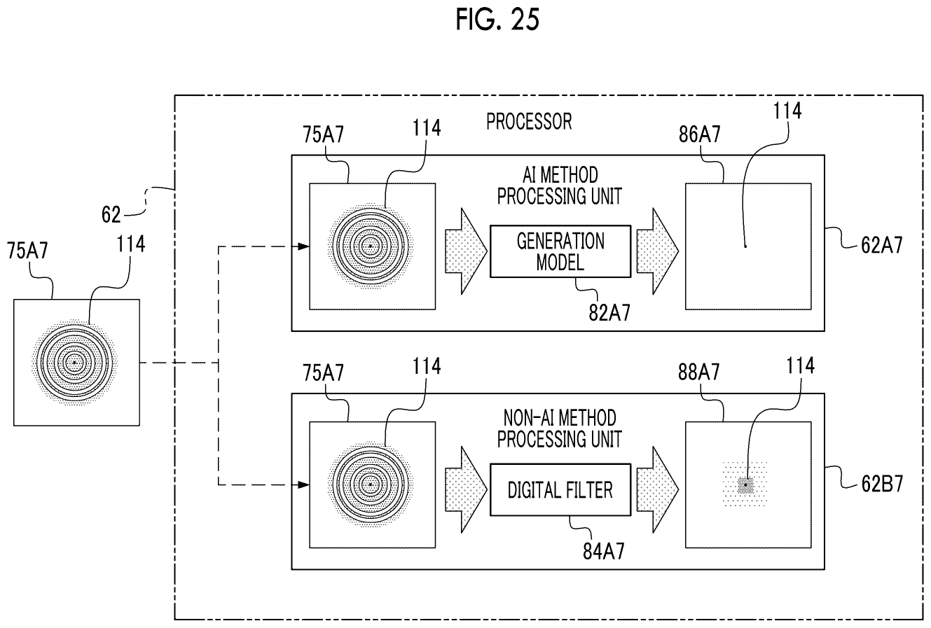

As an example shown in FIG. 25, the processor 62 according to the present sixth modification example differs from the processor 62 shown in FIG. 4 in that an AI method processing unit 62A7 is provided instead of the AI method processing unit 62A1, and in that a non-AI method processing unit 62B7 is provided instead of the non-AI method processing unit 62B1. In the present sixth modification example, the description of the same matters as those described before the sixth modification example will be omitted, and the matters different from the matters described before the sixth modification example will be described.

As an example shown in FIG. 25, a processing target image 75A7 is input to the AI method processing unit 62A7 and the non-AI method processing unit 62B7. The processing target image 75A7 is an example of the processing target image 75A shown in FIG. 2. In the example shown in FIG. 25, a point image 114 is included in the processing target image 75A7. The point image 114 is a subject image obtained by forming an image of subject light representing a point subject on a light-receiving surface 72A and appears in the processing target image 75A7 in a blurred state compared to the original subject image due to a point spread phenomenon derived from an optical characteristic of the imaging lens 40. A blurriness amount of the point image 114 is represented by a generally known point spread function.

The processing target image 75A7 is an image having the point image 114 as the non-noise element. The point image 114 is an example of a “non-noise element of the processing target image”, a “phenomenon that appears in the processing target image due to the characteristic of the imaging apparatus”, and a “blurriness” according to the present disclosed technology. The blurriness amount of the point image 114 is an example of a “blurriness amount of the point image” according to the present disclosed technology. The point spread phenomenon is an example of a “characteristic of the imaging apparatus” and an “optical characteristic of the imaging apparatus” according to the present disclosed technology.

The AI method processing unit 62A7 performs AI method processing on the processing target image 75A7. An example of the AI method processing on the processing target image 75A7 includes processing that uses the generation model 82A7. The generation model 82A7 is an example of the generation model 82A shown in FIG. 3. The generation model 82A7 is a generation network that has already been trained to adjust the blurriness amount of the point image 114. In the following, as the adjustment of the blurriness amount of the point image 114, a reduction of the blurriness amount of the point image 114 (that is, reduction of the point spreading) will be described as an example.

The AI method processing unit 62A7 generates a first point image adjusted image 86A7 by performing processing, which uses the generation model 82A7 on the processing target image 75A7. In other words, the AI method processing unit 62A7 generates the first point image adjusted image 86A7 by adjusting the non-noise element (here, as an example, the point image 114) in the processing target image 75A7 by using the AI method. In other words, the AI method processing unit 62A7 generates the first point image adjusted image 86A7 by reducing the blurriness amount of the point image 114 in the processing target image 75A7 by using the AI method. Here, the processing, which uses the generation model 82A7, is an example of “first AI processing”, “first correction processing”, and “point image adjustment processing” according to the present disclosed technology. Further, here, “generating the first point image adjusted image 86A7” is an example of “acquiring the first image” according to the present disclosed technology.

The processing target image 75A7 is input to the generation model 82A7. The generation model 82A7 generates and outputs the first point image adjusted image 86A7 based on the input processing target image 75A7. The first point image adjusted image 86A7 is an image obtained by adjusting the non-noise element by using the generation model 82A7 (that is, an image obtained by adjusting the non-noise element by the processing, which uses the generation model 82A7, with respect to the processing target image 75A7). In other words, the first point image adjusted image 86A7 is an image in which the non-noise element in the processing target image 75A7 is corrected by using the generation model 82A7 (that is, an image in which the non-noise element is corrected by performing the processing, which uses the generation model 82A7, with respect to the processing target image 75A7). Further, in other words, the first point image adjusted image 86A7 is an image in which the point spreading of the point image 114 is corrected by using the generation model 82A7 (that is, an image in which the point spreading of the point image 114 is corrected so as to be reduced by performing the processing, which uses the generation model 82A7, with respect to the processing target image 75A7). The first point image adjusted image 86A7 is an example of a “first image”, a “first corrected image”, and a “first point image adjusted image” according to the present disclosed technology.

The non-AI method processing unit 62B7 performs non-AI method processing on the processing target image 75A7. The non-AI method processing refers to processing that does not use a neural network. Here, examples of the processing that does not use the neural network include processing that does not use the generation model 82A7.

An example of the non-AI method processing on the processing target image 75A7 includes processing that uses the digital filter 84A7. The digital filter 84A7 is a digital filter configured such that the point spreading of the point image 114 is reduced. An example of the digital filter configured such that the point spreading of the point image 114 is reduced includes a resolution correction filter that offsets the point spreading indicated by the point spread function that represents the point image 114. The resolution correction filter is a filter applied to a visible light image that is more blurred state than the original visible light image due to the point spread phenomenon. An example of the resolution correction filter includes an FIR filter. Since the resolution correction filter is a known filter, further detailed description thereof will be omitted.

The non-AI method processing unit 62B7 generates a second point image adjusted image 88A7 by performing the processing (that is, filtering), which uses the digital filter 84A7, on the processing target image 75A7. In other words, the non-AI method processing unit 62B7 generates the second point image adjusted image 88A7 by adjusting the non-noise element in the processing target image 75A7 by using the non-AI method. In other words, the non-AI method processing unit 62B7 generates the second point image adjusted image 88A7 by correcting the processing target image 75A7 such that the point spreading in the processing target image 75A7 is reduced by using the non-AI method. Here, the processing, which uses the digital filter 84A7, is an example of “non-AI method processing that does not use a neural network”, “second correction processing”, and “processing of adjusting the blurriness amount by using the non-AI method” according to the present disclosed technology. Further, here, “generating the second point image adjusted image 88A7” is an example of “acquiring the second image” according to the present disclosed technology.

The processing target image 75A7 is input to the digital filter 84A7. The digital filter 84A7 generates the second point image adjusted image 88A7 based on the input processing target image 75A7. The second point image adjusted image 88A7 is an image obtained by adjusting the non-noise element by using the digital filter 84A7 (that is, an image obtained by adjusting the non-noise element by the processing, which uses the digital filter 84A7, with respect to the processing target image 75A7). In other words, the second point image adjusted image 88A7 is an image in which the non-noise element in the processing target image 75A7 is corrected by using the digital filter 84A7 (that is, an image in which the non-noise element is corrected by the processing, which uses the digital filter 84A7, with respect to the processing target image 75A7). Further, in other words, the second point image adjusted image 88A7 is an image in which the processing target image 75A7 is corrected by using the digital filter 84A7 (that is, an image in which the point spreading is corrected so as to be reduced by performing the processing, which uses the digital filter 84A7, with respect to the processing target image 75A7). The second point image adjusted image 88A7 is an example of a “second image”, a “second corrected image”, and a “second point image adjusted image” according to the present disclosed technology.

By the way, there is a user who does not completely eliminate the point spread phenomenon but rather wants to appropriately leave the point spread phenomenon in the image. In the example shown in FIG. 25, in the first point image adjusted image 86A7, the point spreading of the point image 114 is reduced more than that of the second point image adjusted image 88A7. In other words, the blurriness of the point image 114 remains in the second point image adjusted image 88A7 as compared with the first point image adjusted image 86A7. However, the user may feel that the blurriness amount of the point image 114 in the first point image adjusted image 86A7 is too insufficient and may feel that the blurriness amount of the point image 114 in the second point image adjusted image 88A7 is too large. Therefore, in a case where only one of the first point image adjusted image 86A7 or the second point image adjusted image 88A7 is finally output, an image that does not suit the user's preference is provided to the user. In a case where the performance of the generation model 82A7 is improved by increasing the amount of training for the generation model 82A7 or increasing the number of interlayers of the generation model 82A7, there is an increased possibility that an image close to the user's preference can be obtained. However, the cost required for creating the generation model 82A7 is high, and as a result, there is a possibility that the cost of the imaging apparatus 10 is increased.

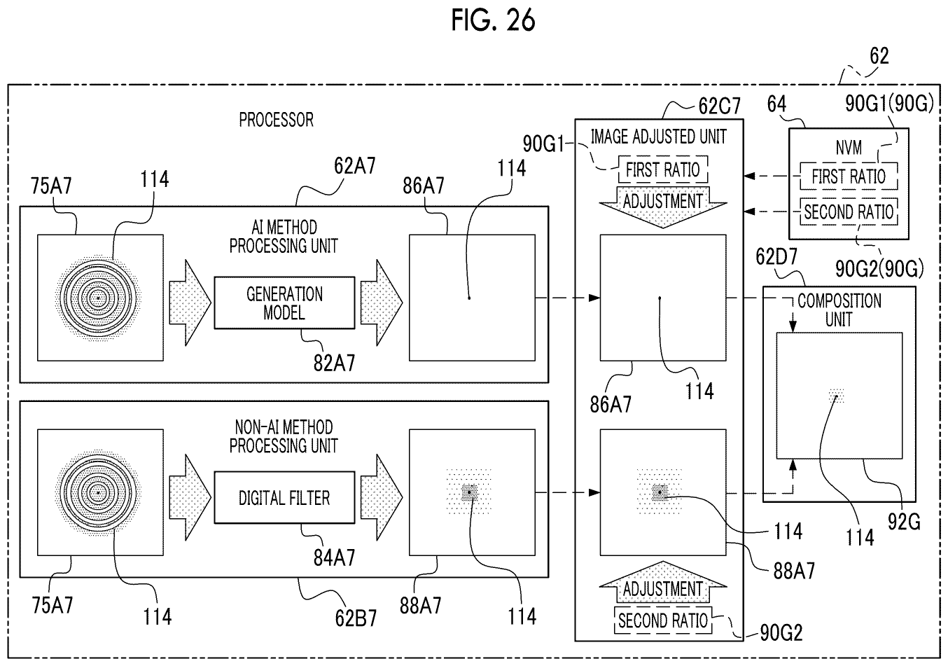

Therefore, in view of such circumstances, in the imaging apparatus 10, as an example shown in FIG. 26, by performing the processing of the image adjustment unit 62C7 and the processing of the composition unit 62D7 on the first point image adjusted image 86A7 and the second point image adjusted image 88A7, the first point image adjusted image 86A7 and the second point image adjusted image 88A7 are combined.

As an example shown in FIG. 26, a ratio 90G is stored in the NVM 64. The ratio 90G is a ratio for combining the first point image adjusted image 86A7 and the second point image adjusted image 88A7 and is defined to adjust excess and deficiency of the AI method processing (that is, the processing that uses the generation model 82A7) performed by the AI method processing unit 62A7.

The ratio 90G is roughly classified into a first ratio 90G1 and a second ratio 90G2. The first ratio 90G1 is a value of 0 or more and 1 or less, and the second ratio 90G2 is a value obtained by subtracting the value of the first ratio 90G1 from “1”. That is, the first ratio 90G1 and the second ratio 90G2 are defined such that the sum of the first ratio 90G1 and the second ratio 90G2 is “1”. The first ratio 90G1 and the second ratio 90G2 are variable values that are changed by an instruction from the user.

The image adjustment unit 62C7 adjusts the first point image adjusted image 86A7 generated by the AI method processing unit 62A7 by using the first ratio 90G1. For example, the image adjustment unit 62C7 adjusts a pixel value of each pixel of the first point image adjusted image 86A7 by multiplying a pixel value of each pixel of the first point image adjusted image 86A7 by the first ratio 90G1.

The image adjustment unit 62C7 adjusts the second point image adjusted image 88A7 generated by the non-AI method processing unit 62B7 by using the second ratio 90G2. For example, the image adjustment unit 62C7 adjusts a pixel value of each pixel of the second point image adjusted image 88A7 by multiplying a pixel value of each pixel of the second point image adjusted image 88A7 by the second ratio 90G2.

The composition unit 62D7 generates a composite image 92G by combining the first point image adjusted image 86A7 adjusted at the first ratio 90G1 by the image adjustment unit 62C7 and the second point image adjusted image 88A7 adjusted at the second ratio 90G2 by the image adjustment unit 62C7. That is, the composition unit 62D7 adjusts the excess and deficiency of the AI method processing performed by the AI method processing unit 62A7 by combining the first point image adjusted image 86A7 adjusted at the first ratio 90G1 and the second point image adjusted image 88A7 adjusted at the second ratio 90G2. In other words, the composition unit 62D7 adjusts the non-noise element by combining the first point image adjusted image 86A7 adjusted at the first ratio 90G1 and the second point image adjusted image 88A7 adjusted at the second ratio 90G2. Further, in other words, the composition unit 62D7 adjusts an element derived from the processing that uses the generation model 82A7 (for example, the pixel value of the pixel of which the point spreading is reduced by using the generation model 82A7) by combining the first point image adjusted image 86A7 adjusted at the first ratio 90G1 and the second point image adjusted image 88A7 adjusted at the second ratio 90G2.

The composition, which is performed by the composition unit 62D7, is an addition of a pixel value of a corresponding pixel position between the first point image adjusted image 86A7 and the second point image adjusted image 88A7. The composition, which is performed by the composition unit 62D7, is performed in the same manner as the composition, which is performed by the composition unit 62D1 shown in FIG. 5. Further, various types of image processing are also performed on the composite image 92G by the composition unit 62D7 in the same manner as on the composite image 92A shown in FIG. 5. The composite image 92G in which various types of image processing are performed, is output to a default output destination by the composition unit 62D7.

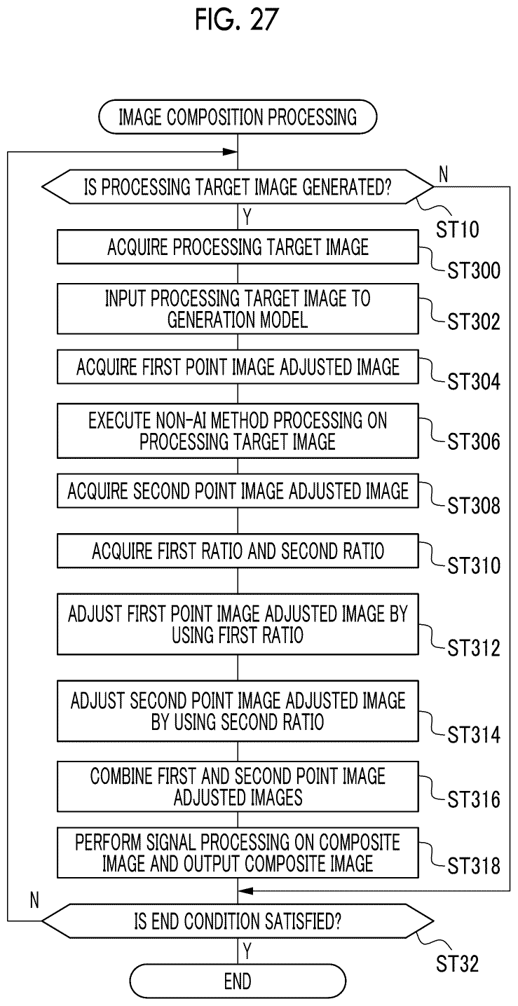

FIG. 27 shows an example of a flow of the image composition processing according to the present sixth modification example. The flowchart shown in FIG. 27 is different from the flowchart shown in FIG. 6 in that it includes step ST300 to step ST318 instead of step ST12 to step ST30.

In the image composition processing shown in FIG. 27, in step ST300, the AI method processing unit 62A7 and the non-AI method processing unit 62B7 acquire the processing target image 75A7 from the image sensor 20. After the processing of step ST300 is executed, the image composition processing shifts to step ST302.

In step ST302, the AI method processing unit 62A7 inputs the processing target image 75A7 acquired in step ST300 to the generation model 82A7. After the processing of step ST302 is executed, the image composition processing shifts to step ST304.

In step ST304, the AI method processing unit 62A7 acquires the first point image adjusted image 86A7 output from the generation model 82A7 by inputting the processing target image 75A7 to the generation model 82A7 in step ST302. After the processing of step ST304 is executed, the image composition processing shifts to step ST306.

In step ST306, the non-AI method processing unit 62B7 corrects the point spreading phenomenon of the processing target image 75A7 by performing the processing, which uses the digital filter 84A7, on the processing target image 75A7 acquired in step ST300. After the processing of step ST306 is executed, the image composition processing shifts to step ST308.

In step ST308, the non-AI method processing unit 62B7 acquires the second point image adjusted image 88A7 obtained by performing the processing, which uses the digital filter 84A7, on the processing target image 75A7 in step ST306. After the processing of step ST308 is executed, the image composition processing shifts to step ST310.

In step ST310, the image adjustment unit 62C7 acquires the first ratio 90G1 and the second ratio 90G2 from the NVM64. After the processing of step ST310 is executed, the image composition processing shifts to step ST312.

In step ST312, the image adjustment unit 62C7 adjusts the first point image adjusted image 86A7 by using the first ratio 90G1 acquired in step ST310. After the processing of step ST312 is executed, the image composition processing shifts to step ST314.

In step ST314, the image adjustment unit 62C7 adjusts the second point image adjusted image 88A7 by using the second ratio 90G2 acquired in step ST310. After the processing of step ST314 is executed, the image composition processing shifts to step ST316.

In step ST316, the composition unit 62D7 adjusts the excess and deficiency of the AI method processing performed by the AI method processing unit 62A7 by combining the first point image adjusted image 86A7 adjusted in step ST312 and the second point image adjusted image 88A7 adjusted in step ST314. The composite image 92G is generated by combining the first point image adjusted image 86A7 adjusted in step ST312 and the second point image adjusted image 88A7 adjusted in step ST314. After the processing of step ST316 is executed, the image composition processing shifts to step ST318.

In step ST318, the composition unit 62D7 performs various types of image processing on the composite image 92G The composition unit 62D7 outputs an image obtained by performing various types of image processing on the composite image 92G to a default output destination as the processed image 75B. After the processing of step ST318 is executed, the image composition processing shifts to step ST32.

As described above, in the imaging apparatus 10 according to the present sixth modification example, the first point image adjusted image 86A7 is generated by reducing the point spreading of the point image 114 in the processing target image 75A7 by using the AI method. Further, the second point image adjusted image 88A7 is generated by reducing the point spreading of the point image 114 in the processing target image 75A7 by the non-AI method. Thereafter, the first point image adjusted image 86A7 and the second point image adjusted image 88A7 are combined. As a result, it is possible to suppress the excess and deficiency of the correction amount of the point spread phenomenon (that is, the correction amount of the blurriness amount of the point image 114) in a case of performing the AI method processing with respect to the composite image 92G As a result, the composite image 92G becomes an image in which the correction amount of the point spread phenomenon in a case of performing the AI method processing is less noticeable than that of the first point image adjusted image 86A7, and it is possible to provide a suitable image to a user who does not prefer the correction amount of the point spread phenomenon in a case of performing the AI method processing to be excessively noticeable.

Here, although an example of the embodiment in which the first point image adjusted image 86A7 obtained by performing the processing, which uses the generation model 82A7, on the processing target image 75A7 and the second point image adjusted image 88A7 obtained by performing the processing, which uses the digital filter 84A7, on the processing target image 75A7 are combined has been described, the present disclosed technology is not limited to this. For example, the first point image adjusted image 86A7 obtained by performing the processing, which uses the generation model 82A7, on the processing target image 75A7 and the processing target image 75A7 (that is, an image in which the non-noise element is not adjusted) may be combined. In this case, the same effect can be expected.

### Seventh Modification Example

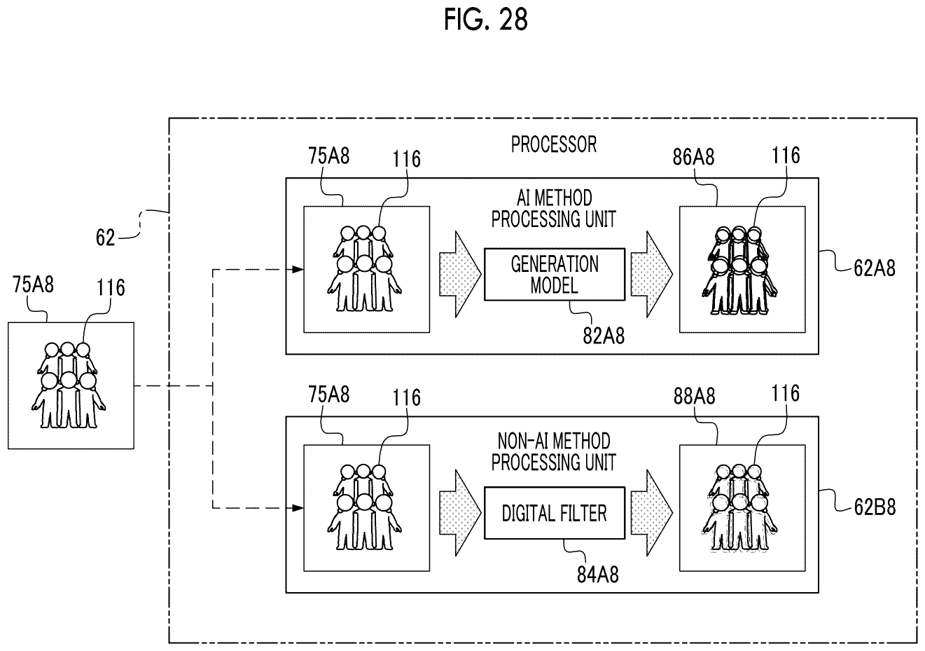

As an example shown in FIG. 28, the processor 62 according to the present seventh modification example differs from the processor 62 shown in FIG. 4 in that an AI method processing unit 62A8 is provided instead of the AI method processing unit 62A1, and in that a non-AI method processing unit 62B8 is provided instead of the non-AI method processing unit 62B1. In the present seventh modification example, the description of the same matters as those described before the seventh modification example will be omitted, and the matters different from the matters described before the seventh modification example will be described.

The processing target image 75A8 is input to the AI method processing unit 62A8 and the non-AI method processing unit 62B8. The processing target image 75A8 is an example of the processing target image 75A shown in FIG. 2. The processing target image 75A8 is a chromatic image and has a person region 116. The person region 116 is an image region where a person is captured. Although a chromatic image is exemplified here as the processing target image 75A8, the processing target image 75A8 may be an achromatic image.

The AI method processing unit 62A8 and the non-AI method processing unit 62B8 perform processing of applying the blurriness, which is determined in accordance with the subject that is captured in the input processing target image 75A8, to the processing target image 75A8. In the present seventh modification example, the subject captured in the processing target image 75A8 refers to a person. The person captured in the processing target image 75A8 is an example of a “third subject” according to the present disclosed technology. The blurriness, which is determined in accordance with the subject, is an example of a “non-noise element of the processing target image”, a “factor that controls a visual impression given from the processing target image”, and a “blurriness that is determined in accordance with the third subject” according to the present disclosed technology.

The AI method processing unit 62A8 performs AI method processing on the processing target image 75A8. An example of the AI method processing on the processing target image 75A8 includes processing that uses the generation model 82A8. The generation model 82A8 is an example of the generation model 82A shown in FIG. 3. The generation model 82A8 is a generation network that has already been trained to apply the blurriness to the person region 116.

The AI method processing unit 62A8 changes the factor that controls the visual impression given from the processing target image 75A8 by using the AI method. That is, the AI method processing unit 62A8 changes the factor that controls the visual impression given from the processing target image 75A8 as the non-noise element of the processing target image 75A8 by performing the processing, which uses the generation model 82A8, on the processing target image 75A8. The factor that controls the visual impression given from the processing target image 75A8 is the blurriness that is determined in accordance with the person region 116 in the processing target image 75A8. In the example shown in FIG. 28, the AI method processing unit 62A8 generates a first blurred image 86A8 by performing the processing, which uses the generation model 82A8, on the processing target image 75A8. The first blurred image 86A8 is an image in which the blurriness is applied to the person region 116 in the processing target image 75A8 by using the AI method.

Here, the processing, which uses the generation model 82A8, is an example of “first AI processing”, “first change processing”, and “blur processing” according to the present disclosed technology. The first blurred image 86A8 is an example of a “first changed image” and a “first blurred image” according to the present disclosed technology. “Generating the first blurred image 86A8” is an example of “acquiring the first image” according to the present disclosed technology.

The processing target image 75A8 is input to the generation model 82A8. The generation model 82A8 generates and outputs the first blurred image 86A8 based on the input processing target image 75A8.

The non-AI method processing unit 62B8 performs non-AI method processing on the processing target image 75A8. The non-AI method processing refers to processing that does not use a neural network. In the present seventh modification example, examples of the processing that does not use the neural network include processing that does not use the generation model 82A8.

An example of the non-AI method processing on the processing target image 75A8 includes processing that uses the digital filter 84A8. The digital filter 84A8 is a digital filter configured to apply the blurriness to the person region 116 in the processing target image 75A8.

The non-AI method processing unit 62B8 generates a second blurred image 88A8 by performing the processing (that is, filtering), which uses the digital filter 84A8, on the processing target image 75A8. In other words, the non-AI method processing unit 62B8 generates the second blurred image 88A8 by changing the non-noise element of the processing target image 75A8 by using the non-AI method. In other words, the non-AI method processing unit 62B8 generates the second blurred image 88A8 by applying the blurriness to the person region 116 in the processing target image 75A8 by using the non-AI method.

Here, the processing, which uses the digital filter 84A8, is an example of “non-AI method processing that does not use a neural network” and “second change processing of changing the factor by using the non-AI method” according to the present disclosed technology. “Generating a second blurred image 88A8” is an example of “acquiring a second image” according to the present disclosed technology.

The processing target image 75A8 is input to the digital filter 84A8. The digital filter 84A8 generates the second blurred image 88A8 based on the input processing target image 75A8. The second blurred image 88A8 is an image obtained by changing the non-noise element by using the digital filter 84A8 (that is, an image obtained by changing the non-noise element by the processing, which uses the digital filter 84A8, with respect to the processing target image 75A8). In other words, the second blurred image 88A8 is an image in which the person region 116 in the processing target image 75A8 is adjusted by using the digital filter 84A8 (that is, an image in which the blurriness is applied to the person region 116 by the processing, which uses the digital filter 84A8, with respect to the processing target image 75A8). A blurriness degree applied to the person region 116 in the second blurred image 88A8 is smaller than a blurriness degree applied to the person region 116 in the first blurred image 86A8. The second blurred image 88A8 is an example of a “second image”, a “second changed image”, and a “second blurred image” according to the present disclosed technology.

By the way, the blurriness amount of the first blurred image 86A8, which is obtained by performing the AI method processing on the processing target image 75A8, may be a blurriness amount different from the user's preference due to the characteristic of the generation model 82A8 (for example, the number of interlayers and/or the amount of training, or the like). In a case where the influence of the AI method processing is excessively reflected on the processing target image 75A8, it is conceivable that the blurriness amount is too high or too low than the user's preference.

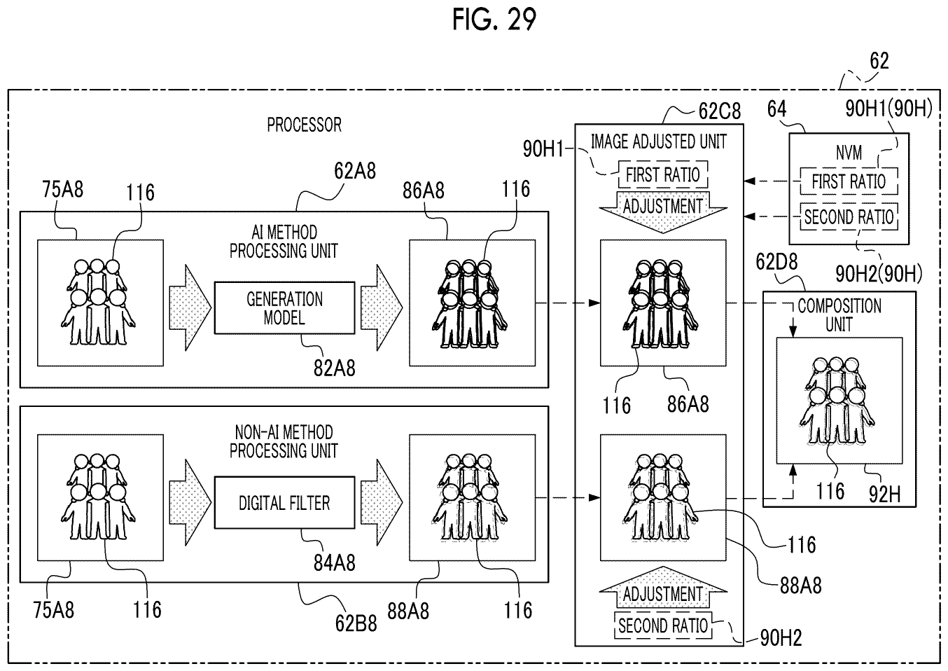

Therefore, in view of such circumstances, in the imaging apparatus 10, as an example shown in FIG. 29, by performing the processing of the image adjustment unit 62C8 and the processing of the composition unit 62D8 on the first blurred image 86A8 and the second blurred image 88A8, the first blurred image 86A8 and the second blurred image 88A8 are combined.

As an example shown in FIG. 29, a ratio 90H is stored in the NVM 64. The ratio 90H is a ratio for combining the first blurred image 86A8 and the second blurred image 88A8 and is defined to adjust excess and deficiency of the AI method processing (that is, the processing that uses the generation model 82A8) performed by the AI method processing unit 62A8.

The ratio 90H is roughly classified into a first ratio 90H1 and a second ratio 90H2. The first ratio 90H1 is a value of 0 or more and 1 or less, and the second ratio 90H2 is a value obtained by subtracting the value of the first ratio 90H1 from “1”. That is, the first ratio 90H1 and the second ratio 90H2 are defined such that the sum of the first ratio 90H1 and the second ratio 90H2 is “1”. The first ratio 90H1 and the second ratio 90H2 are variable values that are changed by an instruction from the user.

The image adjustment unit 62C8 adjusts the first blurred image 86A8 generated by the AI method processing unit 62A8 by using the first ratio 90H1. For example, the image adjustment unit 62C8 adjusts a pixel value of each pixel of the first blurred image 86A8 by multiplying a pixel value of each pixel of the first blurred image 86A8 by the first ratio 90H1.

The image adjustment unit 62C8 adjusts the second blurred image 88A8 generated by the non-AI method processing unit 62B8 by using the second ratio 90H2. For example, the image adjustment unit 62C8 adjusts a pixel value of each pixel of the second blurred image 88A8 by multiplying a pixel value of each pixel of the second blurred image 88A8 by the second ratio 90H2.

The composition unit 62D8 generates a composite image 92H by combining the first blurred image 86A8 adjusted at the first ratio 90H1 by the image adjustment unit 62C8 and the second blurred image 88A8 adjusted at the second ratio 90H2 by the image adjustment unit 62C8. That is, the composition unit 62D8 adjusts the excess and deficiency of the AI method processing performed by the AI method processing unit 62A8 by combining the first blurred image 86A8 adjusted at the first ratio 90H1 and the second blurred image 88A8 adjusted at the second ratio 90H2. In other words, the composition unit 62D8 adjusts the non-noise element by combining the first blurred image 86A8 adjusted at the first ratio 90H1 and the second blurred image 88A8 adjusted at the second ratio 90H2. Further, in other words, the composition unit 62D8 adjusts an element derived from the processing that uses the generation model 82A8 (for example, the pixel value of the pixel of which the blurriness is applied by using the generation model 82A8) by combining the first blurred image 86A8 adjusted at the first ratio 90H1 and the second blurred image 88A8 adjusted at the second ratio 90H2.

The composition, which is performed by the composition unit 62D8, is an addition of a pixel value of a corresponding pixel position between the first blurred image 86A8 and the second blurred image 88A8. The composition, which is performed by the composition unit 62D8, is performed in the same manner as the composition, which is performed by the composition unit 62D1 shown in FIG. 5. Further, various types of image processing are also performed on the composite image 92H by the composition unit 62D8 in the same manner as on the composite image 92A shown in FIG. 5. The composite image 92H, in which various types of image processing are performed, is output to a default output destination by the composition unit 62D8.

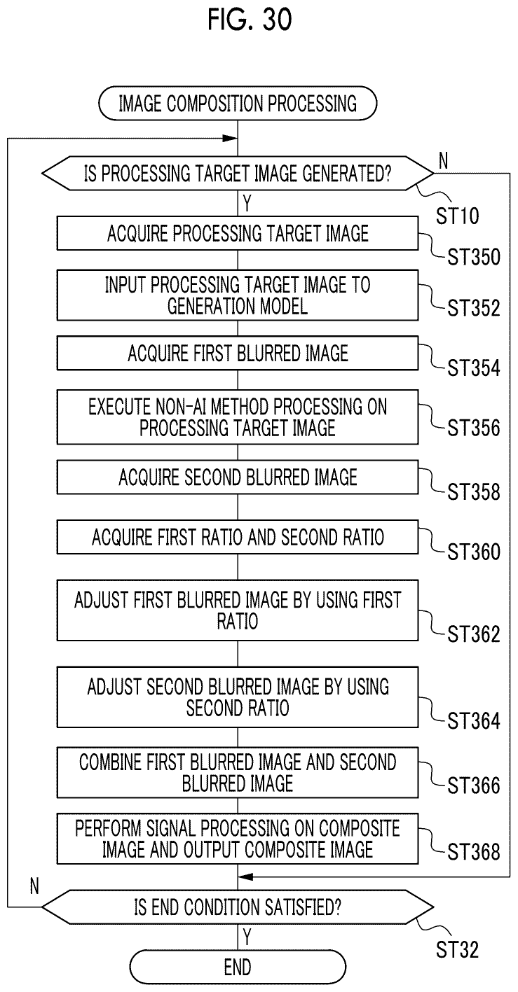

FIG. 30 shows an example of a flow of the image composition processing according to the present seventh modification example. The flowchart shown in FIG. 30 is different from the flowchart shown in FIG. 6 in that it includes step ST350 to step ST368 instead of step ST12 to step ST30.

In the image composition processing shown in FIG. 30, in step ST350, the AI method processing unit 62A8 and the non-AI method processing unit 62B8 acquire the processing target image 75A8 from the image sensor 20. After the processing of step ST350 is executed, the image composition processing shifts to step ST352.

In step ST352, the AI method processing unit 62A8 inputs the processing target image 75A8 acquired in step ST350 into the generation model 82A8. After the processing of step ST352 is executed, the image composition processing shifts to step ST354.

In step ST354, the AI method processing unit 62A8 acquires the first blurred image 86A8 output from the generation model 82A8 by inputting the processing target image 75A8 to the generation model 82A8 in step ST352. After the processing of step ST354 is executed, the image composition processing shifts to step ST356.

In step ST356, the non-AI method processing unit 62B8 applies the blurriness to the person region 116 in the processing target image 75A8 by performing the processing, which uses the digital filter 84A8, on the processing target image 75A8 acquired in step ST350. After the processing of step ST356 is executed, the image composition processing shifts to step ST358.

In the processing of step ST352 and the processing of step ST356, although an example in which the blurriness is applied to the person region 116 is exemplified, this is only an example, and the blurriness, which is determined according to the person region 116, may also be applied to an image region other than the person region 116. The blurriness, which is determined according to the person region 116, may be applied to the image region other than the person region 116 without applying the blurriness to the person region 116. Further, although the person region 116 is illustrated here, this is only an example, and an image region may be used where a subject (for example, a specific vehicle, a specific plant, a specific animal, a specific building, a specific aircraft, or the like) other than a person is captured. In this case as well, the blurriness, which is determined in accordance with the subject, may be applied to the image in the same manner.

In step ST358, the non-AI method processing unit 62B8 acquires the second blurred image 88A8 obtained by performing the processing, which uses the digital filter 84A8, on the processing target image 75A8 in step ST356. After the processing of step ST358 is executed, the image composition processing shifts to step ST360.

In step ST360, the image adjustment unit 62C8 acquires the first ratio 90H1 and the second ratio 90H2 from the NVM64. After the processing of step ST360 is executed, the image composition processing shifts to step ST362.

In step ST362, the image adjustment unit 62C8 adjusts the first blurred image 86A8 by using the first ratio 90H1 acquired in step ST360. After the processing of step ST362 is executed, the image composition processing shifts to step ST364.

In step ST364, the image adjustment unit 62C8 adjusts the second blurred image 88A8 by using the second ratio 90H2 acquired in step ST360. After the processing of step ST364 is executed, the image composition processing shifts to step ST366.

In step ST366, the composition unit 62D8 adjusts the excess and deficiency of the AI method processing performed by the AI method processing unit 62A8 by combining the first blurred image 86A8 adjusted in step ST362 and the second blurred image 88A8 adjusted in step ST364. The composite image 92H is generated by combining the first blurred image 86A8 adjusted in step ST362 and the second blurred image 88A8 adjusted in step ST364. After the processing of step ST366 is executed, the image composition processing shifts to step ST368.

In step ST368, the composition unit 62D8 performs various types of image processing on the composite image 92H. The composition unit 62D8 outputs an image obtained by performing various types of image processing on the composite image 92H to a default output destination as the processed image 75B. After the processing of step ST368 is executed, the image composition processing shifts to step ST32.

As described above, in the imaging apparatus 10 according to the present seventh modification example, the first blurred image 86A8 is generated by applying the blurriness, which is determined in accordance with the person region 116, to the person region 116 in the processing target image 75A8 by using the AI method. Further, the second blurred image 88A8 is generated by applying the blurriness, which is determined in accordance with the person region 116, to the person region 116 in the processing target image 75A8 by using the non-AI method. Thereafter, the first blurred image 86A8 and the second blurred image 88A8 are combined. As a result, it is possible to suppress the excess and deficiency of the blurriness, which is determined in accordance with the person region 116, in a case of performing the AI method processing with respect to the composite image 92H. As a result, the composite image 92H becomes an image in which the blurriness, which is determined in accordance with the person region 116, in a case of performing the AI method processing is less noticeable than in the first blurred image 86A8, and it is possible to provide a suitable image to a user who does not prefer the blurriness in the first blurred image 86A8 in a case of performing the AI method processing to be excessively noticeable.

Here, although an example of the embodiment in which the first blurred image 86A8 obtained by performing the processing, which uses the generation model 82A8, on the processing target image 75A8 and the second blurred image 88A8 obtained by performing the processing, which uses the digital filter 84A8, on the processing target image 75A8 are combined has been described, the present disclosed technology is not limited to this. For example, the first blurred image 86A8 obtained by performing the processing, which uses the generation model 82A8, on the processing target image 75A8 and the processing target image (that is, an image in which the non-noise element is not adjusted) may be combined. In this case, the same effect can be expected.

### Eighth Modification Example

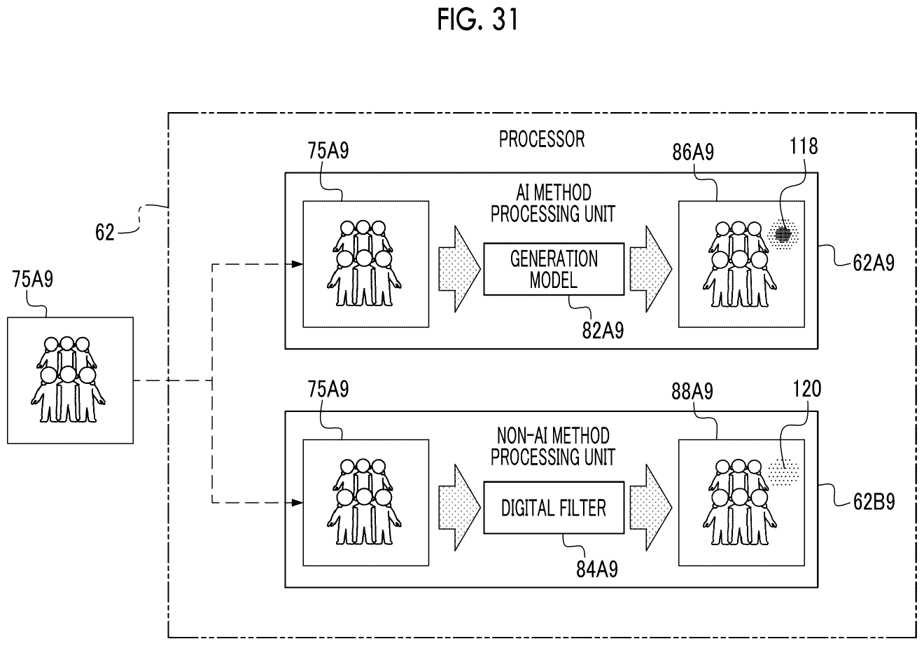

As an example shown in FIG. 31, the processor 62 according to the present eighth modification example differs from the processor 62 shown in FIG. 4 in that an AI method processing unit 62A9 is provided instead of the AI method processing unit 62A1, and in that a non-AI method processing unit 62B9 is provided instead of the non-AI method processing unit 62B1. In the present eighth modification example, the description of the same matters as those described before the eighth modification example will be omitted, and the matters different from the matters described before the eighth modification example will be described.

The processing target image 75A9 is input to the AI method processing unit 62A9 and the non-AI method processing unit 62B9. The processing target image 75A9 is an example of the processing target image 75A shown in FIG. 2. The processing target image 75A9 is a chromatic image. Although a chromatic image is exemplified here as the processing target image 75A9, the processing target image 75A9 may be an achromatic image.

The AI method processing unit 62A9 and the non-AI method processing unit 62B9 perform processing of applying a round blurriness to the input processing target image 75A9. The round blurriness, which is applied to the processing target image 75A9, is an example of a “non-noise element of the processing target image”, a “factor that controls a visual impression given from the processing target image”, a “first round blurriness”, and a “second round blurriness” according to the present disclosed technology.

The AI method processing unit 62A9 performs AI method processing on the processing target image 75A9. An example of the AI method processing on the processing target image 75A9 includes processing that uses the generation model 82A9. The generation model 82A9 is an example of the generation model 82A shown in FIG. 3. The generation model 82A9 is a generation network that has already been trained to apply the round blurriness to the processing target image 75A9.

The AI method processing unit 62A9 changes the factor that controls the visual impression given from the processing target image 75A9 by using the AI method. That is, the AI method processing unit 62A9 changes the factor that controls the visual impression given from the processing target image 75A9 as the non-noise element of the processing target image 75A9 by performing the processing, which uses the generation model 82A9, on the processing target image 75A9. The factor that controls the visual impression given from the processing target image 75A9 is the round blurriness that is applied to the processing target image 75A9. In the example shown in FIG. 31, the AI method processing unit 62A9 generates a first round blurriness image 86A9 by performing the processing, which uses the generation model 82A9, on the processing target image 75A9. The first round blurriness image 86A9 is an image in which a first round blurriness 118 is applied to the processing target image 75A9 by using the AI method.

Here, the processing, which uses the generation model 82A8, is an example of “first AI processing”, “first change processing”, and “round blurriness processing” according to the present disclosed technology. The first round blurriness 118 is an example of a “first round blurriness” according to the present disclosed technology. The first round blurriness image 86A9 is an example of a “first changed image” and a “first round blurriness image” according to the present disclosed technology. “Generating the first round blurriness image 86A9” is an example of “acquiring the first image” according to the present disclosed technology.

The processing target image 75A9 is input to the generation model 82A9. The generation model 82A9 generates and outputs the first round blurriness image 86A9 based on the input processing target image 75A9.

The non-AI method processing unit 62B9 performs non-AI method processing on the processing target image 75A9. The non-AI method processing refers to processing that does not use a neural network. In the present eighth modification example, examples of the processing that does not use the neural network include processing that does not use the generation model 82A9.

An example of the non-AI method processing on the processing target image 75A9 includes processing that uses the digital filter 84A9. The digital filter 84A9 is a digital filter configured to apply the round blurriness to the processing target image 75A9.

The non-AI method processing unit 62B9 generates a second round blurriness image 88A9 by performing the processing (that is, filtering), which uses the digital filter 84A9, on the processing target image 75A9. In other words, the non-AI method processing unit 62B9 generates the second round blurriness image 88A9 by changing the non-noise element of the processing target image 75A9 by using the non-AI method. Further, in other words, the non-AI method processing unit 62B9 generates the second round blurriness image 88A9 by applying a second round blurriness 120 in the processing target image 75A9 by using the non-AI method.

Here, the processing, which uses the digital filter 84A9, is an example of “non-AI method processing that does not use a neural network” and “second change processing of changing the factor by using the non-AI method” according to the present disclosed technology. “Generating the second round blurriness image 88A9” is an example of “acquiring a second image” according to the present disclosed technology.

The processing target image 75A9 is input to the digital filter 84A9. The digital filter 84A9 generates the second round blurriness image 88A9 based on the input processing target image 75A9. The second round blurriness image 88A9 is an image obtained by changing the non-noise element by using the digital filter 84A9 (that is, an image obtained by changing the non-noise element by the processing, which uses the digital filter 84A9, with respect to the processing target image 75A9). In other words, the second round blurriness image 88A9 is an image in which the second round blurriness 120 is applied to the processing target image 75A9 (that is, an image in which the second round blurriness 120 is applied by the processing, which uses the digital filter 84A9, with respect to the processing target image 75A9). The characteristic (for example, color, sharpness, size, and/or the like) of the second round blurriness 120 is different from the characteristic of the first round blurriness 118. The second round blurriness image 88A9 is an example of a “second image”, a “second changed image”, and a “second round blurriness image” according to the present disclosed technology.

By the way, the characteristic of the first round blurriness image 86A9, which is obtained by performing the AI method processing on the processing target image 75A9, may be a characteristic different from the user's preference due to the characteristic of the generation model 82A9 (for example, the number of interlayers and/or the amount of training, or the like). In a case where the influence of the AI method processing is excessively reflected on the processing target image 75A9, it is conceivable that the round blurriness in the user's preference is not represented.

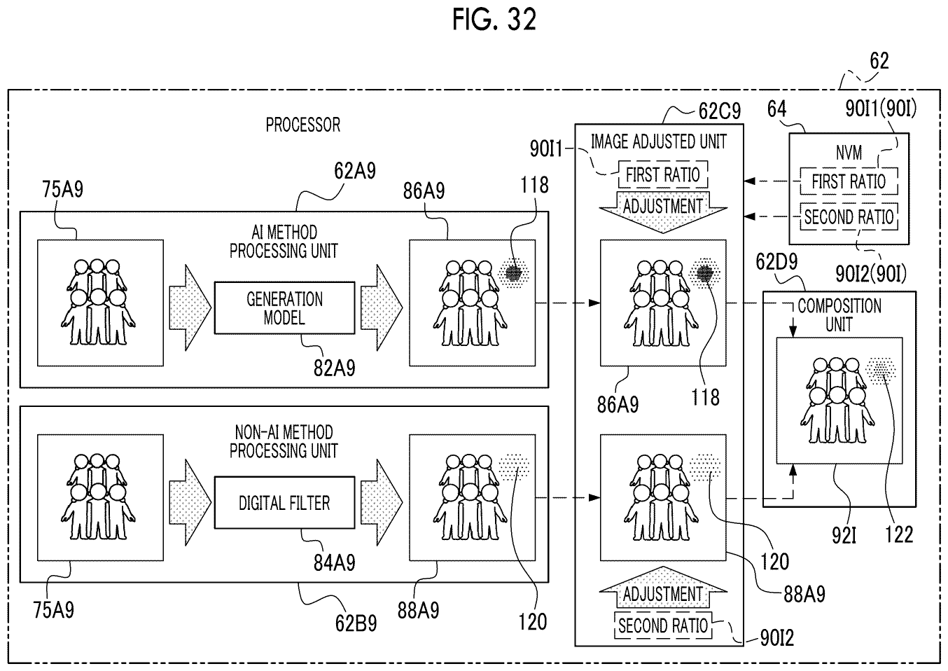

Therefore, in view of such circumstances, in the imaging apparatus 10, as an example shown in FIG. 32, by performing the processing of the image adjustment unit 62C9 and the processing of the composition unit 62D9 on the first round blurriness image 86A9 and the second round blurriness image 88A9, the first round blurriness image 86A9 and the second round blurriness image 88A9 are combined.

As an example shown in FIG. 32, a ratio 90I is stored in the NVM 64. The ratio 90I is a ratio for combining the first round blurriness image 86A9 and the second round blurriness image 88A9 and is defined to adjust excess and deficiency of the AI method processing (that is, the processing that uses the generation model 82A9) performed by the AI method processing unit 62A9.

The ratio 90I is roughly classified into a first ratio 90I1 and a second ratio 90I2. The first ratio 90I1 is a value of 0 or more and 1 or less, and the second ratio 90I2 is a value obtained by subtracting the value of the first ratio 90I1 from “1”. That is, the first ratio 90I1 and the second ratio 90I2 are defined such that the sum of the first ratio 90I1 and the second ratio 90I2 is “1”. The first ratio 90I1 and the second ratio 90I2 are variable values that are changed by an instruction from the user.

The image adjustment unit 62C9 adjusts the first round blurriness image 86A9 generated by the AI method processing unit 62A9 by using the first ratio 90I1. For example, the image adjustment unit 62C9 adjusts a pixel value of each pixel of the first round blurriness image 86A9 by multiplying a pixel value of each pixel of the first round blurriness image 86A9 by the first ratio 90I1.

The image adjustment unit 62C9 adjusts the second round blurriness image 88A9 generated by the non-AI method processing unit 62B9 by using the second ratio 90I2. For example, the image adjustment unit 62C9 adjusts a pixel value of each pixel of the second round blurriness image 88A9 by multiplying a pixel value of each pixel of the second round blurriness image 88A9 by the second ratio 90I2.

The composition unit 62D9 generates a composite image 92I by combining the first round blurriness image 86A9 adjusted at the first ratio 90I1 by the image adjustment unit 62C9 and the second round blurriness image 88A9 adjusted at the second ratio 90I2 by the image adjustment unit 62C9. That is, the composition unit 62D9 adjusts the excess and deficiency of the AI method processing performed by the AI method processing unit 62A9 by combining the first round blurriness image 86A9 adjusted at the first ratio 90I1 and the second round blurriness image 88A9 adjusted at the second ratio 90I2. In other words, the composition unit 62D9 adjusts the non-noise element by combining the first round blurriness image 86A9 adjusted at the first ratio 90I1 and the second round blurriness image 88A9 adjusted at the second ratio 90I2. Further, in other words, the composition unit 62D9 adjusts an element derived from the processing that uses the generation model 82A9 (for example, the pixel value of the pixel of which the first round blurriness 118 is applied by using the generation model 82A9) by combining the first round blurriness image 86A9 adjusted at the first ratio 90I1 and the second round blurriness image 88A9 adjusted at the second ratio 90I2.

The composition, which is performed by the composition unit 62D9, is an addition of a pixel value of a corresponding pixel position between the first round blurriness image 86A9 and the second round blurriness image 88A9. The composition, which is performed by the composition unit 62D9, is performed in the same manner as the composition, which is performed by the composition unit 62D1 shown in FIG. 5. Further, various types of image processing are also performed on the composite image 92I by the composition unit 62D9 in the same manner as on the composite image 92A shown in FIG. 5. The composite image 92I, in which various types of image processing are performed, is output to a default output destination by the composition unit 62D9.

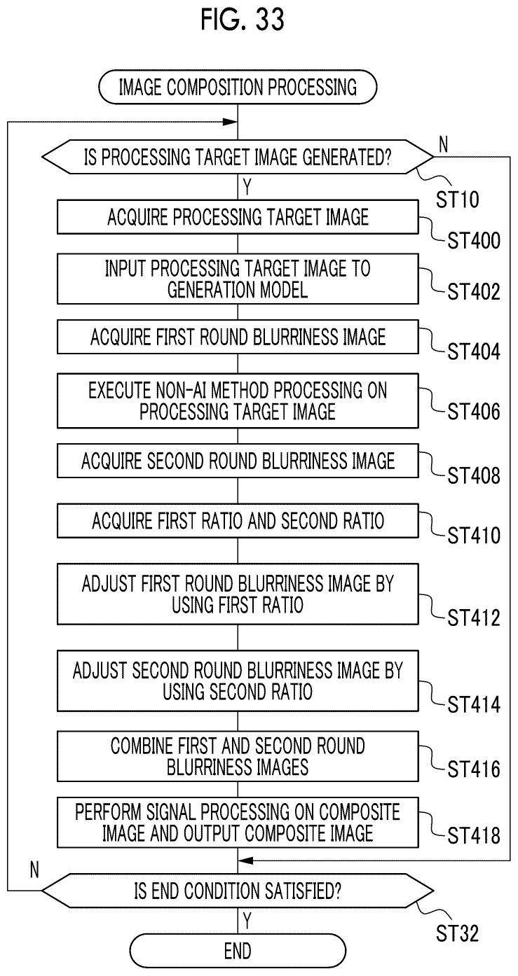

FIG. 33 shows an example of a flow of the image composition processing according to the present eighth modification example. The flowchart shown in FIG. 33 is different from the flowchart shown in FIG. 6 in that it includes step ST400 to step ST418 instead of step ST12 to step ST30.

In the image composition processing shown in FIG. 33, in step ST400, the AI method processing unit 62A9 and the non-AI method processing unit 62B9 acquire the processing target image 75A9 from the image sensor 20. After the processing of step ST400 is executed, the image composition processing shifts to step ST402.

In step ST402, the AI method processing unit 62A9 inputs the processing target image 75A9 acquired in step ST400 to the generation model 82A9. After the processing of step ST402 is executed, the image composition processing shifts to step ST404.

In step ST404, the AI method processing unit 62A9 acquires the first round blurriness image 86A9 output from the generation model 82A9 by inputting the processing target image 75A9 to the generation model 82A9 in step ST402. After the processing of step ST404 is executed, the image composition processing shifts to step ST406.

In step ST406, the non-AI method processing unit 62B9 applies the second round blurriness 120 to the processing target image 75A9 by performing the processing, which uses the digital filter 84A9, on the processing target image 75A9 acquired in step ST400. After the processing of step ST406 is executed, the image composition processing shifts to step ST408.

In the processing of step ST402 and the processing of step ST406, although an example of the embodiment in which the round blurriness is generated regardless of the subject which is captured in the processing target image 75A9 has been described, this is only an example, and a predetermined round blurriness, which is determined in accordance with the subject (for example, a specific person, a specific vehicle, a specific plant, a specific animal, a specific building, a specific aircraft, and/or the like) captured in the processing target image 75A9, may be generated and applied to the processing target image 75A9.

In step ST408, the non-AI method processing unit 62B9 acquires the second round blurriness image 88A9 obtained by performing the processing, which uses the digital filter 84A9, on the processing target image 75A9 in step ST406. After the processing of step ST408 is executed, the image composition processing shifts to step ST410.

In step ST410, the image adjustment unit 62C9 acquires the first ratio 90I1 and the second ratio 90I2 from the NVM64. After the processing of step ST410 is executed, the image composition processing shifts to step ST412.

In step ST412, the image adjustment unit 62C9 adjusts the first round blurriness image 86A9 by using the first ratio 90I1 acquired in step ST410. After the processing of step ST412 is executed, the image composition processing shifts to step ST414.

In step ST414, the image adjustment unit 62C9 adjusts the second round blurriness image 88A9 by using the second ratio 90I2 acquired in step ST410. After the processing of step ST414 is executed, the image composition processing shifts to step ST416.

In step ST416, the composition unit 62D9 adjusts the excess and deficiency of the AI method processing performed by the AI method processing unit 62A9 by combining the first round blurriness image 86A9 adjusted in step ST412 and the second round blurriness image 88A9 adjusted in step ST414. The composite image 92I is generated by combining the first round blurriness image 86A9 adjusted in step ST412 and the second round blurriness image 88A9 adjusted in step ST414. After the processing of step ST416 is executed, the image composition processing shifts to step ST418.

In step ST418, the composition unit 62D9 performs various types of image processing on the composite image 92I. The composition unit 62D9 outputs an image obtained by performing various types of image processing on the composite image 92I to a default output destination as the processed image 75B. After the processing of step ST418 is executed, the image composition processing shifts to step ST32.

As described above, in the imaging apparatus 10 according to the present eighth modification example, the first round blurriness image 86A9 is generated by applying the first round blurriness 118 to the processing target image 75A9 by using the AI method. Further, the second round blurriness image 88A9 is generated by applying the second round blurriness 120 to the processing target image 75A9 by using the non-AI method. Thereafter, the first round blurriness image 86A9 and the second round blurriness image 88A9 are combined. As a result, it is possible to suppress the excess and deficiency of the element of the first round blurriness 118 in a case of performing the AI method processing with respect to the composite image 92I. As a result, the composite image 92I becomes an image in which the first round blurriness 118 in a case of performing the AI method processing is less noticeable than in the first round blurriness image 86A9, and it is possible to provide a suitable image to a user who does not prefer the characteristic of the first round blurriness image 86A9 in a case of performing the AI method processing to be excessively noticeable.

Here, although an example of the embodiment in which the first round blurriness image 86A9 obtained by performing the processing, which uses the generation model 82A9, on the processing target image 75A9 and the second round blurriness image 88A9 obtained by performing the processing, which uses the digital filter 84A9, on the processing target image 75A9 are combined has been described, the present disclosed technology is not limited to this. For example, the first round blurriness image 86A9 obtained by performing the processing, which uses the generation model 82A9, on the processing target image 75A9 and the processing target image 75A9 (that is, an image in which the non-noise element is not adjusted) may be combined. In this case, the same effect can be expected.

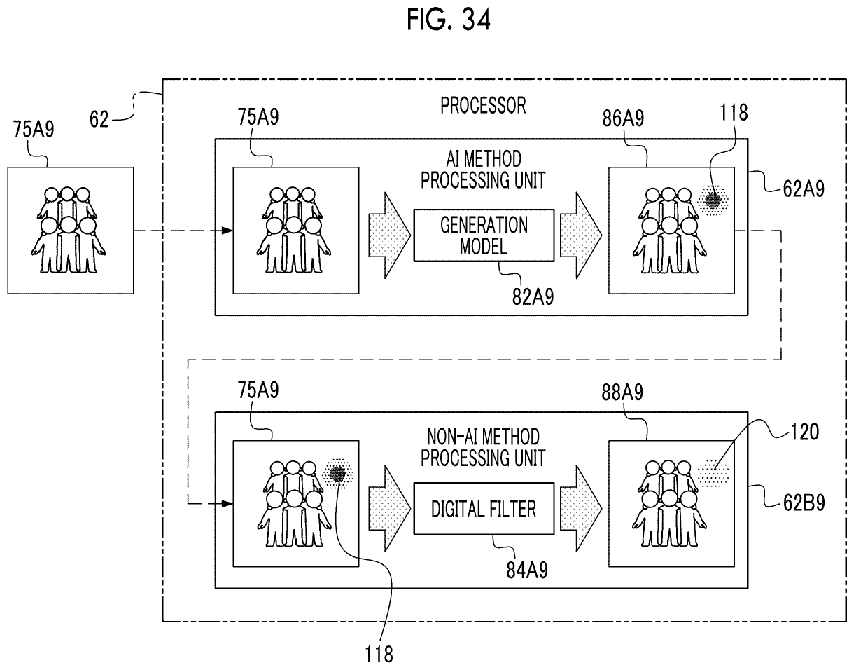

In the example shown in FIG. 31 to FIG. 33, although an example of the embodiment in which the second round blurriness 120 is applied to the processing target image 75A9 by the non-AI method processing unit 62B9 performing the non-AI method processing on the processing target image 75A9 has been described, the present disclosed technology is not limited to this. For example, as shown in FIG. 34, the non-AI method processing unit 62B9 may generate the second round blurriness image 88A9 including the second round blurriness 120 by performing the non-AI method processing on the first round blurriness image 86A9 generated by the AI method processing unit 62A9.

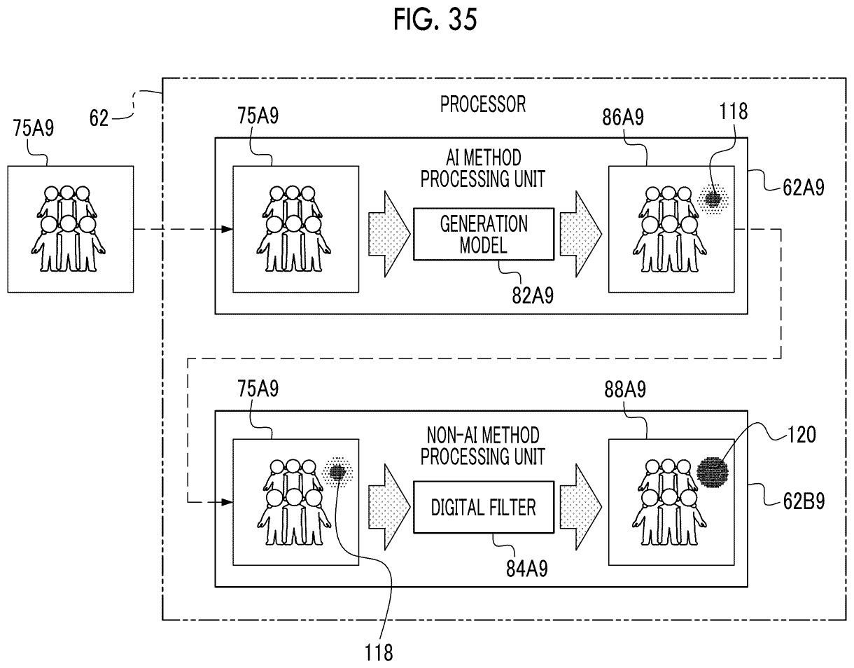

Further, for example, as shown in FIG. 35, the non-AI method processing unit 62B9 may generate the second round blurriness image 88A9 including the second round blurriness 120, which has higher sharpness than the first round blurriness 118, by performing the non-AI method processing on the first round blurriness image 86A9 generated by the AI method processing unit 62A9.

Further, in the examples shown in FIG. 31 to FIG. 35, although an example of the embodiment in which the first round blurriness 118 is applied to the processing target image 75A9 by using the AI method has been described, the AI method processing unit 62A9 may remove the round blurriness from the processing target image 75A9 by using the AI method in a case where the round blurriness is captured in the processing target image 75A9.

### Ninth Modification Example

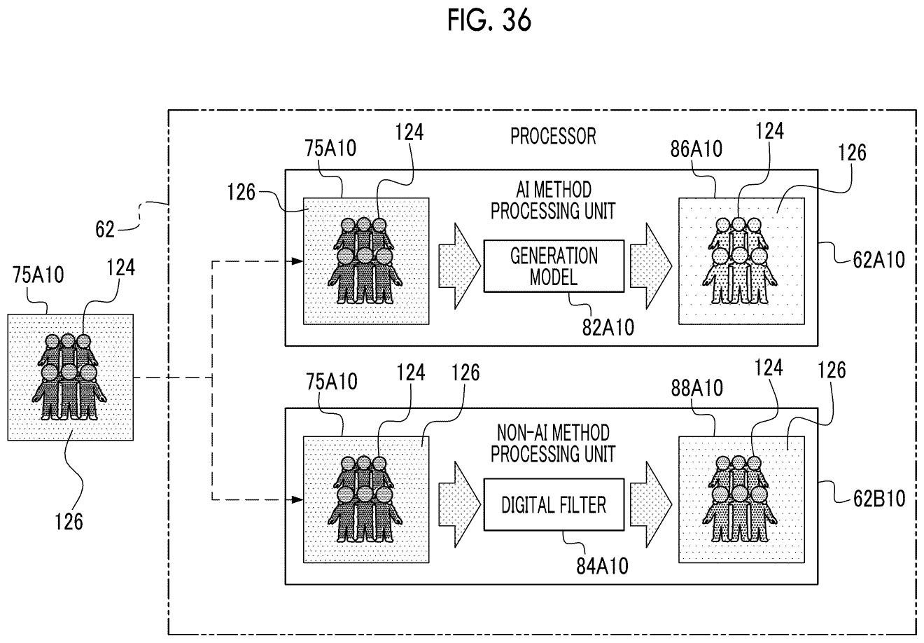

As an example shown in FIG. 36, the processor 62 according to the present ninth modification example differs from the processor 62 shown in FIG. 4 in that an AI method processing unit 62A10 is provided instead of the AI method processing unit 62A1, and in that a non-AI method processing unit 62B10 is provided instead of the non-AI method processing unit 62B1. In the present ninth modification example, the description of the same matters as those described before the ninth modification example will be omitted, and the matters different from the matters described before the ninth modification example will be described.

The processing target image 75A10 is input to the AI method processing unit 62A10 and the non-AI method processing unit 62B10. The processing target image 75A10 is an example of the processing target image 75A shown in FIG. 2. The processing target image 75A10 is a chromatic image and has a person region 124 and a background region 126. The person region 124 is an image region where a person is captured. The background region 126 is an image region where a background is captured. Here, although a chromatic image is exemplified as the processing target image 75A10, this is only an example, and the processing target image 75A10 may be an achromatic image.

Here, the person captured in the processing target image 75A10 is an example of a “fourth subject” according to the present disclosed technology. The gradation of the processing target image 75A10 is an example of a “non-noise element of the processing target image”, a “factor that controls a visual impression given from the processing target image”, and a “gradation of the processing target image” according to the present disclosed technology.

The AI method processing unit 62A10 performs AI method processing on the processing target image 75A10. An example of the AI method processing on the processing target image 75A10 includes processing that uses the generation model 82A10. The generation model 82A10 is an example of the generation model 82A shown in FIG. 3. The generation model 82A10 is a generation network that has already been trained to adjust the gradation of the processing target image 75A10 according to the person region 124. An example of the training of adjusting the gradation of the processing target image 75A10 according to the person region 124 includes a training of changing the gradation of the processing target image 75A10 depending on whether or not a person is captured in the processing target image 75A10, or a training of changing the gradation of the processing target image 75A10 according to a person's feature captured in the processing target image 75A10.

The AI method processing unit 62A10 changes the factor that controls the visual impression given from the processing target image 75A10 by using the AI method. That is, the AI method processing unit 62A10 changes the factor that controls the visual impression given from the processing target image 75A10 as the non-noise element of the processing target image 75A10 by performing the processing, which uses the generation model 82A10, on the processing target image 75A10. The factor that controls the visual impression given from the processing target image 75A10 is the gradation of the processing target image 75A10. In the example shown in FIG. 36, the AI method processing unit 62A10 generates a first gradation adjusted image 86A10 by performing the processing, which uses the generation model 82A10, on the processing target image 75A10. The first gradation adjusted image 86A10 is an image in which the gradation of the processing target image 75A10 is changed according to the person region 124. For example, the gradation of the processing target image 75A10 is changed by raising or lowering a pixel value of an R pixel, a pixel value of a G pixel, and a pixel value of a B pixel to the same extent. Further, the gradation of the processing target image 75A10 may be changed by increasing or decreasing the pixel value of at least one designated pixel among the R pixel, the G pixel, or the B pixel. How much the pixel value of which color is changed is determined according to the person region 124 (for example, presence or absence of the person region 124, a characteristic of the person shown in the person region 124, or the like).

Here, the processing, which uses the generation model 82A10, is an example of “first AI processing”, “first change processing”, and “first gradation adjustment processing” according to the present disclosed technology. The first gradation adjusted image 86A10 is an example of a “first changed image” and a “first gradation adjusted image” according to the present disclosed technology. “Generating the first gradation adjusted image 86A10” is an example of “acquiring the first image” according to the present disclosed technology.

The processing target image 75A10 is input to the generation model 82A10. The generation model 82A10 generates and outputs the first gradation adjusted image 86A10 based on the input processing target image 75A10.

The non-AI method processing unit 62B10 performs non-AI method processing on the processing target image 75A10. The non-AI method processing refers to processing that does not use a neural network. In the present ninth modification example, examples of the processing that does not use the neural network include processing that does not use the generation model 82A10.

An example of the non-AI method processing on the processing target image 75A10 includes processing that uses the digital filter 84A10. The digital filter 84A10 is a digital filter configured to adjust the gradation of the processing target image 75A10. For example, the digital filter 84A10 is used in a case where the processing target image 75A10 includes the person region 124. In this case, for example, the non-AI method processing unit 62B10 determines whether or not the processing target image 75A10 includes the person region 124 by performing known person detection processing on the processing target image 75A10. In a case where it is determined that the processing target image 75A10 includes the person region 124, the non-AI method processing unit 62B10 performs the processing, which uses the digital filter 84A10, on the processing target image 75A10.

Note that, the digital filter 84A10 may be prepared in advance for each feature of the person shown in the person region 124, and in this case, for example, the non-AI method processing unit 62B10 may acquire the feature of the person shown in the person region 124 by performing a known image recognition processing on the processing target image 75A10 and may perform processing, which uses the digital filter 84A10 corresponding to the acquired feature, on the processing target image 75A10.

The non-AI method processing unit 62B10 generates a second gradation adjusted image 88A10 by performing the processing (that is, filtering), which uses the digital filter 84A10, on the processing target image 75A10. In other words, the non-AI method processing unit 62B10 generates the second gradation adjusted image 88A10 by adjusting the non-noise element (here, as an example, the gradation of the processing target image 75A10) in the processing target image 75A10 by using the non-AI method.

Here, the processing, which uses the digital filter 84A10, is an example of “non-AI method processing that does not use a neural network” and “second change processing of changing the factor by using the non-AI method” according to the present disclosed technology. “Generating the second gradation adjusted image 88A10” is an example of “acquiring the second image” according to the present disclosed technology.

The processing target image 75A10 is input to the digital filter 84A10. The digital filter 84A10 generates the second gradation adjusted image 88A10 based on the input processing target image 75A10. The second gradation adjusted image 88A10 is an image obtained by changing the non-noise element by using the digital filter 84A10 (that is, an image obtained by changing the non-noise element by the processing, which uses the digital filter 84A10, with respect to the processing target image 75A10). In other words, the second gradation adjusted image 88A10 is an image in which the gradation of the processing target image 75A10 is changed by using the digital filter 84A10 (that is, an image in which the gradation is changed by the processing, which uses the digital filter 84A10, with respect to the processing target image 75A10). The second gradation adjusted image 88A10 is an example of a “second image”, a “second changed image”, and a “second gradation adjusted image” according to the present disclosed technology.

By the way, the gradation of the first gradation adjusted image 86A10, which is obtained by performing the AI method processing on the processing target image 75A10, may be a gradation different from the user's preference due to the characteristic of the generation model 82A10 (for example, the number of interlayers and/or the amount of training, or the like). In a case where the influence of the AI method processing is excessively reflected on the processing target image 75A10, it is conceivable that the gradation that is different from the user's preference is noticeable.

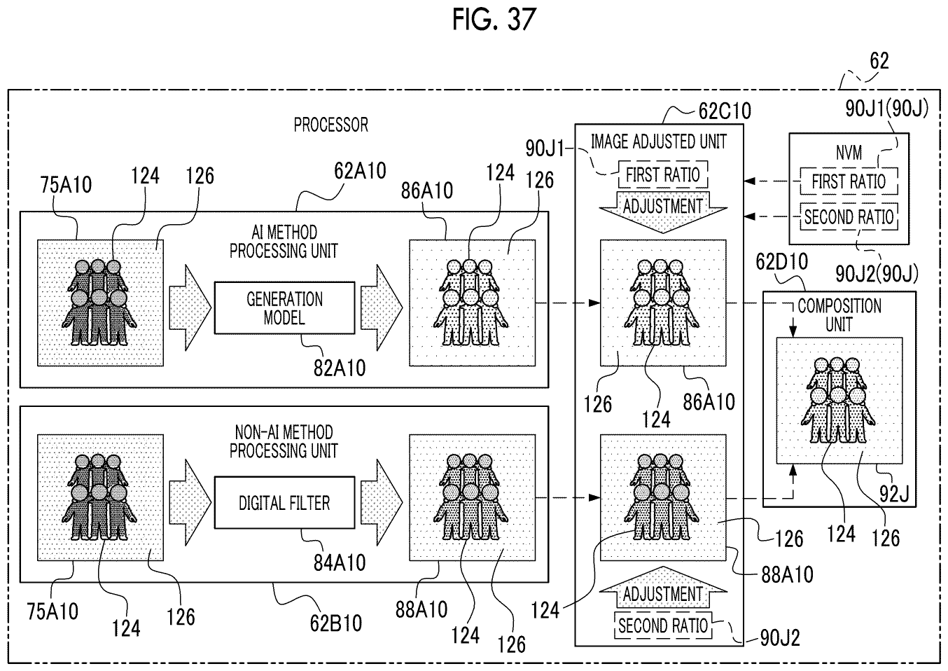

Therefore, in view of such circumstances, in the imaging apparatus 10, as an example shown in FIG. 37, by performing the processing of the image adjustment unit 62C10 and the processing of the composition unit 62D10 on the first gradation adjusted image 86A10 and the second gradation adjusted image 88A10, the first gradation adjusted image 86A10 and the second gradation adjusted image 88A10 are combined.

As an example shown in FIG. 37, a ratio 90J is stored in the NVM 64. The ratio 90J is a ratio for combining the first gradation adjusted image 86A10 and the second gradation adjusted image 88A10 and is defined to adjust excess and deficiency of the AI method processing (that is, the processing that uses the generation model 82A10) performed by the AI method processing unit 62A10.

The ratio 90J is roughly classified into a first ratio 90J1 and a second ratio 90J2. The first ratio 90J1 is a value of 0 or more and 1 or less, and the second ratio 90J2 is a value obtained by subtracting the value of the first ratio 90J1 from “1”. That is, the first ratio 90J1 and the second ratio 90J2 are defined such that the sum of the first ratio 90J1 and the second ratio 90J2 is “1”. The first ratio 90J1 and the second ratio 90J2 are variable values that are changed by an instruction from the user.

The image adjustment unit 62C10 adjusts the first gradation adjusted image 86A10 generated by the AI method processing unit 62A10 by using the first ratio 90J1. For example, the image adjustment unit 62C10 adjusts a pixel value of each pixel of the first gradation adjusted image 86A10 by multiplying a pixel value of each pixel of the first gradation adjusted image 86A10 by the first ratio 90J1.

The image adjustment unit 62C10 adjusts the second gradation adjusted image 88A10 generated by the non-AI method processing unit 62B10 by using the second ratio 90J2. For example, the image adjustment unit 62C10 adjusts a pixel value of each pixel of the second gradation adjusted image 88A10 by multiplying a pixel value of each pixel of the second gradation adjusted image 88A10 by the second ratio 90J2.

The composition unit 62D10 generates a composite image 92J by combining the first gradation adjusted image 86A10 adjusted at the first ratio 90J1 by the image adjustment unit 62C10 and the second gradation adjusted image 88A10 adjusted at the second ratio 90J2 by the image adjustment unit 62C10. That is, the composition unit 62D10 adjusts the excess and deficiency of the AI method processing performed by the AI method processing unit 62A10 by combining the first gradation adjusted image 86A10 adjusted at the first ratio 90J1 and the second gradation adjusted image 88A10 adjusted at the second ratio 90J2. In other words, the composition unit 62D10 adjusts the non-noise element (here, as an example, the gradation of the processing target image 75A10) by combining the first gradation adjusted image 86A10 adjusted at the first ratio 90J1 and the second gradation adjusted image 88A10 adjusted at the second ratio 90J2. Further, in other words, the composition unit 62D10 adjusts an element derived from the processing that uses the generation model 82A10 (for example, the pixel value of the pixel of which the gradation is changed by using the generation model 82A10) by combining the first gradation adjusted image 86A10 adjusted at the first ratio 90J1 and the second gradation adjusted image 88A10 adjusted at the second ratio 90J2.

The composition, which is performed by the composition unit 62D10, is an addition of a pixel value of a corresponding pixel position between the first gradation adjusted image 86A10 and the second gradation adjusted image 88A10. The composition, which is performed by the composition unit 62D10, is performed in the same manner as the composition, which is performed by the composition unit 62D1 shown in FIG. 5. Further, various types of image processing are also performed on the composite image 92J by the composition unit 62D10 in the same manner as on the composite image 92A shown in FIG. 5. The composite image 92J, in which various types of image processing are performed, is output to a default output destination by the composition unit 62D10.

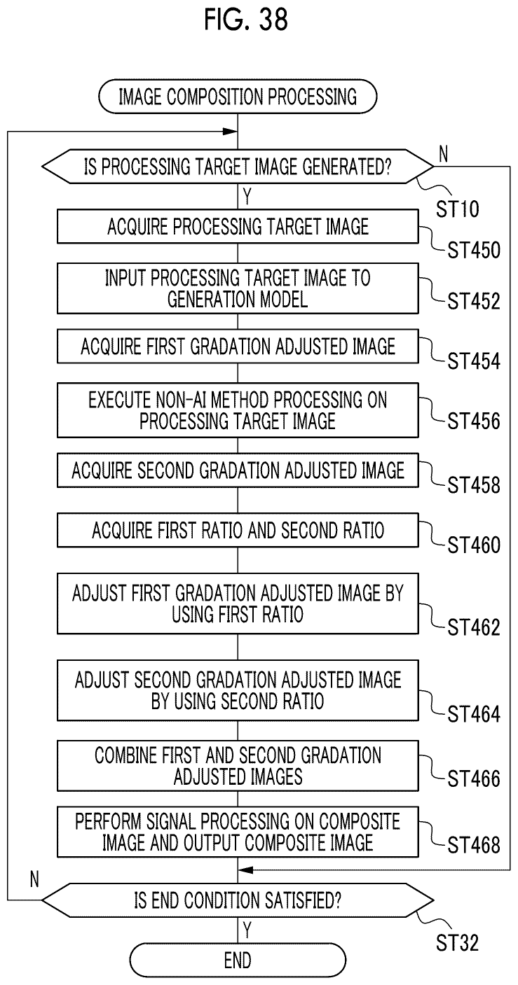

FIG. 38 shows an example of a flow of the image composition processing according to the present ninth modification example. The flowchart shown in FIG. 38 is different from the flowchart shown in FIG. 6 in that it includes step ST450 to step ST468 instead of step ST12 to step ST30.

In the image composition processing shown in FIG. 38, in step ST450, the AI method processing unit 62A10 and the non-AI method processing unit 62B10 acquire the processing target image 75A10 from the image sensor 20. After the processing of step ST450 is executed, the image composition processing shifts to step ST452.

In step ST452, the AI method processing unit 62A10 inputs the processing target image 75A10 acquired in step ST450 to the generation model 82A10. After the processing of step ST452 is executed, the image composition processing shifts to step ST454.

In step ST454, the AI method processing unit 62A10 acquires the first gradation adjusted image 86A10 output from the generation model 82A10 by inputting the processing target image 75A10 to the generation model 82A10 in step ST452. After the processing of step ST454 is executed, the image composition processing shifts to step ST456.

In step ST456, the non-AI method processing unit 62B10 adjusts the gradation of the processing target image 75A10 by performing processing, which uses the digital filter 84A10, on the processing target image 75A10 acquired in step ST450. After the processing of step ST456 is executed, the image composition processing shifts to step ST458.

In step ST458, the non-AI method processing unit 62B10 acquires the second gradation adjusted image 88A10 obtained by performing the processing, which uses the digital filter 84A10, on the processing target image 75A10 in step ST456. After the processing of step ST458 is executed, the image composition processing shifts to step ST460.

In step ST460, the image adjustment unit 62C10 acquires the first ratio 90J1 and the second ratio 90J2 from the NVM64. After the processing of step ST460 is executed, the image composition processing shifts to step ST462.

In step ST462, the image adjustment unit 62C10 adjusts the first gradation adjusted image 86A10 by using the first ratio 90J1 acquired in step ST460. After the processing of step ST462 is executed, the image composition processing shifts to step ST464.

In step ST464, the image adjustment unit 62C10 adjusts the second gradation adjusted image 88A10 by using the second ratio 90J2 acquired in step ST460. After the processing of step ST464 is executed, the image composition processing shifts to step ST466.

In step ST466, the composition unit 62D10 adjusts the excess and deficiency of the AI method processing performed by the AI method processing unit 62A10 by combining the first gradation adjusted image 86A10 adjusted in step ST462 and the second gradation adjusted image 88A10 adjusted in step ST464. The composite image 92J is generated by combining the first gradation adjusted image 86A10 adjusted in step ST462 and the second gradation adjusted image 88A10 adjusted in step ST464. After the processing of step ST466 is executed, the image composition processing shifts to step ST468.

In step ST468, the composition unit 62D10 performs various types of image processing on the composite image 92J. The composition unit 62D10 outputs an image obtained by performing various types of image processing on the composite image 92J to a default output destination as the processed image 75B. After the processing of step ST468 is executed, the image composition processing shifts to step ST32.

As described above, in the imaging apparatus 10 according to the present ninth modification example, the first gradation adjusted image 86A10 is generated by adjusting the gradation of the processing target image 75A10 by using the AI method. Further, the second gradation adjusted image 88A10 is generated by adjusting the gradation of the processing target image 75A10 by using the non-AI method. Thereafter, the first gradation adjusted image 86A10 and the second gradation adjusted image 88A10 are combined. As a result, it is possible to suppress the excess and deficiency of the adjustment amount of the gradation in a case of performing the AI method processing with respect to the composite image 92J. As a result, the composite image 92J becomes an image in which an adjustment amount of the gradation in a case of performing the AI method processing is less noticeable than that of the first gradation adjusted image 86A10, and it is possible to provide a suitable image to a user who does not prefer the adjustment amount of the gradation in a case of performing the AI method processing to be excessively noticeable.

In the present ninth modification example, the first gradation adjusted image 86A10 is generated by adjusting the gradation of the processing target image 75A10 in a case of performing the AI method according to the person region 124. Further, the second gradation adjusted image 88A10 is generated by adjusting the gradation of the processing target image 75A10 in a case of performing the non-AI method according to the person region 124. Thereafter, the first gradation adjusted image 86A10 and the second gradation adjusted image 88A10 are combined. As a result, it is possible to suppress the excess and deficiency of the adjustment amount, for which the gradation is adjusted according to the person region 124 by using the AI method, with respect to the composite image 92J.

Here, although an example of the embodiment in which the gradation is adjusted according to the person region 124 has been described, this is only an example, and the gradation may be adjusted according to the background region 126. Further, the gradation may be adjusted according to the combination of the person region 124 and the background region 126. Further, the gradation may be adjusted according to a region (for example, a region where a specific vehicle is captured, a region where a specific animal is captured, a region where a specific plant is captured, a region where a specific building is captured, a region where a specific aircraft is captured, and/or the like) other than the person region 124 and the background region 126.

Further, here, although an example of the embodiment in which the first gradation adjusted image 86A10 obtained by performing the processing, which uses the generation model 82A10, on the processing target image 75A10 and the second gradation adjusted image 88A10 obtained by performing the processing, which uses the digital filter 84A10, on the processing target image 75A10 are combined has been described, the present disclosed technology is not limited to this. For example, the first gradation adjusted image 86A10 obtained by performing the processing, which uses the generation model 82A10, on the processing target image 75A10 and the processing target image 75A10 (that is, an image in which the non-noise element is not adjusted) may be combined. In this case, the same effect can be expected.

### Tenth Modification Example

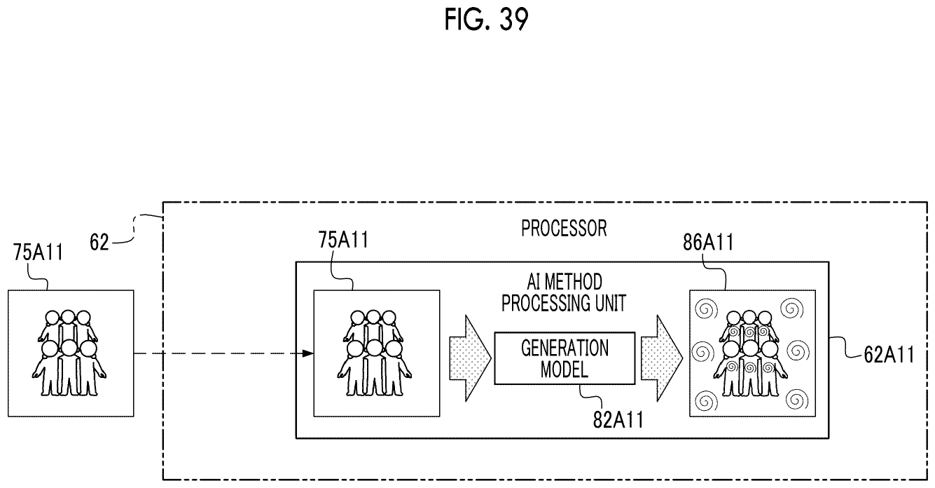

As an example shown in FIG. 39, the processor 62 according to the present tenth modification example differs from the processor 62 shown in FIG. 4 in that an AI method processing unit 62A11 is provided instead of the AI method processing unit 62A1. In the present tenth modification example, the description of the same matters as those described before the tenth modification example will be omitted, and the matters different from the matters described before the tenth modification example will be described.

The processing target image 75A11 is input to the AI method processing unit 62A11. The processing target image 75A11 is an example of the processing target image 75A shown in FIG. 2. The processing target image 75A11 is a chromatic image. Here, although a chromatic image is exemplified as the processing target image 75A11, this is only an example, and the processing target image 75A11 may be an achromatic image.

The AI method processing unit 62A11 performs AI method processing on the processing target image 75A11. An example of the AI method processing on the processing target image 75A11 includes processing that uses the generation model 82A11. The generation model 82A11 is an example of the generation model 82A shown in FIG. 3. The generation model 82A11 is a generation network that has already been trained to change an image style of the processing target image 75A11.

Here, the image style of the processing target image 75A11 is an example of a “non-noise element of the processing target image”, a “factor that controls a visual impression given from the processing target image”, and an “image style of the processing target image” according to the present disclosed technology.

The AI method processing unit 62A11 changes the factor that controls the visual impression given from the processing target image 75A11 by using the AI method. That is, the AI method processing unit 62A11 changes the factor that controls the visual impression given from the processing target image 75A11 as the non-noise element of the processing target image 75A11 by performing the processing, which uses the generation model 82A11, on the processing target image 75A11. The factor that controls the visual impression given from the processing target image 75A11 is the image style of the processing target image 75A11. In the example shown in FIG. 39, the AI method processing unit 62A11 generates the image style changed image 86A11 by performing the processing, which uses the generation model 82A11, on the processing target image 75A11. The image style changed image 86A11 is an image in which the image style of the processing target image 75A11 is changed. In the example shown in FIG. 39, the image style of the image style changed image 86A11 is different from the image style of the processing target image 75A11 in that a plurality of spiral patterns are added.

Here, the processing using the generation model 82A11 is an example of “first AI processing”, “first change processing”, and “image style change processing” according to the present disclosed technology. The image style changed image 86A11 is an example of a “first changed image” and an “image style changed image” according to the present disclosed technology. The processing target image 75A11 is an example of a “second image” according to the present disclosed technology. “Generating the image style changed image 86A11” is an example of “acquiring the first image” according to the present disclosed technology.

The processing target image 75A11 is input to the generation model 82A11. The generation model 82A11 generates and outputs the image style changed image 86A11 based on the input processing target image 75A11.

By the way, the image style of the image style changed image 86A11, which is obtained by performing the AI method processing on the processing target image 75A11, may be an image style different from the user's preference due to the characteristic of the generation model 82A11 (for example, the number of interlayers and/or the amount of training, or the like). In a case where the influence of the AI method processing is excessively reflected on the processing target image 75A11, it is conceivable that the image style that is different from the user's preference is noticeable.

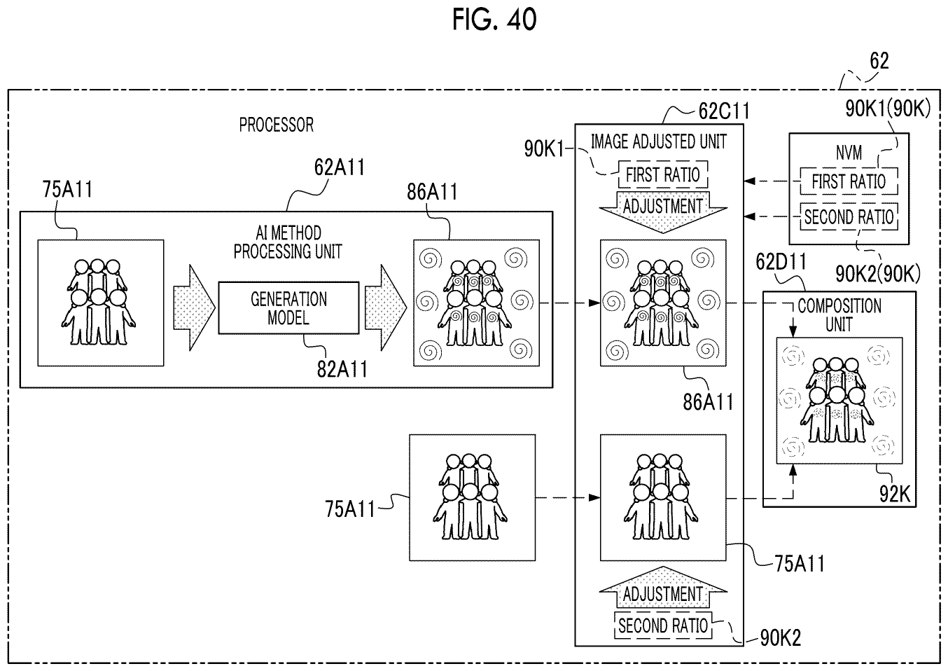

Therefore, in view of such circumstances, in the imaging apparatus 10, as an example shown in FIG. 40, by performing the processing of the image adjustment unit 62C11 and the processing of the composition unit 62D11 on the image style changed image 86A11 and the processing target image 75A11, the image style changed image 86A11 and the processing target image 75A11 are combined.

As an example shown in FIG. 40, a ratio 90K is stored in the NVM 64. The ratio 90K is a ratio for combining the image style changed image 86A11 and the processing target image 75A11 and is defined to adjust excess and deficiency of the AI method processing (that is, the processing that uses the generation model 82A11) performed by the AI method processing unit 62A11.

The ratio 90K is roughly classified into a first ratio 90K1 and a second ratio 90K2. The first ratio 90K1 is a value of 0 or more and 1 or less, and the second ratio 90K2 is a value obtained by subtracting the value of the first ratio 90K1 from “1”. That is, the first ratio 90K1 and the second ratio 90K2 are defined such that the sum of the first ratio 90K1 and the second ratio 90K2 is “1”. The first ratio 90K1 and the second ratio 90K2 are variable values that are changed by an instruction from the user.

The image adjustment unit 62C11 adjusts the image style changed image 86A11 generated by the AI method processing unit 62A11 by using the first ratio 90K1. For example, the image adjustment unit 62C11 adjusts a pixel value of each pixel of the image style changed image 86A11 by multiplying a pixel value of each pixel of the image style changed image 86A11 by the first ratio 90K1.

The image adjustment unit 62C11 adjusts the processing target image 75A11 by using the second ratio 90K2. For example, the image adjustment unit 62C11 adjusts a pixel value of each pixel of the processing target image 75A11 by multiplying a pixel value of each pixel of the processing target image 75A11 by the second ratio 90K2.

The composition unit 62D11 generates a composite image 92K by combining the image style changed image 86A11 adjusted at the first ratio 90K1 by the image adjustment unit 62C11 and the processing target image 75A11 adjusted at the second ratio 90K2 by the image adjustment unit 62C11. That is, the composition unit 62D11 adjusts the excess and deficiency of the AI method processing performed by the AI method processing unit 62A11 by combining the image style changed image 86A11 adjusted at the first ratio 90K1 and the processing target image 75A11 adjusted at the second ratio 90K2. In other words, the composition unit 62D11 adjusts the non-noise element (here, as an example, the image style of the processing target image 75A11) by combining the image style changed image 86A11 adjusted at the first ratio 90K1 and the processing target image 75A11 adjusted at the second ratio 90K2. Further, in other words, the composition unit 62D11 adjusts an element derived from the processing that uses the generation model 82A11 (for example, the pixel value of the pixel of which the image style is changed by using the generation model 82A11) by combining the image style changed image 86A11 adjusted at the first ratio 90K1 and the processing target image 75A11 adjusted at the second ratio 90K2.

The composition, which is performed by the composition unit 62D11, is an addition of a pixel value of a corresponding pixel position between the image style changed image 86A11 and the processing target image 75A11. The composition, which is performed by the composition unit 62D11, is performed in the same manner as the composition, which is performed by the composition unit 62D1 shown in FIG. 5. Further, various types of image processing are also performed on the composite image 92K by the composition unit 62D11 in the same manner as on the composite image 92A shown in FIG. 5. The composite image 92K, in which various types of image processing are performed, is output to a default output destination by the composition unit 62D11.

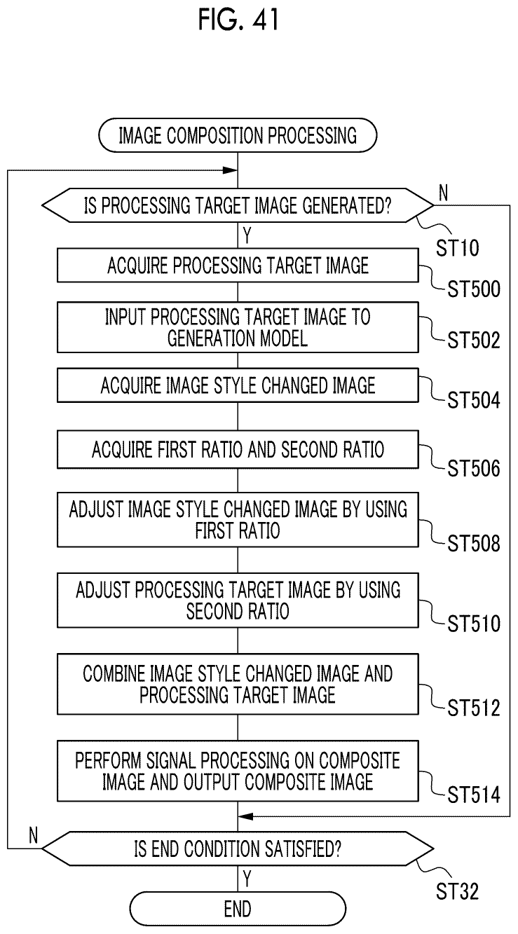

FIG. 41 shows an example of a flow of the image composition processing according to the present tenth modification example. The flowchart shown in FIG. 41 is different from the flowchart shown in FIG. 6 in that it includes step ST500 to step ST514 instead of step ST12 to step ST30.

In the image composition processing shown in FIG. 41, in step ST500, the AI method processing unit 62A11 acquires the processing target image 75A11 from the image sensor 20. After the processing of step ST500 is executed, the image composition processing shifts to step ST502.

In step ST502, the AI method processing unit 62A11 inputs the processing target image acquired in step ST500 to the generation model 82A11. After the processing of step ST502 is executed, the image composition processing shifts to step ST504.

In step ST504, the AI method processing unit 62A11 acquires the image style changed image 86A11 output from the generation model 82A11 by inputting the processing target image to the generation model 82A11 in step ST502. After the processing of step ST504 is executed, the image composition processing shifts to step ST506.

In step ST506, the image adjustment unit 62C11 acquires the first ratio 90K1 and the second ratio 90K2 from the NVM64. After the processing of step ST506 is executed, the image composition processing shifts to step ST508.

In step ST508, the image adjustment unit 62C11 adjusts the image style changed image 86A11 by using the first ratio 90K1 acquired in step ST506. After the processing of step ST508 is executed, the image composition processing shifts to step ST510.

In step ST510, the image adjustment unit 62C11 adjusts the processing target image by using the second ratio 90K2 acquired in step ST506. After the processing of step ST510 is executed, the image composition processing shifts to step ST512.

In step ST512, the composition unit 62D11 adjusts the excess and deficiency of the AI method processing performed by the AI method processing unit 62A11 by combining the image style changed image 86A11 adjusted in step ST508 and the processing target image 75A11 adjusted in step ST510. The composite image 92K is generated by combining the image style changed image 86A11 adjusted in step ST508 and the processing target image 75A11 adjusted in step ST510. After the processing of step ST512 is executed, the image composition processing shifts to step ST514.

In step ST514, the composition unit 62D11 performs various types of image processing on the composite image 92K. The composition unit 62D11 outputs an image obtained by performing various types of image processing on the composite image 92K to a default output destination as the processed image 75B. After the processing of step ST514 is executed, the image composition processing shifts to step ST32.

As described above, in the imaging apparatus 10 according to the present tenth modification example, the image style changed image 86A11 is generated by adjusting the image style of the processing target image 75A11 by using the AI method. Thereafter, the image style changed image 86A11 and the processing target image 75A11 are combined. As a result, it is possible to suppress the excess and deficiency of the image style changed in a case of performing the AI method with respect to the composite image 92K. As a result, the composite image 92K becomes an image in which the image style that is changed in a case of performing the AI method processing is less noticeable than that of the image style changed image 86A11, and it is possible to provide a suitable image to a user who does not prefer the image style that is changed in a case of performing the AI method processing to be excessively noticeable.

### Eleventh Modification Example

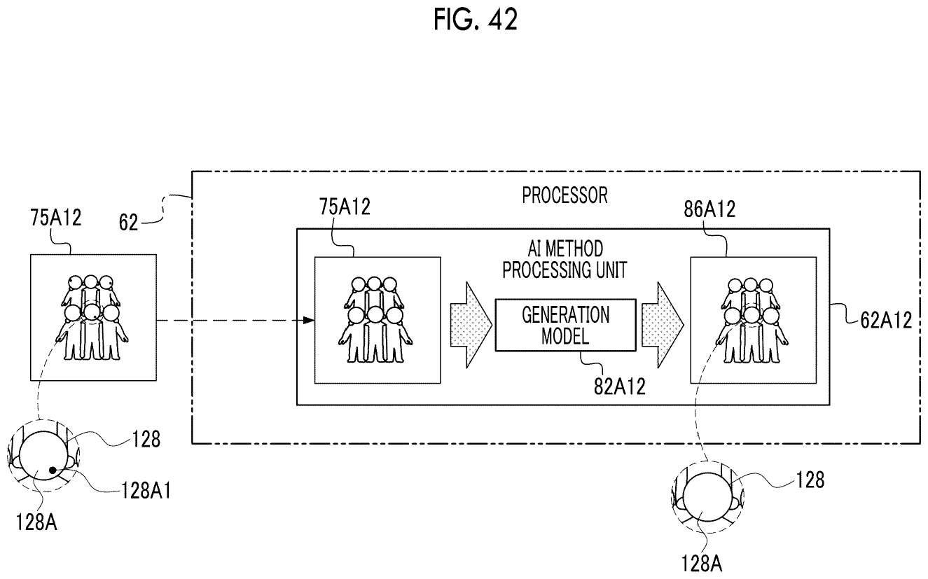

As an example shown in FIG. 42, the processor 62 according to the present eleventh modification example differs from the processor 62 shown in FIG. 4 in that an AI method processing unit 62A12 is provided instead of the AI method processing unit 62A1. In the present eleventh modification example, the description of the same matters as those described before the eleventh modification example will be omitted, and the matters different from the matters described before the eleventh modification example will be described.

The processing target image 75A12 is input to the AI method processing unit 62A12. The processing target image 75A12 is an example of the processing target image 75A shown in FIG. 2. The processing target image 75A12 is a chromatic image. Here, although a chromatic image is exemplified as the processing target image 75A12, this is only an example, and the processing target image 75A12 may be an achromatic image.

The processing target image 75A12 has a person region 128. The person region 128 is an image region showing a person. The person region 128 has a skin region 128A showing skin. Further, the skin region 128A includes a stain region 128A1. The stain region 128A1 is an image region showing a stain generated on the skin. Further, although the stain is exemplified here, the present modification example is not limited to the stain, and it may be a mole, a scar, and/or the like, as long as it is an element that interferes with the aesthetics of the skin.

The AI method processing unit 62A12 performs AI method processing on the processing target image 75A12. An example of the AI method processing on the processing target image includes processing that uses the generation model 82A12. The generation model 82A12 is an example of the generation model 82A shown in FIG. 3. The generation model 82A12 is a generation network that has already been trained to adjust an image quality (that is, the image quality of the skin region 128A) related to the skin that is captured in the processing target image 75A12. The adjustment of the image quality related to the skin refers to, for example, a correction (for example, erasing the stain region 128A1) of making the stain region 128A1 in the processing target image 75A12 less noticeable.

Here, the image quality of the skin region 128A is an example of a “non-noise element of the processing target image”, a “factor that controls a visual impression given from the processing target image”, and an “image quality related to the skin” according to the present disclosed technology.

The AI method processing unit 62A12 changes the factor that controls the visual impression given from the processing target image 75A12 by using the AI method. That is, the AI method processing unit 62A12 changes the factor that controls the visual impression given from the processing target image 75A12 as the non-noise element of the processing target image 75A12 by performing the processing, which uses the generation model 82A12, on the processing target image 75A12. The factor that controls the visual impression given from the processing target image 75A12 is the image quality of the skin region 128A. In the example shown in FIG. 42, the AI method processing unit 62A12 generates a skin image quality adjusted image 86A12 by performing the processing, which uses the generation model 82A12, on the processing target image 75A12. The skin image quality adjusted image 86A12 is an image in which the image quality of the skin region 128A included in the processing target image 75A12 is adjusted. In the example shown in FIG. 42, the skin image quality adjusted image 86A12 is different from the processing target image 75A12 in that the stain region 128A1 is erased.

Here, the processing, which uses the generation model 82A12, is an example of “first AI processing”, “first change processing”, and “skin image quality adjustment processing” according to the present disclosed technology. The skin image quality adjusted image 86A12 is an example of a “first changed image” and a “skin image quality adjusted image” according to the present disclosed technology. The processing target image 75A12 is an example of a “second image” according to the present disclosed technology. “Generating the skin image quality adjusted image 86A12” is an example of “acquiring a first image” according to the present disclosed technology.

The processing target image 75A12 is input to the generation model 82A12. The generation model 82A12 generates and outputs the skin image quality adjusted image 86A12 based on the input processing target image 75A12.

By the way, the image quality of the skin region 128A in the skin image quality adjusted image 86A12, which is obtained by performing the AI method processing on the processing target image 75A12, may be an image quality different from the user's preference due to the characteristic of the generation model 82A12 (for example, the number of interlayers and/or the amount of training, or the like). In a case where the influence of the AI method processing is excessively reflected on the processing target image 75A12, it is conceivable that the image quality that is different from the user's preference is noticeable. For example, there is a possibility that an unnatural image may be obtained by completely erasing the stain region 128A1.

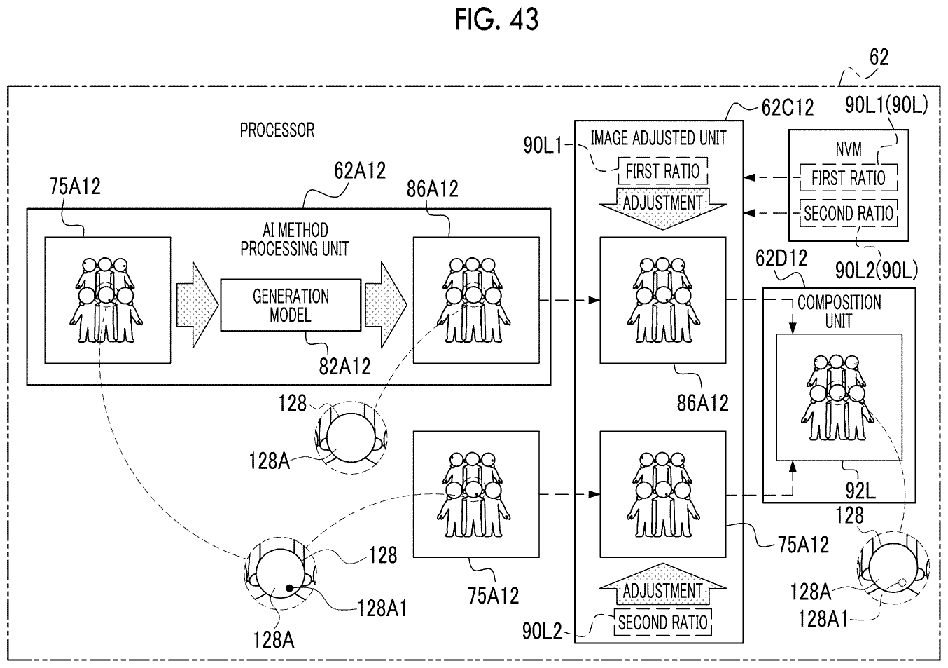

Therefore, in view of such circumstances, in the imaging apparatus 10, as an example shown in FIG. 43, by performing the processing of the image adjustment unit 62C12 and the processing of the composition unit 62D12 on the skin image quality adjusted image 86A12 and the processing target image 75A12, the skin image quality adjusted image 86A12 and the processing target image 75A12 are combined.

As an example shown in FIG. 43, a ratio 90L is stored in the NVM 64. The ratio 90L is a ratio for combining the skin image quality adjusted image 86A12 and the processing target image 75A12 and is defined to adjust excess and deficiency of the AI method processing (that is, the processing that uses the generation model 82A12) performed by the AI method processing unit 62A12.

The ratio 90L is roughly classified into a first ratio 90L1 and a second ratio 90L2. The first ratio 90L1 is a value of 0 or more and 1 or less, and the second ratio 90L2 is a value obtained by subtracting the value of the first ratio 90L1 from “1”. That is, the first ratio 90L1 and the second ratio 90L2 are defined such that the sum of the first ratio 90L1 and the second ratio 90L2 is “1”. The first ratio 90L1 and the second ratio 90L2 are variable values that are changed by an instruction from the user.

The image adjustment unit 62C12 adjusts the skin image quality adjusted image 86A12 generated by the AI method processing unit 62A12 by using the first ratio 90L1. For example, the image adjustment unit 62C12 adjusts a pixel value of each pixel of the skin image quality adjusted image 86A12 by multiplying a pixel value of each pixel of the skin image quality adjusted image 86A12 by the first ratio 90L1.

The image adjustment unit 62C12 adjusts the processing target image 75A12 by using the second ratio 90L2. For example, the image adjustment unit 62C12 adjusts a pixel value of each pixel of the processing target image 75A12 by multiplying a pixel value of each pixel of the processing target image 75A12 by the second ratio 90L2.

The composition unit 62D12 generates a composite image 92L by combining the skin image quality adjusted image 86A12 adjusted at the first ratio 90L1 by the image adjustment unit 62C12 and the processing target image 75A12 adjusted at the second ratio 90L2 by the image adjustment unit 62C12. That is, the composition unit 62D12 adjusts the excess and deficiency of the AI method processing performed by the AI method processing unit 62A12 by combining the skin image quality adjusted image 86A12 adjusted at the first ratio 90L1 and the processing target image 75A12 adjusted at the second ratio 90L2. In other words, the composition unit 62D12 adjusts the non-noise element (here, as an example, the image quality of the skin region 128A) by combining the skin image quality adjusted image 86A12 adjusted at the first ratio 90L1 and the processing target image 75A12 adjusted at the second ratio 90L2. Further, in other words, the composition unit 62D12 adjusts an element derived from the processing that uses the generation model 82A12 (for example, the pixel value of the pixel of which the image quality is changed by using the generation model 82A12) by combining the skin image quality adjusted image 86A12 adjusted at the first ratio 90L1 and the processing target image 75A12 adjusted at the second ratio 90L2.

The composition, which is performed by the composition unit 62D12, is an addition of a pixel value of a corresponding pixel position between the skin image quality adjusted image 86A12 and the processing target image 75A12. The composition, which is performed by the composition unit 62D12, is performed in the same manner as the composition, which is performed by the composition unit 62D1 shown in FIG. 5. Further, various types of image processing are also performed on the composite image 92L by the composition unit 62D12 in the same manner as on the composite image 92A shown in FIG. 5. The composite image 92L, in which various types of image processing are performed, is output to a default output destination by the composition unit 62D12.

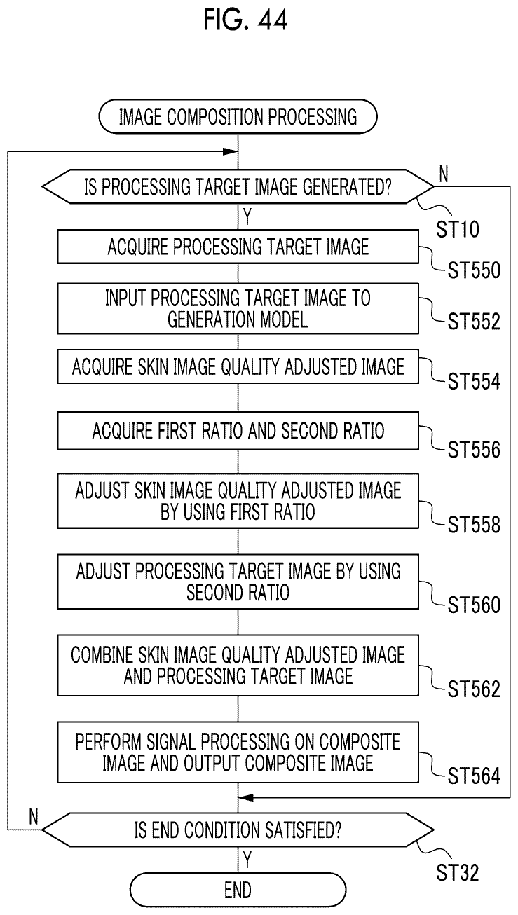

FIG. 44 shows an example of a flow of the image composition processing according to the present eleventh modification example. The flowchart shown in FIG. 44 is different from the flowchart shown in FIG. 6 in that it includes step ST550 to step ST564 instead of step ST12 to step ST30.

In the image composition processing shown in FIG. 44, in step ST550, the AI method processing unit 62A12 acquires the processing target image 75A12 from the image sensor 20. After the processing of step ST550 is executed, the image composition processing shifts to step ST552.

In step ST552, the AI method processing unit 62A12 inputs the processing target image acquired in step ST550 to the generation model 82A12. After the processing of step ST552 is executed, the image composition processing shifts to step ST554.

In step ST554, the AI method processing unit 62A12 acquires the skin image quality adjusted image 86A12 output from the generation model 82A12 by inputting the processing target image 75A12 to the generation model 82A12 in step ST552. After the processing of step ST554 is executed, the image composition processing shifts to step ST556.

In step ST556, the image adjustment unit 62C12 acquires the first ratio 90L1 and the second ratio 90L2 from the NVM64. After the processing of step ST556 is executed, the image composition processing shifts to step ST558.

In step ST558, the image adjustment unit 62C12 adjusts the skin image quality adjusted image 86A12 by using the first ratio 90L1 acquired in step ST556. After the processing of step ST558 is executed, the image composition processing shifts to step ST560.

In step ST560, the image adjustment unit 62C12 adjusts the processing target image 75A12 by using the second ratio 90L2 acquired in step ST556. After the processing of step ST560 is executed, the image composition processing shifts to step ST562.

In step ST562, the composition unit 62D12 adjusts the excess and deficiency of the AI method processing performed by the AI method processing unit 62A12 by combining the skin image quality adjusted image 86A12 adjusted in step ST558 and the processing target image 75A12 adjusted in step ST560. The composite image 92L is generated by combining the skin image quality adjusted image 86A12 adjusted in step ST558 and the processing target image 75A12 adjusted in step ST560. After the processing of step ST562 is executed, the image composition processing shifts to step ST564.

In step ST564, the composition unit 62D12 performs various types of image processing on the composite image 92L. The composition unit 62D12 outputs an image obtained by performing various types of image processing on the composite image 92L to a default output destination as the processed image 75B. After the processing of step ST564 is executed, the image composition processing shifts to step ST32.

As described above, in the imaging apparatus 10 according to the present eleventh modification example, the skin image quality adjusted image 86A12 is generated by adjusting the image quality of the skin region 128A in the processing target image 75A12 by using the AI method. Thereafter, the skin image quality adjusted image 86A12 and the processing target image 75A12 are combined. As a result, it is possible to suppress an excess and deficiency of the adjustment amount of the image quality adjusted by using the AI method with respect to the composite image 92L. As a result, the composite image 92L becomes an image in which the adjustment amount of the image quality that is adjusted in a case of performing the AI method is less noticeable than that of the skin image quality adjusted image 86A12, and it is possible to provide a suitable image to a user (for example, a user who does not want the stain region 128A1 to be completely erased) who does not prefer the adjustment amount of the image quality that is adjusted in a case of performing the AI method to be excessively noticeable.

Here, although an example of the embodiment in which the stain region 128A1 is erased has been described, the present disclosed technology is not limited to this. For example, the skin, which is captured in the processing target image 75A12, may be made beautiful by changing the brightness of the skin region 128A or changing the color of the skin region 128A by using the AI method. Also in this case, the processing of steps ST556 to ST564 are performed such that the skin of the person, which is captured in the image, does not have an unnatural appearance due to the excessive beautification of the skin.

Hereinafter, for convenience of description, in a case where it is not necessary to distinguish between the processing target images 75A1 to 75A12, the processing target images 75A1 to 75A12 are referred to as a “processing target image 75A”. Further, in the following description, for convenience of explanation, in a case where it is not necessary to distinguish between the ratios 90A to 90L, the ratios 90A to 90L are referred to as a “ratio 90”. Further, in the following description, for convenience of explanation, in a case where it is not necessary to distinguish among the first aberration corrected image 86A1, the first colored image 86A2, the first contrast adjusted image 86A3, the first resolution adjusted image 86A4, the first HDR image 86A5, the first edge emphasized image 86A6, the first point image adjusted image 86A7, the first blurred image 86A8, the first round blurriness image 86A9, the first gradation adjusted image 86A10, the image style changed image 86A11, and the skin image quality adjusted image 86A12, these are referred to as a “first image 86A”. Further, in a case where it is not necessary to distinguish among the second aberration corrected image 88A1, the second colored image 88A2, the second contrast adjusted image 88A3, the second resolution adjusted image 88A4, the second HDR image 88A5, the second edge emphasized image 88A6, the second point image adjusted image 88A7, the second blurred image 88A8, the second round blurriness image 88A9, the second gradation adjusted image 88A10, the processing target image 75A11, and the processing target image 75A12, these are referred to as a “second image 88A”. Further, in the following, for convenience of explanation, in a case where it is not necessary to distinguish between the generation models 82A1 and 82A12, the generation models 82A1 to 82A12 are referred to as a “generation model 82A”. Further, in the following description, for convenience of explanation, in a case where it is not necessary to distinguish between the AI method processing units 62A1 to 62A12, the AI method processing units 62A1 to 62A12 are referred to as an “AI method processing unit 62A”. Further, in the following description, for convenience of explanation, in a case where it is not necessary to distinguish between the composite images 92A to 92L, the composite images 92A to 92L are referred to as a “composite image 92”.

### Twelfth Modification Example

In the examples shown in FIG. 1 to FIG. 44, although an example of the embodiment in which the processor 62 generates the first image 86A by performing single processing for each purpose by using the AI method has been described, the present disclosed technology is limited to this. For example, the processor 62 may perform a plurality of processing by using the AI method.

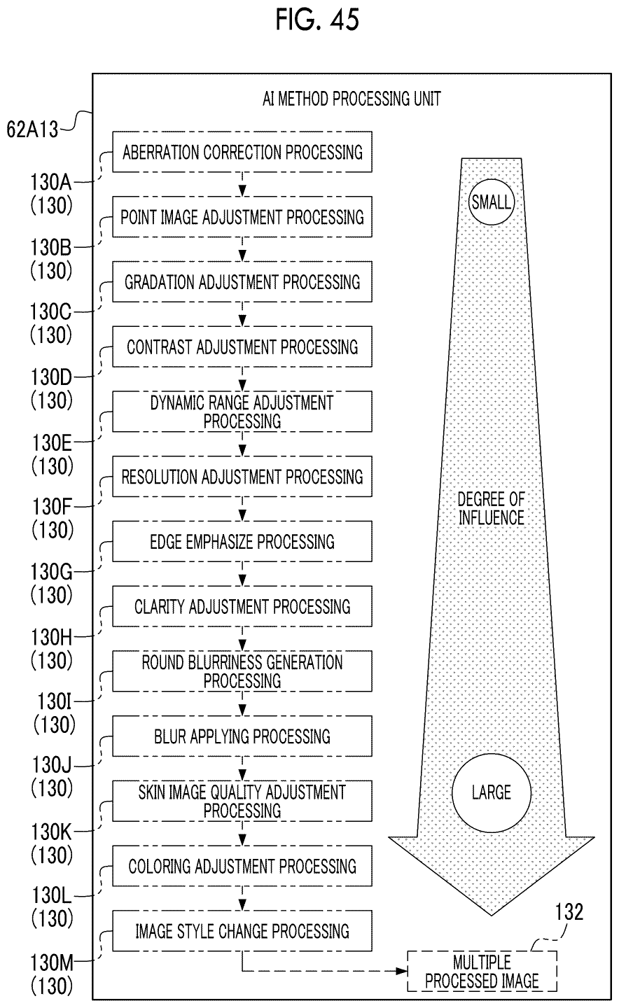

In this case, as an example shown in FIG. 45, the AI method processing unit 62A13 performs a plurality of purpose-specific processing 130 on the processing target image 75A by using the AI method. That is, the AI method processing unit 62A13 performs processing, which uses the plurality of generation models 82A, on the processing target image 75A. A multiple processed image 132 is generated by performing the plurality of purpose-specific processing 130 on the processing target image 75A by using the AI method. The multiple processed image 132 and the second image 88A are combined at the ratio of 90.

The plurality of purpose-specific processing 130 include the aberration correction processing 130A, the point image adjustment processing 130B, the gradation adjustment processing 130C, the contrast adjustment processing 130D, the dynamic range adjustment processing 130E, the resolution adjustment processing 130F, the edge emphasize processing 130G, the clarity adjustment processing 130H, the round blurriness generation processing 130I, the blur applying processing 130J, the skin image quality adjustment processing 130K, the coloring adjustment processing 130L, and the image style change processing 130M.

An example of the aberration correction processing 130A includes processing performed by the AI method processing unit 62A1 shown in FIG. 4. An example of the point image adjustment processing 130B includes processing performed by the AI method processing unit 62A7 shown in FIG. 25. An example of the gradation adjustment processing 130C includes processing performed by the AI method processing unit 62A10 shown in FIG. 36. An example of the contrast adjustment processing 130D includes processing performed by the AI method processing unit 62A3. An example of the dynamic range adjustment processing 130E includes processing performed by the AI method processing unit 62A5 shown in FIG. 19. An example of the resolution adjustment processing 130F includes processing performed by the AI method processing unit 62A4 shown in FIG. 16. An example of the edge emphasize processing 130G includes processing performed by the AI method processing unit 62A6 shown in FIG. 22. An example of the clarity adjustment processing 130H includes processing performed by the AI method processing unit 62A3 shown in FIG. 14. An example of the round blurriness generation processing 130I includes processing performed by the AI method processing unit 62A9 shown in FIG. 31. An example of the blur applying processing 130J includes processing performed by the AI method processing unit 62A8 shown in FIG. 28. An example of the skin image quality adjustment processing 130K includes processing performed by the AI method processing unit 62A12 shown in FIG. 42. An example of the coloring adjustment processing 130L includes processing performed by the AI method processing unit 62A2 shown in FIG. 7. An example of the image style change processing 130M includes processing performed by the AI method processing unit 62A11 shown in FIG. 39.

The plurality of purpose-specific processing 130 are performed in an order based on a degree of influence on the processing target image 75A. For example, the plurality of purpose-specific processing 130 are performed stepwise from the purpose-specific processing 130 having a small degree of influence on the processing target image 75A to the purpose-specific processing 130 having a large degree of influence on the processing target image 75A. In the example shown in FIG. 45, the processing, which is performed on the processing target image 75A, is performed in the order the aberration correction processing 130A, the point image adjustment processing 130B, the gradation adjustment processing 130C, the contrast adjustment processing 130D, the dynamic range adjustment processing 130E, the resolution adjustment processing 130F, the edge emphasize processing 130G, the clarity adjustment processing 130H, the round blurriness generation processing 130I, the blur applying processing 130J, the skin image quality adjustment processing 130K, the coloring adjustment processing 130L, and the image style change processing 130M.

As described above, in the present twelfth modification example, the plurality of purpose-specific processing 130 are performed on the processing target image 75A by using the AI method, and since the multiple processed image 132 and the second image 88A, which are obtained by performing the plurality of purpose-specific processing 130, are combined at the ratio of 90, the same effect as the examples shown in FIG. 1 to FIG. 44 can be obtained.

Further, in the present twelfth modification example, since the plurality of purpose-specific processing 130 are performed in order based on the degree of influence on the processing target image 75A, it is possible to suppress that the appearance of the multiple processed image 132 becomes unnatural as compared with the case where the plurality of purpose-specific processing 130 are performed on the processing target image 75A in the order determined without considering the degree of influence on the processing target image 75A.

Further, in the present twelfth modification example, the plurality of purpose-specific processing 130 are performed stepwise from the purpose-specific processing 130 having a small degree of influence on the processing target image 75A to the purpose-specific processing 130 having a large degree of influence on the processing target image 75A. Therefore, it is possible to suppress that the appearance of the multiple processed image 132 becomes unnatural as compared with the case where the plurality of purpose-specific processing 130 are performed stepwise from the purpose-specific processing 130 having a large degree of influence on the processing target image 75A to the purpose-specific processing 130 having a small degree of influence on the processing target image 75A.

### Thirteenth Modification Example

In the examples shown in FIG. 1 to FIG. 45, although an example of the embodiment in which the ratio 90 is determined in accordance with an instruction from the user has been described, the present disclosed technology is not limited to this, and the ratio 90 may be determined by another method. For example, in a case where a difference between the processing target image 75A and the first image 86A or a difference between the first image 86A and the second image 88A is excessively large, or in a case where a difference between the processing target image 75A and the first image 86A or a difference between the first image 86A and the second image 88A is excessively small, it can be determined that the AI method processing has a great influence on the first image 86A. Therefore, the ratio 90 may be defined according to the difference between the processing target image 75A and the first image 86A, or the difference between the first image 86A and the second image 88A.

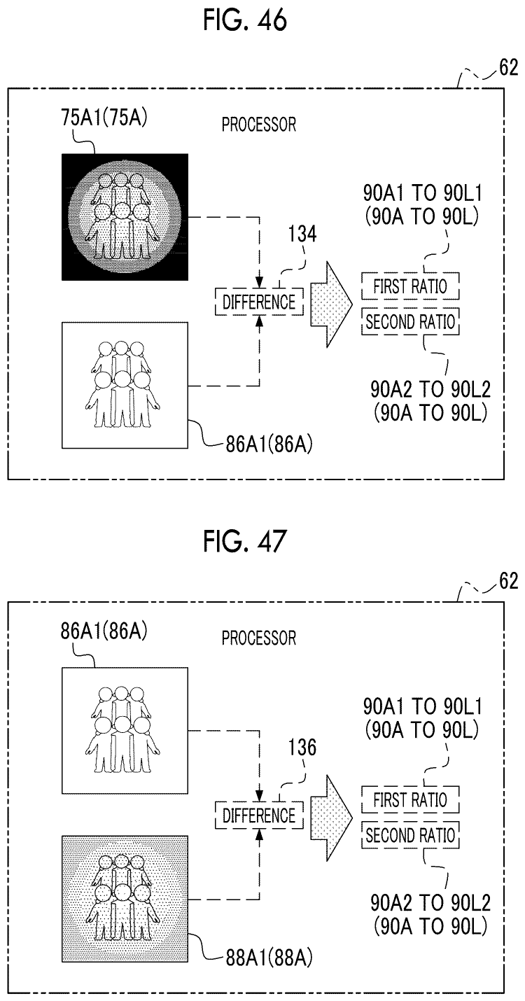

In this case, for example, as shown in FIG. 46, the processor 62 derives the ratio 90 based on a difference 134 between the processing target image 75A and the first image 86A. The ratio 90 may be calculated by using a calculation formula in which the difference 134 is defined as an independent variable and the ratio 90 is defined as a dependent variable, or the ratio 90 may be derived from a table in which the difference 134 and the ratio 90 are associated with each other. Further, a division value may be used instead of the difference 134. An example of the division value used instead of the difference 134 includes a ratio of one of a statistical value (for example, an average pixel value) of pixel values of a plurality of pixels (for example, all pixels or a plurality of pixels constituting a region where a main subject is captured) included in the processing target image 75A or a statistical value (for example, an average pixel value) of pixel values of a plurality of pixels (for example, all pixels or a plurality of pixels constituting a region where a main subject is captured) included in the first image 86A with respect to the other.

Further, for example, as shown in FIG. 47, the processor 62 may derive the ratio 90 based on a difference 136 between the first image 86A and the second image 88A. In this case as well, the ratio 90 may be calculated by using a calculation formula in which the difference 136 is defined as an independent variable and the ratio 90 is defined as a dependent variable, or the ratio 90 may be derived from a table in which the difference 136 and the ratio 90 are associated with each other. Further, a division value may be used instead of the difference 136. An example of the division value used instead of the difference 136 includes a ratio of one of a statistical value (for example, an average pixel value) of pixel values of a plurality of pixels (for example, all pixels or a plurality of pixels constituting a region where a main subject is captured) included in the first image 86A or a statistical value (for example, an average pixel value) of pixel values of a plurality of pixels (for example, all pixels or a plurality of pixels constituting a region where a main subject is captured) included in the second image 88A with respect to the other.

Further, the ratio 90 may be derived based on the differences 134 and 136. In this case, the ratios 90 may be calculated by using a calculation formula in which the differences 134 and 136 are defined as an independent variable and the ratio 90 is defined as a dependent variable, or the ratio 90 may be derived from a table in which the differences 134 and 136, and the ratio 80 are associated with each other.

As described above, according to the present thirteenth modification example, the ratio 90 is defined based on the difference between the processing target image 75A and the first image 86A and/or the difference between the first image 86A and the second image 88A. Therefore, it is possible to suppress that the appearance of the image obtained by combining the first image 86A and the second image 88A becomes unnatural due to the influence of the AI method processing as compared with the case where the ratio 90 is a fixed value that is defined without considering the first image 86A.

### Fourteenth Modification Example

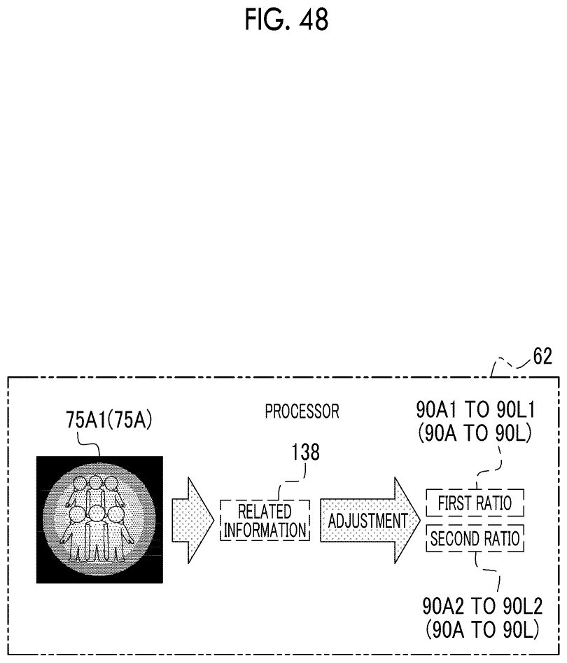

As an example shown in FIG. 48, the processor 62 may adjust the ratio 90 according to the related information 138 related to the processing target image 75A. Here, a first example of the related information 138 includes information related to the sensitivity of the image sensor 20 (for example, ISO sensitivity and the like). A second example of the related information 138 includes information related to the brightness of the processing target image 75A (for example, an average value, a median value, or the most frequent value of the pixel values of the processing target image 75A). A third example of the related information 138 includes information indicating a spatial frequency of the processing target image 75A. A fourth example of the related information 138 includes a subject image (for example, a person image, a site image, or the like) in the processing target image 75A.

As described above, according to the present fourteenth modification example, the ratio 90 is adjusted according to the related information 138 related to the processing target image 75A. Therefore, it is possible to suppress deterioration in the image quality of the image obtained by combining the first image 86A and the second image 88A due to the related information 138 as compared with the case where the ratio 90 is changed without considering the related information 138 at all.

### Other Modification Examples

In the above description, although an example of the embodiment in which the AI method processing unit 62A performs the processing that uses the generation model 82A has been described, a plurality of types of generation models 82A may be selectively used by the AI method processing unit 62A according to conditions. For example, the generation model 82A, which is used by using the AI method processing unit 62A, may be switched according to an imaging scene imaged by the imaging apparatus 10. Further, the ratio 90 may be changed according to the generation model 82A that is used by the AI method processing unit 62A.

In the above description, although an example of the embodiment in which a chromatic image or an achromatic image, which is obtained by being imaged by the imaging apparatus 10, is used as the processing target image 75A has been described, the present disclosed technology is not limited to this, and the processing target image 75A may be a distance image.

In the above description, although an example of the embodiment in which the second image 88A is obtained by performing the non-AI method processing on the processing target image 75A has been described, the present disclosed technology is not limited to this, and an image, which is obtained by performing the non-AI method and the processing that uses a trained model different from the generation model 82A on the processing target image 75A, may be used as the second image 88A.

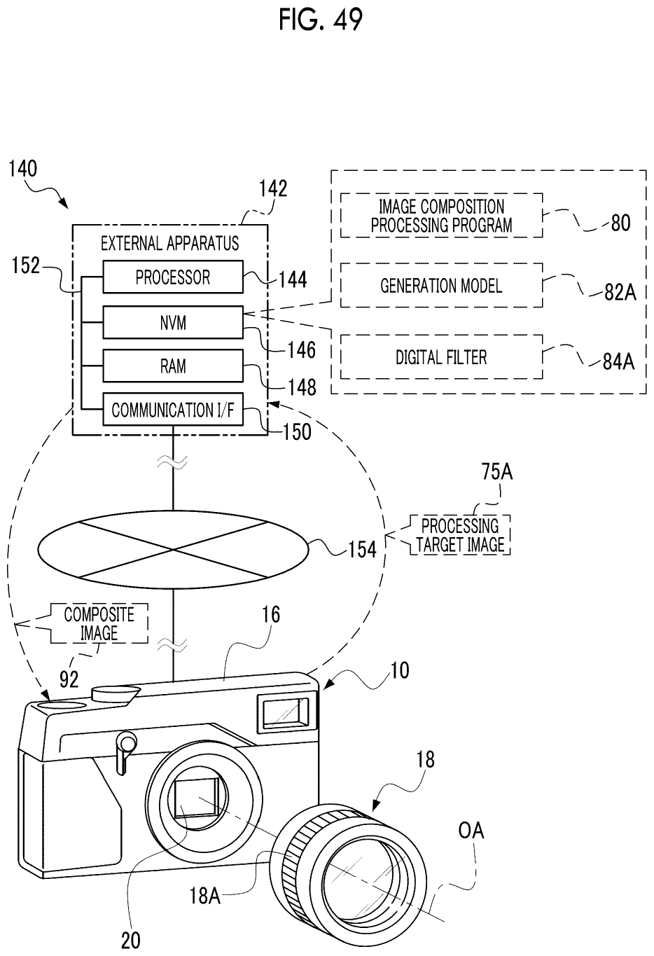

In the above description, although an example of the embodiment in which the image composition processing is performed by the processor 62 of the image processing engine 12 included in the imaging apparatus 10 has been described, the present disclosed technology is not limited to this, and a device that performs the image composition processing may be provided outside the imaging apparatus 10. In this case, as an example shown in FIG. 49, the imaging system 140 may be used. The imaging system 140 includes the imaging apparatus 10 and an external apparatus 142. The external apparatus 142 is, for example, a server. The server is implemented by cloud computing, for example. Here, although the cloud computing is exemplified, this is only an example, and for example, the server may be implemented by a mainframe or implemented by network computing such as fog computing, edge computing, or grid computing. Here, although a server is exemplified as an example of the external apparatus 142, this is only an example, and at least one personal computer or the like may be used as the external apparatus 142 instead of the server.

The external apparatus 142 includes a processor 144, an NVM 146, a RAM 148, and a communication I/F 150, and the processor 144, the NVM 146, the RAM 148, and the communication I/F 150 are connected via a bus 152. The communication I/F 150 is connected to the imaging apparatus 10 via the network 154. The network 154 is, for example, the Internet. The network 154 is not limited to the Internet and may be a WAN and/or a LAN such as an intranet or the like.

The image composition processing program 80, the generation model 82A, and the digital filter 84A are stored in the NVM 146. The processor 144 executes the image composition processing program 80 on the RAM 148. The processor 144 performs the above described image composition processing according to the image composition processing program 80 executed on the RAM 148. In a case where the image composition processing is performed, the processor 144 processes the processing target image 75A by using the generation model 82A and the digital filter 84A as described in each of the above examples. The processing target image 75A is transmitted from the imaging apparatus 10 to the external apparatus 142 via the network 154, for example. The communication I/F 150 of the external apparatus 142 receives the processing target image 75A. The processor 144 performs the image composition processing on the processing target image 75A received via the communication I/F 150. The processor 144 generates the composite image 92 by performing the image composition processing and transmits the generated composite image 92 to the imaging apparatus 10. The imaging apparatus 10 receives the composite image 92, which is transmitted from the external apparatus 142, via the communication I/F 52 (see FIG. 2).

In the example shown in FIG. 49, the external apparatus 142 is an example of an “image processing apparatus” and a “computer” according to the present disclosed technology, and the processor 144 is an example of a “processor” according to the present disclosed technology.

Further, the image composition processing may be performed in a distributed manner by a plurality of apparatuses including the imaging apparatus 10 and the external apparatus 142.

In the above embodiment, although the processor 62 is exemplified, at least one other CPU, at least one GPU, and/or at least one TPU may be used instead of the processor 62 or together with the processor 62.

In the above embodiment, although an example of the embodiment in which the image composition processing program 80 is stored in the NVM 64 has been described, the present disclosed technology is not limited to this. For example, the image composition processing program 80 may be stored in a portable non-temporary storage medium such as an SSD or a USB memory. The image composition processing program 80 stored in the non-temporary storage medium is installed in the image processing engine 12 of the imaging apparatus 10. The processor 62 executes the image composition processing according to the image composition processing program 80.

Further, the image composition processing program 80 may be stored in the storage device such as another computer or a server device connected to the imaging apparatus 10 via the network, the image composition processing program 80 may be downloaded in response to the request of the imaging apparatus 10, and the image composition processing program 80 may be installed in the image processing engine 12.

It is not necessary to store all of the image composition processing programs 80 in the storage device such as another computer or a server device connected to the imaging apparatus 10, or the NVM 64, and a part of the image composition processing program 80 may be stored.

Further, although the imaging apparatus 10 shown in FIG. 1 and FIG. 2 has a built-in image processing engine 12, the present disclosed technology is not limited to this, for example, the image processing engine 12 may be provided outside the imaging apparatus 10.

In the above embodiment, although the image processing engine 12 is exemplified, the present disclosed technology is not limited to this, and a device including an ASIC, FPGA, and/or PLD may be applied instead of the image processing engine 12. Further, instead of the image processing engine 12, a combination of a hardware configuration and a software configuration may be used.

As a hardware resource for executing the image composition processing described in the above embodiment, the following various processors can be used. Examples of the processor include software, that is, a CPU, which is a general-purpose processor that functions as a hardware resource for executing the image composition processing by executing a program. Further, examples of the processor include a dedicated electric circuit, which is a processor having a circuit configuration specially designed for executing specific processing such as FPGA, PLD, or ASIC. A memory is built-in or connected to any processor, and each processor executes the image composition processing by using the memory.

The hardware resource for executing the image composition processing may be configured with one of these various processors or may be configured with a combination (for example, a combination of a plurality of FPGAs or a combination of a CPU and an FPGA) of two or more processors of the same type or different types. Further, the hardware resource for executing the image composition processing may be one processor.

As an example of configuring with one processor, first, one processor is configured with a combination of one or more CPUs and software, and there is an embodiment in which this processor functions as a hardware resource for executing the image composition processing. Secondly, as typified by SoC, there is an embodiment in which a processor that implements the functions of the entire system including a plurality of hardware resources for executing the image composition processing with one IC chip is used. As described above, the image composition processing is implemented by using one or more of the above-mentioned various processors as a hardware resource.

Further, as the hardware-like structure of these various processors, more specifically, an electric circuit in which circuit elements such as semiconductor elements are combined can be used. Further, the above-mentioned image composition processing is only an example. Therefore, it goes without saying that unnecessary steps may be deleted, new steps may be added, or the processing order may be changed within a range that does not deviate from the purpose.

The contents described above and the contents shown in the illustration are detailed explanations of the parts related to the present disclosed technology and are only an example of the present disclosed technology. For example, the description related to the configuration, function, action, and effect described above is an example related to the configuration, function, action, and effect of a portion according to the present disclosed technology. Therefore, it goes without saying that unnecessary parts may be deleted, new elements may be added, or replacements may be made to the contents described above and the contents shown in the illustration, within the range that does not deviate from the purpose of the present disclosed technology. Further, in order to avoid complications and facilitate understanding of the parts of the present disclosed technology, in the contents described above and the contents shown in the illustration, the descriptions related to the common technical knowledge or the like that do not require special explanation in order to enable the implementation of the present disclosed technology are omitted.

In the present specification, “A and/or B” is synonymous with “at least one of A or B.” That is, “A and/or B” means that it may be only A, it may be only B, or it may be a combination of A and B. Further, in the present specification, in a case where three or more matters are connected and expressed by “and/or”, the same concept as “A and/or B” is applied.

All documents, patent applications, and technical standards described in the present specification are incorporated in the present specification by reference to the same extent in a case where it is specifically and individually described that the individual documents, the patent applications, and the technical standards are incorporated by reference.

What is claimed is:

1. An image processing apparatus comprising:
a processor,
wherein the processor is configured to:
acquire a first image, which is obtained by performing first AI processing on a processing target image, and a second image, which is obtained without performing the first AI processing on the processing target image; and
adjust excess and deficiency of the first AI processing by combining the first image and the second image.

2. The image processing apparatus according to claim 1,
wherein the second image is an image obtained by performing non-AI method processing, which does not use a neural network, on the processing target image.

3. An image processing apparatus comprising:
a processor,
wherein the processor is configured to:
acquire a first image, which is obtained by performing first AI processing on a processing target image to adjust a non-noise element of the processing target image, and a second image, which is obtained without performing the first AI processing on the processing target image; and
adjust the non-noise element by combining the first image and the second image.

4. The image processing apparatus according to claim 3,
wherein the second image is an image in which the non-noise element is adjusted by performing non-AI method processing, which does not use a neural network, on the processing target image.

5. The image processing apparatus according to claim 3,
wherein the second image is an image in which the non-noise element is not adjusted.

6. The image processing apparatus according to claim 1,
wherein the processor is configured to combine the first image and the second image at a ratio in which the excess and deficiency of the first AI processing is adjusted.

7. The image processing apparatus according to claim 6,
wherein the processing target image is an image obtained by performing imaging by an imaging apparatus,
the first AI processing includes first correction processing of correcting a phenomenon, which appears in the processing target image due to a characteristic of the imaging apparatus, by using an AI method,
the first image includes a first corrected image obtained by performing the first correction processing, and
the processor is configured to adjust an element derived from the first correction processing by combining the first corrected image and the second image at the ratio.

8. The image processing apparatus according to claim 7,
wherein the processor is configured to perform second correction processing of correcting the phenomenon by using a non-AI method,
the second image includes a second corrected image obtained by performing the second correction processing, and
the processor is configured to adjust the element derived from the first correction processing by combining the first corrected image and the second corrected image at the ratio.

9. The image processing apparatus according to claim 7,
wherein the characteristic includes an optical characteristic of the imaging apparatus.

10. The image processing apparatus according to claim 6,
wherein the first AI processing includes first change processing of changing a factor that controls a visual impression given from the processing target image by using an AI method,
the first image includes a first changed image obtained by performing the first change processing, and
the processor is configured to adjust an element derived from the first change processing by combining the first changed image and the second image at the ratio.

11. The image processing apparatus according to claim 10,
wherein the processor is configured to perform second change processing of changing the factor by using a non-AI method,
the second image includes a second changed image obtained by performing the second change processing, and
the processor is configured to adjust the element derived from the first change processing by combining the first changed image and the second changed image at the ratio.

12. The image processing apparatus according to claim 10,
wherein the factor includes a clarity, color, a gradation, a resolution, a blurriness, an emphasizing degree of an edge region, an image style, and/or an image quality related to skin.

13. The image processing apparatus according to claim 6,
wherein the processing target image is a captured image obtained by imaging subject light, which is formed on a light-receiving surface by a lens of an imaging apparatus, by the imaging apparatus,
the first image includes a first aberration corrected image obtained by performing aberration region correction processing of correcting a region of the captured image where an aberration of the lens is reflected by using an AI method, as processing included in the first AI processing,
the second image includes a second aberration corrected image obtained by performing processing of correcting the region of the captured image where the aberration of the lens is reflected by using a non-AI method, and
the processor is configured to adjust an element derived from the aberration region correction processing by combining the first aberration corrected image and the second aberration corrected image at the ratio.

14. The image processing apparatus according to claim 6,
wherein the first image includes a first colored image obtained by performing color processing of coloring a first region and a second region, which is a region different from the first region, with respect to the processing target image in a distinguishable manner by using an AI method, as processing included in the first AI processing,
the second image includes a second colored image obtained by performing processing of changing color of the processing target image by using a non-AI method, and
the processor is configured to adjust an element derived from the color processing by combining the first colored image and the second colored image at the ratio.

15. The image processing apparatus according to claim 14,
wherein the second colored image is an image obtained by performing processing of coloring the first region and the second region with respect to the processing target image in a distinguishable manner by using the non-AI method.

16. The image processing apparatus according to claim 14,
wherein the processing target image is an image obtained by imaging a first subject, and
the first region is a region where a specific subject, which is included in the first subject in the processing target image, is captured.

17. The image processing apparatus according to claim 6,
wherein the first image includes a first contrast adjusted image obtained by performing first contrast adjustment processing of adjusting a contrast of the processing target image by using an AI method, as processing included in the first AI processing,
the second image includes a second contrast adjusted image obtained by performing second contrast adjustment processing of adjusting the contrast of the processing target image by using a non-AI method, and
the processor is configured to adjust an element derived from the first contrast adjustment processing by combining the first contrast adjusted image and the second contrast adjusted image at the ratio.

18. The image processing apparatus according to claim 17,
wherein the processing target image is an image obtained by imaging a second subject,
the first contrast adjustment processing includes third contrast adjustment processing of adjusting the contrast of the processing target image according to the second subject by using the AI method,
the second contrast adjustment processing includes fourth contrast adjustment processing of adjusting the contrast of the processing target image according to the second subject by using the non-AI method,
the first image includes a third contrast image obtained by performing the third contrast adjustment processing,
the second image includes a fourth contrast image obtained by performing the fourth contrast adjustment processing, and
the processor is configured to adjust an element derived from the third contrast adjustment processing by combining the third contrast image and the fourth contrast image at the ratio.

19. The image processing apparatus according to claim 17,
wherein the first contrast adjustment processing includes fifth contrast adjustment processing of adjusting a contrast between a center pixel included in the processing target image and a plurality of adjacent pixels adjacent to a vicinity of the center pixel by using the AI method,
the second contrast adjustment processing includes sixth contrast adjustment processing of adjusting the contrast between the center pixel and the plurality of adjacent pixels by using the non-AI method,
the first image includes a fifth contrast image obtained by performing the fifth contrast adjustment processing,
the second image includes a sixth contrast image obtained by performing the sixth contrast adjustment processing, and
the processor is configured to adjust an element derived from the fifth contrast adjustment processing by combining the fifth contrast image and the sixth contrast image at the ratio.

20. The image processing apparatus according to claim 6,
wherein the first image includes a first resolution adjusted image obtained by performing first resolution adjustment processing of adjusting a resolution of the processing target image by using an AI method, as processing included in the first AI processing,
the second image includes a second resolution adjusted image obtained by performing second resolution adjustment processing of adjusting the resolution by using a non-AI method, and
the processor is configured to adjust an element derived from the first resolution adjustment processing by combining the first resolution adjusted image and the second resolution adjusted image at the ratio.

21. The image processing apparatus according to claim 20,
wherein the first resolution adjustment processing is processing of performing a super-resolution on the processing target image by using the AI method, and
the second resolution adjustment processing is processing of performing the super-resolution on the processing target image by using the non-AI method.

22. The image processing apparatus according to claim 6,
wherein the first image includes a first high dynamic range image obtained by performing expansion processing of expanding a dynamic range of the processing target image by using an AI method, as processing included in the first AI processing,
the second image includes a second high dynamic range image obtained by performing processing of expanding the dynamic range of the processing target image by using a non-AI method, and
the processor is configured to adjust an element derived from the expansion processing by combining the first high dynamic range image and the second high dynamic range image at the ratio.

23. The image processing apparatus according to claim 6,
wherein the first image includes a first edge emphasized image obtained by performing emphasis processing of emphasizing an edge region in the processing target image more than a non-edge region, which is a region different from the edge region, by using an AI method, as processing included in the first AI processing,
the second image includes a second edge emphasized image obtained by performing processing of emphasizing the edge region more than the non-edge region by using a non-AI method, and
the processor is configured to adjust an element derived from the emphasis processing by combining the first edge emphasized image and the second edge emphasized image at the ratio.

24. The image processing apparatus according to claim 6,
wherein the first image includes a first point image adjusted image obtained by performing point image adjustment processing of adjusting a blurriness amount of a point image with respect to the processing target image by using an AI method, as processing included in the first AI processing,
the second image includes a second point image adjusted image obtained by performing processing of adjusting the blurriness amount by using a non-AI method, and
the processor is configured to adjust an element derived from the point image adjustment processing by combining the first point image adjusted image and the second point image adjusted image at the ratio.

25. The image processing apparatus according to claim 6,
wherein the processing target image is an image obtained by imaging a third subject,
the first image includes a first blurred image obtained by performing blur processing of applying a blurriness, which is determined in accordance with the third subject, to the processing target image by using an AI method, as processing included in the first AI processing,
the second image includes a second blurred image obtained by performing processing of applying the blurriness to the processing target image by using a non-AI method, and
the processor is configured to adjust an element derived from the blur processing by combining the first blurred image and the second blurred image at the ratio.

26. The image processing apparatus according to claim 6,
wherein the first image includes a first round blurriness image obtained by performing round blurriness processing of applying a first round blurriness to the processing target image by using an AI method, as processing included in the first AI processing,
the second image includes a second round blurriness image obtained by performing processing of adjusting the first round blurriness from the processing target image by using a non-AI method or of applying a second round blurriness to the processing target image by using the non-AI method, and
the processor is configured to adjust an element derived from the round blurriness processing by combining the first round blurriness image and the second round blurriness image at the ratio.

27. The image processing apparatus according to claim 6,
wherein the first image includes a first gradation adjusted image obtained by performing first gradation adjustment processing of adjusting a gradation of the processing target image by using an AI method, as processing included in the first AI processing,
the second image includes a second gradation adjusted image obtained by performing second gradation adjustment processing of adjusting the gradation of the processing target image by using a non-AI method, and
the processor is configured to adjust an element derived from the first gradation adjustment processing by combining the first gradation adjusted image and the second gradation adjusted image at the ratio.

28. The image processing apparatus according to claim 27,
wherein the processing target image is an image obtained by imaging a fourth subject,
the first gradation adjustment processing is processing of adjusting the gradation of the processing target image according to the fourth subject by using the AI method, and
the second gradation adjustment processing is processing of adjusting the gradation of the processing target image according to the fourth subject by using the non-AI method.

29. The image processing apparatus according to claim 6,
wherein the first image includes an image style changed image obtained by performing image style change processing of changing an image style of the processing target image by using an AI method, as processing included in the first AI processing, and
the processor is configured to adjust an element derived from the image style change processing by combining the image style changed image and the second image at the ratio.

30. The image processing apparatus according to claim 6,
wherein the processing target image is an image obtained by imaging skin,
the first image includes a skin image quality adjusted image obtained by performing skin image quality adjustment processing of adjusting an image quality related to the skin captured in the processing target image by using an AI method, as processing included in the first AI processing, and
the processor is configured to adjust an element derived from the skin image quality adjustment processing by combining the skin image quality adjusted image and the second image at the ratio.

31. The image processing apparatus according to claim 6,
wherein the first AI processing includes a plurality of purpose-specific processing performed by using an AI method,
the first image includes a multiple processed image obtained by performing the plurality of purpose-specific processing on the processing target image, and
the processor is configured to combine the multiple processed image and the second image at the ratio.

32. The image processing apparatus according to claim 31,
wherein the plurality of purpose-specific processing are performed in an order based on a degree of influence applied on the processing target image.

33. The image processing apparatus according to claim 32,
wherein the plurality of purpose-specific processing are performed stepwise from purpose-specific processing in which the degree of the influence is small to purpose-specific processing in which the degree of the influence is large.

34. The image processing apparatus according to claim 6,
wherein the ratio is defined based on a difference between the processing target image and the first image and/or a difference between the first image and the second image.

35. The image processing apparatus according to claim 6,
wherein the processor is configured to adjust the ratio according to related information that is related to the processing target image.

36. An imaging apparatus comprising:
the image processing apparatus according to claim 1; and
an image sensor,
wherein the processing target image is an image obtained by performing imaging by the image sensor.

37. An image processing method comprising:
acquiring a first image, which is obtained by performing first AI processing on a processing target image, and a second image, which is obtained without performing the first AI processing on the processing target image; and
adjusting excess and deficiency of the first AI processing by combining the first image and the second image.

38. An image processing method comprising:
acquiring a first image, which is obtained by performing first AI processing on a processing target image to adjust a non-noise element of the processing target image, and a second image, which is obtained without performing the first AI processing on the processing target image; and
adjusting the non-noise element by combining the first image and the second image.

39. A non-transitory computer-readable storage medium storing a program executable by a computer to perform a process comprising:
acquiring a first image, which is obtained by performing first AI processing on a processing target image, and a second image, which is obtained without performing the first AI processing on the processing target image; and
adjusting excess and deficiency of the first AI processing by combining the first image and the second image.

40. A non-transitory computer-readable storage medium storing a program executable by a computer to perform a process comprising:
acquiring a first image, which is obtained by performing first AI processing on a processing target image to adjust a non-noise element of the processing target image, and a second image, which is obtained without performing the first AI processing on the processing target image; and
adjusting the non-noise element by combining the first image and the second image.
